(19) United States
(12) Patent Application Publication
(10) Pub. No.: US 2013/0255514 A1
(43) Pub. Date: Oct. 3, 2013

(54) METHOD FOR TRANSFERRING LIQUID PRESSURE PROVIDED WITH DESIGN SURFACE CLEANING MECHANISM AND LIQUID PRESSURE TRANSFER DEVICE THEREFOR

(71) Applicants: Youichiro Yoshii, Tokyo (JP); Eiji Suzuki, Tokyo (JP); Sakae Ushiwata, Tokyo (JP); Katsumi Iyanagi, Tokyo (JP)

(72) Inventors: Youichiro Yoshii, Tokyo (JP); Eiji Suzuki, Tokyo (JP); Sakae Ushiwata, Tokyo (JP); Katsumi Iyanagi, Tokyo (JP)

(73) Assignee: TAICA CORPORATION, Tokyo (JP)

(21) Appl. No.: 13/992,026

(22) PCT Filed: Dec. 8, 2011
(86) PCT No.: PCT/JP2011/078443

§ 371 Date: Jun. 6, 2013

(30) Foreign Application Priority Data
Dec. 10, 2010 (JP) 2010-275525

(51) Int. Cl. B41F 16/00

(52) U.S. Cl. CPC B41F 16/00
USPC 101/425

(57) ABSTRACT

The present invention relates to a liquid pressure transferring technique for forming an appropriate transfer pattern on the surface of an object by pressing the object from the upper side of a transfer tank, in a liquid-leaving area in which the object is pulled up from the transfer liquid in the transfer tank, a design surface oppositely-separating flow that is separated away from a design surface of the object that is in the process of getting out of a liquid is formed by using the design surface cleaning device such as an overflow tank, and foam on a surface of the transfer liquid and foreign substances staying in the liquid are separated away from the design surface of the object that is in the process of getting out of the liquid and are discharged outside the transfer tank.

### TECHNICAL FIELD

The present invention relates to a liquid pressure transfer, in which a transfer film made by applying an appropriate transfer pattern (surface ink layer) with a transfer ink in advance is supported in a floating manner on a surface of a liquid, and while an object is pressed on the transfer film, the object is put into the transfer liquid, whereby the transfer pattern on the film is transferred onto the object using a liquid pressure thereof. More particularly, the present invention relates to a novel liquid pressure transferring technique not allowing film scraps, foam, and the like disposed on the surface of the transfer liquid to reach a design surface of an object floating in the transfer liquid.

### BACKGROUND ART

A liquid pressure transfer is known, in which a transfer film made by applying an appropriate water-insoluble transfer pattern with a transfer ink on a water-soluble film (holding sheet) in advance is set in the transfer tank (transfer liquid) so that the transfer film floats on the transfer liquid, and while the transfer film (water-soluble film) is wet with the transfer liquid (in short, water), the object is pressed onto the liquid in the transfer tank while the object is brought into contact with the transfer film, and using the liquid pressure, the transfer pattern on the film is transferred and formed on the surface of the object. As described above, on the transfer film, the transfer pattern is formed (printed) on the water-soluble film with ink in advance, and the ink of the transfer pattern is in a dried state. Therefore, during the transfer, it is necessary to apply an activating agent, a thinner, and the like to the transfer pattern on the transfer film to return the transfer pattern back to a wet state like the state immediately after the printing of the transfer pattern, i.e., to return the transfer pattern back to a state achieving the adhesive property, and this is referred to as activation.

Then, after the transfer, the half-dissolved water-soluble film is removed by water-cleaning and the like from the object removed from the transfer tank, and thereafter, the object is dried. In order to protect the decorative layer formed and transferred onto the object, the object is subjected to top coating in many cases. However, in this kind of conventional liquid pressure transfer, first, solvent-based clear coating is used for the top coating, and there is a problem in that the environmental impact is high, and moreover, since, e.g., there is defect during the top coating and it takes a relatively long time and energy in the coating and drying, the overall cost of the liquid pressure transfer increases.

Therefore, a method has been devised, in which during the liquid pressure transfer, a transfer pattern also having a surface protection function is formed on an object, and after the transfer, this is cured to form a decorative layer, so that the top coating is omitted (for example, see Patent Literatures 1, 2).

Among them, Patent Literature 1 relates to a method in which, while a conventional transfer film made by forming only a transfer pattern on a water-soluble film is used, a curable resin composition (liquid) is used as an activating agent, and ultraviolet ray is emitted onto the object after the transfer, so that a curable resin composition (surface protection layer) formed integrally with the transfer pattern is cured.

On the other hand, Patent Literature 2 relates to a method in which a transfer film made by forming a curable resin layer between a water-soluble film and a transfer pattern is used, and the curable resin layer on the transfer pattern is cured by emitting active energy ray such as ultraviolet ray onto the object or heating the object after the transfer.

By the way, in the liquid pressure transfer, such an operation is performed that the object pierces through the transfer film floating on the surface of the liquid and sinks into the liquid when the object is put into the liquid (during the transfer), and, accordingly, the film remaining on the surface of the liquid after the sinking is no longer used for the transfer and is unnecessary (this will be referred to as a liquid surface residual film). In addition, as the object pierces through the transfer film on the surface of the liquid, a large amount of very small film residues (for example, in the form of waste strings in which a water-soluble film and ink are mixed together) are dispersed and discharged into the transfer liquid, and these are accumulated in the transfer liquid. Furthermore, since the object is put into the liquid (transferred) with a jig attached thereto, when the object is put into the liquid, redundant films attached to the jig and the object may be separated and discharged in the liquid. For this reason, the liquid surface residual films, the film residues, the redundant films, and the like explained above may attach to the design surface of the object pulled up from the transfer liquid (these remain in the liquid and the transfer liquid surface and are unnecessary after the transfer, and therefore, in this specification they are collectively referred to as “foreign substances”).

Further, for example, as illustrated in FIG. 22(a), in a case where the object W has an opening portion Wa in the design surface S1, a thin film M made of a water soluble material of the water-soluble film is often formed in the opening portion Wa when the object is pulled up from the surface of the liquid, and this bursts, whereby bubbles A attach to the design surface S1 of the object W, or when the transfer liquid L drops to the surface of the liquid from a protruding portion of the object W or an upper edge portion of the opening portion Wa, bubbles A are generated on the surface of the liquid, and the bubbles may attach to the design surface 51. More specifically, in FIG. 22(a), at first, the thin film M is formed in the frame of the jig J, and the burst residual bubbles A float on the surface of the transfer liquid L. According to the movement of the surface of the liquid in the liquid-leaving area P2 (relative descend as the object W is pulled up), the bubbles A are incorporated into the thin film M formed in the opening portion Wa of the object W. Thereafter, the burst residues of the thin film M float on the surface of the liquid as the bubbles A, and the bubbles A are indirectly attached to the design surface S1, or the bubbles A are directly passed along the surface of the object W, and are attached to the design surface S1. As a result, the state as illustrated in FIG. 22(b) is obtained.

Then, when a curing processing is performed by emission of an activation energy ray and/or heating in this state, for example, as illustrated in FIG. 22(c), the following defects occur. Only in portions to which the bubbles A are attached, a defect of deformation of the pattern of the decorative layer (the transfer pattern and the surface protection layer) and defect (so called pinhole defect) of loss of the pattern occur due to the reasons such as stress caused by the bubbles A and refraction of the activation energy ray. It is to be understood that the above defect of the deformation of the pattern and the defect of the loss of the pattern are not limited to a case where the bubbles A attach to the object W. This is a phenomenon that may also occur when foreign substances such as the liquid surface residual films, the film residues, and the redundant films attach to the design surface S1. In this case, reference numeral f in the figure mainly denotes the decorative layer transferred to the object W (design surface 51) and the like. Therefore, it is important to prevent the liquid surface residual films, the film residues, the redundant films, the bubbles A, and the like from being attached to the design surface S1 as much as possible in the liquid pressure transfer for forming the transfer pattern also having a surface protection function during the liquid pressure transfer. Particularly in the present invention, the preventing of the film residues, the bubbles A, and the like from being attached to the design surface S1 in the process of outputting the liquid from the transfer liquid L is considered to be important.

It should be noted that a product with the defect of pattern deformation and defect of pattern loss (liquid pressure transfer product) are once subjected to the curing processing, projection and depression caused by the pattern deformation and the pattern loss are significant, but it is impossible to perform the transfer all over again (impossible to reproduce), and therefore, the above defects significantly reduces the mass productivity, and a fundamental solution method for reducing the defective rate itself is strongly desired.

In addition, the collection of the liquid surface residual films floating on the surface of the liquid after the transfer has been conventionally performed, and, for example, an overflow structure disposed at the distal end (terminal end) of the transfer tank corresponds thereto. In other words, in order to collect the liquid surface residual films after the transfer together with the transfer liquid and use the collected transfer liquid in a circulatory manner, such an overflow structure is configured to eliminate and collect the liquid surface residual films from the collected liquid by using a filter or the like in the middle of the path.

However, in this kind of collecting method, the liquid surface residual films pass through the liquid-leaving area. Therefore, in particular, in liquid pressure transfer for forming even a surface protection layer during liquid pressure transfer, this collecting method cannot be said effective collection means, and more active collecting method is desired, and there is such method that has already been devised (for example, in addition to Patent Literature 2 explained above, see Patent Literatures 3 and 4).

First, Patent Literature 2 discloses a method in which every time the liquid pressure transfer is performed, all residual films on water surface are pushed and washed away from a transfer tank by providing water into the tank from a bottom portion of the transfer tank. On the other hand, Patent Literature 3 discloses a method for sucking films on water surface using vacuum while an object is put under the water. Further, Patent Literature 4 discloses a method, in which after an object is pulled up from a water tank, air is blown to one end of the water tank, and transfer residues and remaining residues are washed away from the one end of the water tank after an ink coat is transferred onto the object.

However, these are mainly intended for collecting films and residues on the transfer liquid surface (on the water surface). Moreover, these require extensive structure, and are batch processing method in which films and residues are collected on every transfer, and therefore, it takes a long time and the efficiency is low, which cannot be necessarily said a preferable method.

### CITATION LIST

### Patent Literature

Patent Literature 1: Japanese Patent Application Laid-Open (JP-A) No. 2005-169693
Patent Literature 2: JP-A No. 2005-162298
Patent Literature 3: JP-A No. 2004-306602
Patent Literature 4: JP-A No. 2006-123264

### SUMMARY OF INVENTION

### Technical Problem

The present invention is contrived by recognizing such backgrounds, and a novel liquid transfer technique has been attempted to be developed, which is a technique specialized for an object getting out of the liquid (floating), in other words, a technique for preventing film residuals, foam, and the like to approach a design surface of the object pulled upward from the transfer liquid, employing a relatively simple structure at low cost.

### Solution to Problem

First, a liquid pressure transfer method provided with a design surface cleaning device in which a transfer film configured by forming at least a transfer pattern on a water-soluble film in a dried state is supported on a liquid surface inside a transfer tank so as to float, and the transfer pattern is transferred mainly to a design surface side of an object in accordance with liquid pressure generated by pressing the object from an upper side, the liquid pressure transfer method according to claim 1 is configured by including: forming a design surface oppositely-separating flow that is separated away from a design surface of the object that is in the process of getting out of a liquid in a liquid-leaving area in which the object is pulled up from the transfer liquid in the transfer tank, separating foam on a surface of a transfer liquid and foreign substances staying in the liquid away from the design surface of the object that is in the process of getting out of the liquid, and discharging the foam and the foreign substances outside the transfer tank.

The liquid pressure transfer method provided with the design surface cleaning device according to claim 2 is based on the requirement of claim 1, and is further configured such that, on both left and right sides of the liquid-leaving area, side oppositely-separating flows from a decoration-unnecessary surface side that is a rear side of the design surface of the object in the process of getting out of the liquid toward both side walls of the transfer tank are formed near the liquid surface, and the foreign substances staying in the transfer liquid and on the surface of the liquid are separated away from the liquid-leaving area and are discharged outside the transfer tank.

The liquid pressure transfer method provided with the design surface cleaning device according to claim 3 is based on the requirement of claim 1 or 2, and is further configured such that a discharge means discharging liquid surface residual films, which are not used for the transfer due to immersion of the object, floating on the liquid surface from the transfer tank is disposed on a previous stage of the liquid-leaving area, and the liquid surface residual films are collected until the object gets out of the liquid so as not to arrive at the liquid-leaving area.

The liquid pressure transfer method provided with the design surface cleaning device according to claim 4 is based on the requirement of claim 1, 2, or 3, and is further configured such that the design surface oppositely-separating flow is formed by an overflow tank disposed so as to face the design surface of the object that is in the process of getting out of the liquid.

The liquid pressure transfer method provided with the design surface cleaning device according to claim 5 is based on the requirement of claim 4, and is further configured such that an overflow tank collecting the transfer liquid is further disposed at a rear stage of the overflow tank disposed so as to face the design surface of the object that is in the process of getting out of the liquid.

The liquid pressure transfer method provided with the design surface cleaning device according to claim 6 is based on the requirement of claim 4 or 5, and is further configured such that the design surface oppositely-separating flow is generated by supplying new water such as clean water not containing foreign substances or purified water acquired by removing foreign substances from the transfer liquid collected from the transfer tank from a lower side of the overflow tank for forming the design surface oppositely-separating flow toward the liquid-leaving area disposed on an upstream side.

The liquid pressure transfer method provided with the design surface cleaning device according to claim 7 is based on the requirement of claim 4, and is further configured such that a new water supply port that supplies new water such as clean water not containing foreign substances or purified water acquired by removing foreign substances from the transfer liquid collected from the transfer tank into the inside of the tank is disposed on the lower side of the overflow tank for forming the design surface oppositely-separating flow, and the design surface oppositely-separating flow is formed using new water supplied upward from the new water supply port toward the liquid-leaving area.

The liquid pressure transfer method provided with the design surface cleaning device according to claim 8 is based on the requirement of claim 7, and is further configured such that downward new water is supplied from the new water supply port toward the liquid-leaving area, a siphon-type discharge unit that sucks up the transfer liquid containing foreign substances such as film residuals from the lower side and discharges the transfer liquid to the outside of the tank is disposed on a rear face side of the new water supply port, and a sucking flow according to the siphon-type discharge unit is formed using new water supplied downward toward the liquid-leaving area.

The liquid pressure transfer method provided with the design surface cleaning device according to claim 9 is based on the requirement of claim 8, and is further configured such that the transfer tank has a tapered inclined plate disposed on the lower side of the new water supply port and is formed such that a tank depth gradually decreases toward a terminal end portion of the tank, and a sucking port of the siphon-type discharge unit is disposed so as to face an uppermost end portion of the inclined plate.

The liquid pressure transfer method provided with the design surface cleaning device according to claim 10 is based on the requirement of claim 8 or 9, and is further configured such that new water that flows in approximately parallel with the liquid-leaving area is also supplied from the new water supply port, and the new water is supplied from the new water supply port between both new water supplied upward toward the liquid-leaving area and new water supplied downward toward the liquid-leaving area.

The liquid pressure transfer method provided with the design surface cleaning device according to claim 11 is based on the requirement of claim 7, 8, 9, or 10, and is further configured such that, in the new water supply port, a punching metal is disposed in a discharge port portion supplying new water, and new water supplied from the new water supply port to the transfer tank is uniformly discharged from a relatively broad range.

The liquid pressure transfer method provided with the design surface cleaning device according to claim 12 is based on the requirement of claim 4, 5, 6, 7, 8, 9, 10, or 11, and is further configured such that, in the overflow tank forming the design surface oppositely-separating flow, a flow rate increase brim for increasing a flow rate of the transfer liquid introduced into the overflow tank is formed in a discharge port that serves as a liquid collection port.

The liquid pressure transfer method provided with the design surface cleaning device according to claim 13 is based on the requirement of claim 1, 2, 3, 4, 5, 6, 7, 8, 9, 10, 11, or 12, and is further configured such that the transfer tank is formed so as to secure a depth in which the design surface of the object is immersed into the transfer liquid in a transfer-necessary section that is until the object gets out of the liquid after being immersed into the liquid and is formed so as to have a depth smaller than the depth in the other transfer-unnecessary section.

The liquid pressure transfer method provided with the design surface cleaning device according to claim 14 is based on the requirement of claim 4, 5, 6, 7, 8, 9, 10, 11, 12, or 13, and is further configured such that the overflow tank forming the design surface oppositely-separating flow is formed to be freely movable in a longitudinal direction of the transfer tank and is moved so as to maintain a distance between the design surface of the object and the overflow tank to be almost constant even when a position of the object changes to a front or rear side in accordance with an operation of the object getting out of the liquid.

The liquid pressure transfer method provided with the design surface cleaning device according to claim 15 is based on the requirement of claim 2, 3, 4, 5, 6, 7, 8, 9, 10, 11, 12, 13, or 14, and is further configured such that the side oppositely-separating flows are formed by overflow tanks disposed on both left and right sides of the liquid-leaving area, and in the discharge port that serves as a liquid collection port in the overflow tank, a flow rate increase brim for increasing a flow rate of the transfer liquid introduced into the overflow tank is formed.

The liquid pressure transfer method provided with the design surface cleaning device according to claim 16 is based on the requirement of claim 15, and is further configured such that, in the liquid-leaving area, foreign substances staying in the transfer liquid and on the surface of the liquid are discharged by performing air blowing for pushing foam or the foreign substances generated on the liquid surface of the liquid-leaving area to one side wall of the transfer tank, and the foam and the foreign substances disposed on the liquid surface of the area are also collected by the overflow tank for forming the side oppositely-separating flows and are discharged to the outside of the tank.

The liquid pressure transfer method provided with the design surface cleaning device according to claim 17 is based on the requirement of claim 15 or 16, and is further configured such that an overflow tank for collecting the liquid surface residual films is disposed in a previous stage of the overflow tank forming the side oppositely-separating flows, and in the overflow tank, a blocking means blocking collection of the liquid is disposed in the middle of the discharge port collecting the liquid surface residual films, and the liquid surface residual films are collected from front and rear sides of the blocking means.

The liquid pressure transfer method provided with the design surface cleaning device according to claim 18 is based on the requirement of claim 17, and is further configured such that, in collecting the liquid surface residual films, until the object gets out of the transfer liquid after being immersed into the transfer liquid, the liquid surface residual films are divided to be split in a longitudinal direction of the transfer tank by a dividing means, and the divided liquid surface residual films are caused to approach both side walls of the transfer tank and are collected by the overflow tank for collecting the liquid surface residual films.

The liquid pressure transfer method provided with the design surface cleaning device according to claim 19 is based on the requirement of claim 1, 2, 3, 4, 5, 6, 7, 8, 9, 10, 11, 12, 13, 14, 15, 16, or 18, and is further configured such that the liquid pressure transfer applied to the object is performed by either applying a transfer film made by forming only a transfer pattern to a water-soluble film in a dried state and using a liquid curable resin composition as an activating agent, or applying a transfer film having a curable resin layer between a water-soluble film and a transfer pattern as a transfer film, and using the liquid pressure transfer, a transfer pattern also having a surface protection function is formed on the object, and this is cured by emission of an active energy ray and/or heating after the transfer.

A liquid pressure transfer device provided with a design surface cleaning device which supports a transfer film configured by forming at least a transfer pattern on a water-soluble film in a dried state on a liquid surface inside a transfer tank so as to float and transfers the transfer pattern mainly to a design surface side of an object in accordance with liquid pressure generated by pressing the object from an upper side, the liquid pressure transfer device according to claim 20 is configured by including: the transfer tank that stores a transfer liquid; a transfer film supply device that supplies the transfer film to the transfer tank; and an object conveying device that presses the object from the upper side with respect to the transfer film that is in an activation state on the liquid surface of the transfer tank, and is configured such that an oppositely-separating flow forming means acting on the design surface of the object that is in the process of rising from the transfer liquid is disposed in a liquid-leaving area in which the object is pulled up from the transfer liquid, a design surface oppositely-separating flow that is separated away from the design surface of the object that is in the process of getting out of a liquid is formed, and foam disposed on the surface of the transfer liquid and foreign substances staying in the liquid are separated away from the design surface of the object that is in the process of getting out of the liquid and are discharged outside the transfer tank in accordance with the design surface oppositely-separating flow.

The liquid pressure transfer device provided with the design surface cleaning device according to claim 21 is based on the requirement of claim 20, and is further configured such that a discharge means that collects the transfer liquid near the liquid surface is disposed on both left and right sides of the liquid-leaving area, side oppositely-separating flows from a decoration-unnecessary surface side that is a rear side of the design surface of the object in the process of getting out of the liquid toward both side walls of the transfer tank are formed, and the foreign substances staying in the transfer liquid and on the surface of the liquid are separated away from the liquid-leaving area and are discharged outside the transfer tank in accordance with the side oppositely-separating flows.

The liquid pressure transfer device provided with the design surface cleaning device according to claim 22 is based on the requirement of claim 20 or 21, and is further configured such that a discharge means discharging liquid surface residual films, which are not used for the transfer due to immersion of the object, floating on the liquid surface from the transfer tank is disposed on a previous stage of the liquid-leaving area, and the liquid surface residual films are collected until the object gets out of the liquid so as not to arrive at the liquid-leaving area.

The liquid pressure transfer device provided with the design surface cleaning device according to claim 23 is based on the requirement of claim 20, 21, or 22, and is further configured such that the design surface oppositely-separating flow is formed by an overflow tank disposed so as to face the design surface of the object that is in the process of getting out of the liquid.

The liquid pressure transfer device provided with the design surface cleaning device according to claim 24 is based on the requirement of claim 23, and is further configured such that an overflow tank collecting the transfer liquid is further disposed at a rear stage of the overflow tank disposed so as to face the design surface of the object that is in the process of getting out of the liquid.

The liquid pressure transfer device provided with the design surface cleaning device according to claim 25 is based on the requirement of claim 23 or 24, and is further configured such that the design surface oppositely-separating flow is generated by supplying new water such as clean water not containing foreign substances or purified water acquired by removing foreign substances from the transfer liquid collected from the transfer tank from a lower side of the overflow tank for forming the design surface oppositely-separating flow toward the liquid-leaving area disposed on an upstream side.

The liquid pressure transfer device provided with the design surface cleaning device according to claim 26 is based on the requirement of claim 23, and is further configured such that a new water supply port that supplies new water such as clean water not containing foreign substances or purified water acquired by removing foreign substances from the transfer liquid collected from the transfer tank into the inside of the tank is disposed on the lower side of the overflow tank for forming the design surface oppositely-separating flow, and the design surface oppositely-separating flow is formed using new water supplied upward from the new water supply port toward the liquid-leaving area.

The liquid pressure transfer device provided with the design surface cleaning device according to claim 27 is based on the requirement of claim 26, and is further configured such that downward new water is supplied from the new water supply port toward the liquid-leaving area, a siphon-type discharge unit that sucks up the transfer liquid containing foreign substances such as film residuals from the lower side and discharges the transfer liquid to the outside of the tank is disposed on a rear face side of the new water supply port, and a sucking flow according to the siphon-type discharge unit is formed using new water supplied downward toward the liquid-leaving area.

The liquid pressure transfer device provided with the design surface cleaning device according to claim 28 is based on the requirement of claim 27, and is further configured such that the transfer tank has a tapered inclined plate disposed on the lower side of the new water supply port and is formed such that a tank depth gradually decreases toward a terminal end portion of the tank, and a sucking port of the siphon-type discharge unit is disposed so as to face an uppermost end portion of the inclined plate.

The liquid pressure transfer device provided with the design surface cleaning device according to claim 29 is based on the requirement of claim 27 or 28, and is further configured such that new water that flows in approximately parallel with the liquid-leaving area is also supplied from the new water supply port, and the new water is supplied from the new water supply port between both new water supplied upward toward the liquid-leaving area and new water supplied downward toward the liquid-leaving area.

The liquid pressure transfer device provided with the design surface cleaning device according to claim 30 is based on the requirement of claim 26, 27, 28, or 29, and is further configured such that, in the new water supply port, a punching metal is disposed in a discharge port portion supplying new water, and new water supplied from the new water supply port to the transfer tank is uniformly discharged from a relatively broad range.

The liquid pressure transfer device provided with the design surface cleaning device according to claim 31 is based on the requirement of claim 23, 24, 25, 26, 27, 28, 29, or 30, and is further configured such that, in the overflow tank forming the design surface oppositely-separating flow, a flow rate increase brim for increasing a flow rate of the transfer liquid introduced into the overflow tank is formed in a discharge port that serves as a liquid collection port.

The liquid pressure transfer device provided with the design surface cleaning device according to claim 32 is based on the requirement of claim 20, 21, 22, 23, 24, 25, 26, 27, 28, 29, 30, or 31, and is further configured such that the transfer tank is formed so as to secure a depth in which the design surface of the object is immersed into the transfer liquid in a transfer-necessary section that is until the object gets out of the liquid after being immersed into the liquid and is formed so as to have a depth smaller than the depth in the other transfer-unnecessary section.

The liquid pressure transfer device provided with the design surface cleaning device according to claim 33 is based on the requirement of claim 23, 24, 25, 26, 27, 28, 29, 30, 31, or 32, and is further configured such that the overflow tank forming the design surface oppositely-separating flow is formed to be freely movable in a longitudinal direction of the transfer tank and is moved so as to maintain a distance between the design surface of the object and the overflow tank to be almost constant even when a position of the object changes to a front or rear side in accordance with an operation of the object getting out of the liquid.

The liquid pressure transfer device provided with the design surface cleaning device according to claim 34 is based on the requirement of claim 21, 22, 23, 24, 25, 26, 27, 28, 29, 30, 31, 32, or 33, and is further configured such that, as the discharge means forming the side oppositely-separating flows, overflow tanks disposed on both left and right sides of the liquid-leaving area are applied, and in the discharge port that serves as a liquid collection port in the overflow tank, a flow rate increase brim for increasing a flow rate of the transfer liquid introduced into the overflow tank is formed.

The liquid pressure transfer device provided with the design surface cleaning device according to claim 35 is based on the requirement of claim 34, and is further configured such that, in the transfer tank, an air blowing device pushing foam or foreign substances generated on the liquid surface of the liquid-leaving area to one side wall of the transfer tank is disposed, and the foam and the foreign substances disposed on the liquid surface of the area are also discharged from the overflow tank for forming the side oppositely-separating flows to the outside of the tank together with discharge of foreign substrates staying in the transfer liquid and on the surface of the liquid.

The liquid pressure transfer device provided with the design surface cleaning device according to claim 36 is based on the requirement of claim 34 or 35, and is further configured such that an overflow tank for collecting the liquid surface residual films is disposed in a previous stage of the overflow tank forming the side oppositely-separating flows, and in the overflow tank, a blocking means blocking collection of the liquid is disposed in the middle of the discharge port collecting the liquid surface residual films, and the liquid surface residual films are collected from front and rear sides of the blocking means.

The liquid pressure transfer device provided with the design surface cleaning device according to claim 37 is based on the requirement of claim 36, and is further configured such that a dividing means dividing the liquid surface residual films right after the transfer to be split in a longitudinal direction of the transfer tank is disposed in a previous stage of the overflow tank collecting the liquid surface residual films, and when the liquid surface residual films are collected, the liquid surface residual films divided by the dividing means are collected by the overflow tank until the object gets out of the transfer liquid after being immersed into the transfer liquid.

The liquid pressure transfer device provided with the design surface cleaning device according to claim 38 is based on the requirement of claim 20, 21, 22, 23, 24, 25, 26, 27, 28, 29, 30, 31, 32, 33, 34, 35, 36, or 37, and is further configured such that, as the transfer film, either a film acquired by forming only a transfer pattern on a water-soluble film in a dried state or a film in which a resin layer having hardenability is included between a water-soluble film and the transfer pattern is applied, and, in a case where the film in which only the transfer pattern is formed on the water-soluble film in the dried state is applied, a liquid resin composite material having hardenability is used as an activating agent, and when the liquid pressure transfer is performed using the resin composite material, a transfer pattern having also a surface protection function is formed on the object, and the transfer pattern is hardened by radiation of an active energy ray or/and heating after the transfer.

### Advantageous Effects of Invention

The constitution of the invention described in each claim is used as means for solving the above problems.

First, according to invention described in claim 1 or 20, for an object getting out of the liquid, a design surface oppositely-separating flow is formed in a direction separating away from a design surface, and accordingly, it is difficult for foreign substances such as foam and film residuals to adhere to the design surface, and a clean transfer product (object) can be acquired. In addition, since it is difficult for the foam and the foreign substances to adhere to the design surface, a transfer pattern can be accurately transferred, and it is difficult for pattern distortion or deformation to occur.

In addition, according to the invention described in claim 2 or 21, since a side oppositely-separating flow is formed at both sides of a liquid-leaving area, foreign substances such as film residuals staying in the transfer liquid or foam generated on the surface of the transfer liquid can be discharged to the outside of the transfer tank by loading them in the side oppositely-separating flow, whereby a more clean transfer product (object) can be acquired.

In addition, according to the invention described in claim 3 or 22, since a residual film disposed on the liquid surface is collected until the object gets out of the liquid after immersion thereof, the residual film disposed on the liquid surface does not arrive at the liquid-leaving area, and a further more clean transfer product (object) can be acquired.

In addition, according to the invention described in claim 4 or 23, a technique for forming the design surface oppositely-separating flow is more specific, and the design surface oppositely-separating flow can be accurately acted on the design surface of the object getting out of the transfer liquid. In addition, although the operation and the purpose are different from those of the invention, an overflow tank has been conventionally used for such a kind of the transfer tank (liquid pressure transferring technique), and accordingly, the above-described invention can be easily employed from a viewpoint of the design of the liquid pressure transfer device and a viewpoint of performing a method of transferring liquid pressure.

In addition, according to the invention described in claim 5 or 24, at the rear stage of an overflow tank (first-stage OF tank) for forming the design surface oppositely-separating flow, an overflow tank (second-stage OF tank) is additionally arranged, and accordingly, the flow of the liquid inside the transfer tank can be controlled as below. First, since the first-stage OF tank becomes resistance for a liquid flow, a middle layer stream at a height (depth) at which the first-stage OF tank is approximately arranged becomes a flow slipping through the lower side of the OF tank. In other words, the middle layer stream becomes a downward flow getting into the lower side of the OF tank right before the first-stage OF tank and becomes an upward flow after passing through the first-stage OF tank. On the other hand, an upper layer stream (a surface stream inside the transfer tank) flowing through a position (liquid level) higher than that of the middle layer stream is directly collected by the first-stage OF tank. In addition, a lower layer stream (a liquid flow flowing through the bottom of the transfer tank) flowing through a position lower than that of the middle layer stream directly flows horizontally regardless of the first-stage OF tank, and a curtain effect occurs in which it is difficult to cause foreign substances contained in the middle layer stream to be deposited and stay at the bottom of the transfer tank. In addition, after passing through the first-stage OF tank, the middle layer stream becomes an upward flow, and accordingly, the lower layer stream is pulled upward, and foreign substances considered to be contained much particularly in the lower face of the middle layer stream in the transfer liquid in accordance with the upward flows according to the middle layer stream and the lower layer stream are sent to the second-stage OF tank and can be efficiently collected therein.

In addition, according to the invention described in claim 6 or 25, since the design surface oppositely-separating flow is generated by using new water supplied from the lower side of the overflow tank for forming the design surface oppositely-separating flow, a remarkably clean transfer product (object) can be acquired, compared to a case where the collected transfer liquid is reused as the design surface oppositely-separating flow almost as it is.

In addition, according to the invention described in claim 7 or 26, since the design surface oppositely-separating flow is generated by using new water (clean water not containing foreign substances or purified water acquired by removing foreign substances from the collected liquid) supplied upward toward the liquid-leaving area from the lower side of the overflow tank for forming the design surface oppositely-separating flow, a flow (design surface oppositely-separating flow) from the lower side toward the upper side along the design surface of the object getting out of the liquid can be more reliably formed. In addition, compared to a case where the collected transfer liquid is reused as the design surface oppositely-separating flow almost as it is, a remarkably clean transfer product (object) can be acquired.

In addition, according to the invention described in claim 8 or 27, since a siphon-type discharge unit is arranged on the rear face side of the new water supply port supplying new water downward toward the liquid-leaving area, after the transfer liquid, particularly, foreign substances such as film residuals staying in the middle layer water are conveyed (caused to flow) toward the lower side (bottom) of the transfer tank, the transfer liquid is sucked up therefrom and can be effectively collected. Accordingly, the foreign substances are prevented from rising to the liquid-leaving area disposed on the upper side, and accordingly, the liquid-leaving area can be maintained to be in a more clean state. In addition, even when all the transfer liquid is not sucked up by the siphon-type discharge unit, new water forms a sucking flow inside the transfer tank, and a flow (downward flow) toward the sucking port can be formed, whereby a downward flow promoting sedimentation and separation can be formed at the bottom of the transfer tank.

In addition, according to the invention described in claim 9 or 28, since the tapered inclined plate is arranged at the bottom of the terminal end of the processing tank, and the sucking port of the siphon-type discharge unit is arranged so as to face the uppermost end portion of the inclined plate, a sucking flow according to the siphon-type discharge unit can be more efficiently formed from new water supplied downward toward the liquid-leaving area. In other words, the flow of the transfer liquid rising in accordance with the inclination of the inclined plate can be efficiently taken into the sucking port of the siphon-type discharge unit with the power thereof being maintained, and accordingly, the formation of a sucking flow from new water can be more easily performed.

In addition, according to the invention described in claim 10 or 29, between new water supplied upward and new water supplied downward from the new water supply port, since new water flowing in parallel with the liquid-leaving area is also supplied, this promotes (prevents inhibition from each other) the action of the new water supplied upward and the new water supplied downward, thereby contributing to an increase in the clean zone in the liquid-leaving area.

In addition, according to the invention described in claim 11 or 30, since the punching metal is arranged in a portion of the discharge port of the new water supply port, new water supplied therefrom to the transfer tank is uniformly discharged from a relatively broad range, and the supply of the new water in a partially straight state can be prevented.

In addition, according to the invention described in claim 12 or 31, since the flow rate increase brim is formed in the overflow tank for forming the design surface oppositely-separating flow, foreign substances floating near the liquid surface disposed on the design surface side mainly in the liquid-leaving area, foam disposed on the liquid surface, and the like can be collected more reliably.

In addition, according to the invention described in claim 13 or 32, since the transfer tank is not formed to have the same depth (a depth for which the object is completely immersed into the transfer liquid) over the whole length (longitudinal direction) but is formed to be shallow in a portion such as a film supply end portion that is not necessary for the transfer, the amount of transfer liquid housed in the transfer tank is smaller than that of a case where the whole transfer tank is formed to have the same depth.

In addition, according to the invention described in claim 14 or 33, even in a case where the overflow tank for forming the design surface oppositely-separating flow is movable in the longitudinal direction of the transfer tank, and a distance between the object and the overflow tank changes in accordance with the leaving of the liquid as it is, by moving the overflow tank to the front side or the rear side in accordance with the change, the distance can be maintained to be almost constant (the liquid leaving position with respect to the overflow tank can be constant), and foam and foreign substances can be collected further more reliably.

In addition, according to the invention described in claim 15 or 34, since the side oppositely-separating flow is formed by the overflow tank, and the flow rate increase brim is formed in the overflow tank, foreign substances floating near the liquid surface disposed on the decoration-unnecessary surface side mainly in the liquid-leaving area, foam disposed on the liquid surface, and the like can be collected more reliably.

In addition, according to the invention described in claim 16 or 35, in addition to the formation of the side oppositely-separating flow using the overflow tank, foam and foreign substances generated on the liquid surface of the liquid-leaving area are sent to one of the overflow tanks by air blow, and accordingly, in accordance with such a synergistic effect, the liquid-leaving area is cleaned (in the liquid and on the liquid surface) with a high level. In other words, the wrapping around of foam, foreign substances, and the like that may be generated on the liquid surface of the liquid-leaving area and in the liquid to the design surface side can be prevented at a high level.

In addition, according to the invention described in claim 17 or 36, since residual films disposed on the liquid surface are collected by the overflow tank arranged at the previous stage of the overflow tank for forming the side oppositely-separating flow, and the blocking means blocking the collection of the liquid is arranged in this overflow tank, the residual films disposed on the liquid surface can be collected in two stages before and after the blocking means in the same overflow tank, and the induced flow rate of the collection can be controlled by the blocking means. Accordingly, the residual films disposed on the liquid surface are not pulled as a whole (without having an adverse effect on the transfer film at the transfer position), and the residual films disposed on the liquid surface can be reliably collected.

In addition, according to the invention described in claim 18 or 37, since the residual films disposed on the liquid surface are collected after dividing the residual films, after the transfer, the residual films disposed on the liquid surface can be collected quickly and reliably. In addition, since the residual films disposed on the liquid surface do not arrive at the liquid-leaving area, and the residual films disposed on the liquid surface can be prevented from adhering to the design surfaces of objects sequentially rising from the transfer liquid.

In addition, according to the present invention, since the residual films disposed on the liquid surface are divided and then collected, the film that has not been transferred is not pulled as a whole, and the residual films disposed on the liquid surface can be collected without deforming a transfer film before transfer such as a transfer position.

In addition, according to the invention described in claim 19 or 38, since the transfer pattern additionally having the surface protection function is formed on the object according to the liquid pressure transfer, and the transfer pattern is cured by the radiation of an activation energy ray or/and heating performed thereafter, prevention of foreign substances such as film residuals, foam, and the like from adhering to the object pulled up from the transfer liquid is important, and such a liquid pressure transfer (a liquid pressure transfer forming a transfer pattern additionally having the surface protection function) can be performed with an extremely low fraction defective.

### BRIEF DESCRIPTION OF DRAWINGS

FIG. 1 represents a plan view and a sectional side view illustrating an example of a liquid pressure transfer device including a design surface cleaning mechanism according to the present invention.

FIG. 2 is a sectional side view that illustrates the internal structure of a transfer tank, particularly, the use status of a transfer liquid in combination with the above-described plan view.

FIG. 3 is an explanatory diagram that schematically illustrates the appearance of a liquid flow inside the transfer tank in a two-stage OF structure in which a terminal end overflow tank (second-stage OF tank) is additionally disposed at the rear stage of an overflow tank (first-stage OF tank) for forming a design surface oppositely-separating flow.

FIG. 4 is a structural perspective view that illustrates the transfer tank.

FIG. 5 is a perspective view that illustrates an example of the process in a case where a film holding mechanism is configured by a belt.

FIG. 6 is a plan view illustrating a transfer tank in which two air blowing devices are used as a dividing means of a liquid surface residual film, and the film is divided into three parts in a direction of the flow of a liquid, so that the divided films are collected at three locations.

FIG. 7 is a plan view illustrating a transfer tank in which three air blowing devices are used as a dividing means of a liquid surface residual film, and the film is divided into two parts in a direction of the flow of a liquid.

FIG. 8 is an explanatory diagram (a diagram of a film holding mechanism when it is seen from a side) illustrating a modified example in which the divided liquid surface residual films are moved to side wall portions of the transfer tank, and when the divided liquid surface residual films are discharged from there, an action of holding the film by using the film holding mechanism is cancelled in a case where a chain conveyer is applied as the film holding mechanism.

FIG. 9 is a plan view illustrating and comparing a situation (a) where the action of holding the film by using the film holding mechanism is exerted up to the overflow tanks for collecting the liquid surface residual films and a situation (b) where the action of holding the film is not exerted up to the overflow tanks.

FIG. 10 includes a structural perspective view (a) illustrating a transfer tank to which an in-tank blocking body is applied as a blocking means to block the collection of the liquid in an overflow tank for collecting liquid surface residual films and a perspective view (b) and a cross sectional view (c) enlarging and illustrating only the overflow tank.

FIG. 11 is a plan view illustrating a transfer tank in which the liquid surface residual film is divided into two parts in the direction of the flow of the liquid, which are collected at four locations.

FIG. 12 includes a structural perspective view (a) illustrating a transfer tank including a design surface cleaning mechanism in combination with a conveyer (triangular conveyer) as an object conveying device and explanatory diagrams (b) and (c) that enlarge and illustrate the appearances of an oppositely-separating flow on the design surface applied to the object during getting out of the liquid.

FIG. 13 is an explanatory diagram illustrating a design surface slowly getting away from the overflow tank for forming an oppositely-separating flow on the design surface due to a curved state, the degree of projection and depression, and the like of an object even in a case where the object is pulled up at a constant inclined posture and liquid-leaving angle.

FIG. 14 is an explanatory diagram illustrating a preferred operating status of the overflow tank for forming an oppositely-separating flow on the design surface in a stepped manner in a case where the liquid pressure transfer is performed in a batch process, in other words, in a case where an object is pulled up straight in a constant inclined posture.

FIG. 15 is a side view illustrating an object conveying device made by connecting a triangular conveyer unit and a straight conveyer unit with a liquid-exiting side wheel, wherein a case where the angle of entering the liquid is relatively small is denoted with a solid line in (a), and a case where the angle of entering the liquid is relatively large is denoted with a solid line in (b).

FIG. 16 is a side view illustrating the object conveying device in which an entire conveying orbit is formed in a rectangular shape in the state of view from the side surface, wherein the angle of entering the liquid and the angle of exiting from the liquid can be changed.

FIG. 17 is a partial side view illustrating the object conveying device in which the object is gradually moved upward in the transfer liquid in a section between a liquid-entering side wheel and a liquid-exiting side wheel.

FIG. 18 is a side view illustrating the object conveying device in which, after the liquid-exiting side wheel, the object is conveyed to the liquid-entering side in a folded manner.

FIG. 19 includes an explanatory diagram, corresponding to FIG. 1, illustrating and associating a transfer tank and an example of movement of the object in a robot transfer to which a manipulator is applied and an explanatory diagram illustrating a preferred liquid leaving status of an object in an enlarged scale.

FIG. 20 includes a rear view and sectional view (a) illustrating an object having an opening portion in the design surface wherein a thin film derivative is provided with a clearance at the back surface side of this opening portion, and explanatory diagrams (b) and (c) illustrating liquid pressure transfer and ultraviolet ray emission with the thin film derivative.

FIG. 21 is an explanatory diagram illustrating an embodiment in which, when a thin film derivative is provided on an object, a clearance with the opening portion is not constant but is different on the entire periphery.

FIG. 22 is an explanatory diagram illustrating a case where during liquid pressure transfer, not only a transfer pattern but also a surface protection layer are formed, and thereafter, the decorative layers are cured by ultraviolet ray emission and the like, and the explanatory diagram illustrates how bubbles attach to the design surface during the liquid pressure transfer and how the ultraviolet ray is emitted in this state.

FIG. 23 is an explanatory diagram schematically illustrating how a transfer film supplied onto the transfer liquid surface curls upward due to a difference of elongation between a transfer pattern at an upper side and a water-soluble film at a lower side in general.

FIG. 24 is a sectional side view that illustrates another embodiment (Another Embodiment 1), in which the internal structure of a transfer tank, particularly, the use status of a transfer liquid is differently configured, in combination with a plan view.

FIG. 25 is an enlarged explanatory diagram illustrating the form of emitting new water supplied from a new water supply port to a transfer tank together with the form of sucking a transfer liquid using a siphon type discharge unit according to Another Embodiment 1 illustrated in FIG. 24.

FIG. 26 is a structural perspective view illustrating a transfer tank according to Another Embodiment 1 illustrated in FIG. 24.

FIG. 27 is a perspective view illustrating an example of a liquid pressure transfer device according to another embodiment (Another Embodiment 2) in which a transfer film is supplied to a transfer liquid surface and then is activated.

FIG. 28 is a side view mainly illustrating a transfer tank and a film detachment cleaning device according to Another Embodiment 2.

FIG. 29 is a side view illustrating an example of a liquid pressure transfer device according to Another Embodiment 2.

FIG. 30 includes a plan view and a side view illustrating a liquid pressure transfer device, in which a post-activation guide mechanism (and a pre-activation guide mechanism) is partly changed, according to Another Embodiment 2.

FIG. 31 includes a plan view (a) and a side view (b) illustrating the appearance of an airflow generated inside a hood of an activation area according to a catch basin and the appearance in which an air containing an unnecessary activating agent component collected thereby is cleaned by being dissolved into a transfer liquid (collected liquid) in Another Embodiment 2.

FIG. 32 includes an explanatory diagram (side view) (a) illustrating a projection/depression molding roller that forms projections and depressions used for preventing curls on a transfer film, an explanatory diagram (side view) (b) illustrating the appearance in which the projections and depressions used for preventing curls are formed by a laser marker, and an explanatory diagram (cross sectional view) (c) illustrating an appearance in which the projections and depressions used for preventing curls are formed as projections and depressions having key shapes when viewed from the side surface in Another Embodiment 2.

FIG. 33 is a plan view illustrating a liquid pressure transfer device in which the pre-activation guide mechanism, an elongation and extension reduction prevention mechanism, and the like are partly modified in Another Embodiment 2.

FIG. 34 is a perspective view illustrating a pre-activation guide mechanism and a post-activation guide mechanism that can appropriately change the width dimension (guide width dimension) maintaining and regulating both sides of the transfer film in Another Embodiment 2.

FIG. 35 includes a table illustrating changes in a weekly transfer amount, the amount of exchanged water of transfer water, and a PVA density according to a conventional liquid pressure transferring technique and a graph illustrating the relation between the PVA density and the PH of the transfer tank water at that time.

### REFERENCE SINGS LIST

1 liquid pressure transfer device
1A liquid pressure transfer device (Another Embodiment 1)
1B liquid pressure transfer device (Another Embodiment 2)
2 transfer tank
3 transfer film supply device
4 activating agent applying device
5 object conveying device
6 film holding mechanism
7 liquid surface residual film collecting mechanism
8 liquid-leaving area cleaning mechanism
9 design surface cleaning mechanism
10 elongation and extension reduction prevention mechanism
2 transfer tank
21 processing tank
22 side wall
23 inclined plate
24 inclined part
26 air blowing device
28 frame
29 frame
3 transfer film supply device
31 film roll
32 heat roller
33 guide conveyer
34 guide roller
4 activating agent applying device
41 roll coater
5 object conveying device
51 conveyer
52 jig holder
53 link chain
54 link bar
55 triangular conveyer unit
56 liquid-entering side wheel
57 liquid-exiting side wheel
58 straight conveyer unit
58A straight conveyer unit
58B straight conveyer unit
59 chain wheel
59A chain wheel
59B chain wheel
110 robot (multi-joint robot)
111 hand (transfer robot)
112 hand (handling robot)
120 thin film derivative
6 film holding mechanism
61 conveyer
62 pulley
62A leading end pulley
62B terminal end pulley
62C relay pulley
62D position fixed pulley
62E vertical movement pulley
63 belt
63G forward belt
63B backward belt
63C tension adjustment unit
64 rotary shaft
65 arm bar
66 clamp
67 chain conveyer
68 chain
69A guide body
69B guide body
7 liquid surface residual film collecting mechanism
71 dividing means
72 discharge means
73 air blowing device
73a auxiliary air blowing device
73b auxiliary air blowing device
75 overflow tank
75a auxiliary overflow tank
76 discharge port
76a discharge port
77 blocking means
78 sheathing board
79 in-tank blocking body
79a dam action unit
79b foot unit
8 liquid-leaving area cleaning mechanism
81 discharge means
82 overflow tank
83 discharge port
84 flow rate increase brim
85 air blowing device
9 design surface cleaning mechanism
91 oppositely-separating flow forming means
92 overflow tank (first-stage OF tank)
93 discharge port
94 flow rate increase brim
95 sucking nozzle
97 terminal end overflow tank (second-stage OF tank)
98 rear side overflow tank (rear side OF tank)
107 new water supply port
108 siphon-type discharge unit
108a sucking port
108b siphon path
10 elongation and extension reduction prevention mechanism
101 removing means
102 compressed air blow nozzle
A bubble
C conveyer (for UV emission step)
CL clearance
F transfer film
FL dividing line
F′ liquid surface residual film
f transferred decorative layer
J jig
JL jig leg
K activating agent component
L transfer liquid
M thin film
W object
Wa opening portion
P1 immersion area (transfer position)
P2 liquid-leaving area
P3 dividing start point
S1 design surface
S2 decoration-unnecessary surface
LR design surface oppositely-separating flow
LS side oppositely-separating flow
LV suction flow
PU new water (upward)
PD new water (downward)
PP new water (parallel)
1B liquid pressure transfer device
20 transfer tank
30 transfer film supply device
40 activating agent applying device
50 object conveying device
60 pre-activation guide mechanism
70 post-activation guide mechanism
80 elongation and extension reduction prevention mechanism
90 film detaching and cleaning device
20 transfer tank
21 processing tank
22 side wall
203 overflow unit
204 circulating pipe path
30 transfer film supply device
31 film roll
302 projection/depression molding roller
303 rubber smoothing roller
304 serration roller
305 gear (wave-shaped teeth)
306 gear (wave-shaped teeth)
307 laser marker
40 activating agent applying device
401 spray gun
402 hood
50 object conveying device
51 conveyer
52 jig holder
53 link chain
60 pre-activation guide mechanism
601 conveyer
602 pulley
602A driving pulley
602B driven pulley
603 belt
604 rotary shaft
605 arm bar
606 clamp
70 post-activation guide mechanism
701 chain conveyer
702 sprocket
703 chain
704 rotary shaft
80 elongation and extension reduction prevention mechanism
801 removing means
802 catch basin
803 mist separator
804 air discharge fan
805 compressed air extraction nozzle
90 film detaching and cleaning device
901 conveyer
902 warm water shower
902a supply pipe path
903 rinse water shower
903a supply pipe path
904 storage tank
905 circulating water discharge pipe path
R curl preventing projection and depression
Z1 liquid contact point
Z2 activation area
Z3 transfer area

### DESCRIPTION OF EMBODIMENTS

Modes for carrying out the present invention include an embodiment described below as one of such modes and further include various kinds of methods that can be achieved by making improvements within the technical scope thereof.

In addition, in the description, first, a transfer film F that is appropriately used in the present invention will be described, and then, the whole configuration of a liquid pressure transfer device 1 will be described.

### Embodiments

First, the transfer film F preferably used in the present invention will be explained. In the present invention, during liquid pressure transfer, only a transfer pattern is not simply transferred onto an object W, and it is preferable to transfer a transfer pattern also having a surface protection function (in this specification, such transfer pattern will be referred to as “transfer pattern also having surface protection function”). This is because a top coating conventionally performed after the transfer is not needed. That is, in the liquid pressure transfer that also gives the surface protection function, the transfer pattern formed by the liquid pressure transfer is cured by emitting active energy ray such as ultraviolet ray and an electron beam to the object W to which the transfer pattern has been transferred, so that the surface can be protected. Nonetheless, it is also possible to further apply a top coating after the transfer pattern also having the surface protection function has been transferred.

Due to such facts, the transfer film F is preferably a film having only a transfer pattern made of transfer ink on a water-soluble film (for example, PVA (polyvinyl alcohol) or a film having a curable resin layer formed between a water-soluble film and a transfer pattern. In particular, when the transfer film F having only the transfer pattern formed on the water-soluble film is used, a liquid curable resin composition is used as an activating agent. In this case, the curable resin composition is preferably a solvent-free ultraviolet or electron beam curable resin composition including photopolymerizable monomer.

It is to be understood that the design surface cleaning mechanism 9, which is a featured configuration of the present invention, can also be applied even when a transfer film F having only a transfer pattern formed on a water-soluble film is used but the surface protection function is not given during the liquid pressure transfer and thereafter an ordinary top coating is applied to provide surface protection (conventional method for transferring liquid pressure).

In this case, transfer patterns include various kinds of patterns such as a wood form pattern, a metallic (gloss) form pattern, a stone form pattern imitating a surface of a rock such as a marble form, a fabric form pattern imitating a grain and a fabric-like form, a pattern such as a tiling form and a bricklaying form, and a pattern having a geometric form and hologram effect. Further, the transfer pattern may be a pattern made by appropriately combining the above patterns. It should be noted that the above geometric form includes not only figures but also patterns having characters and pictures applied thereon.

Surfaces of the object W will be defined. First, a transfer surface having a decorative layer formed thereon is a design surface 51. This design surface S1 is a surface that requires a precise transfer, and is a surface facing the transfer film F (transfer pattern) floating on a transfer liquid surface when the object W is immersed into the liquid. In this case, as described above, when the transfer pattern also having the surface protection function is formed during the liquid pressure transfer, the design surface 51 of the object W is prevented, as much as possible, from being attached to a liquid surface residual film F′, a redundant film, film residues, bubbles A, and the like.

On the other hand, a surface of the object W on which the decorative layer is not formed (surface that does not require any liquid pressure transfer) is a decoration-unnecessary surface S2. No problem would be caused when the film residues, the bubbles A, and the like attach to the decoration-unnecessary surface S2 (for example, no problem would be caused when the transfer pattern coming from the design surface S1 is transferred onto the decoration-unnecessary surface S2 in a distorted state).

Therefore, in other words, the design surface 91 is a portion which is seen as an external appearance when the object W (liquid pressure transfer product) is ultimately made into a completed product assembled as an assembly and the like. The decoration-unnecessary surface S2 is a portion which is not seen as an external appearance in the assembled state, and is usually at the back side of the design surface S1.

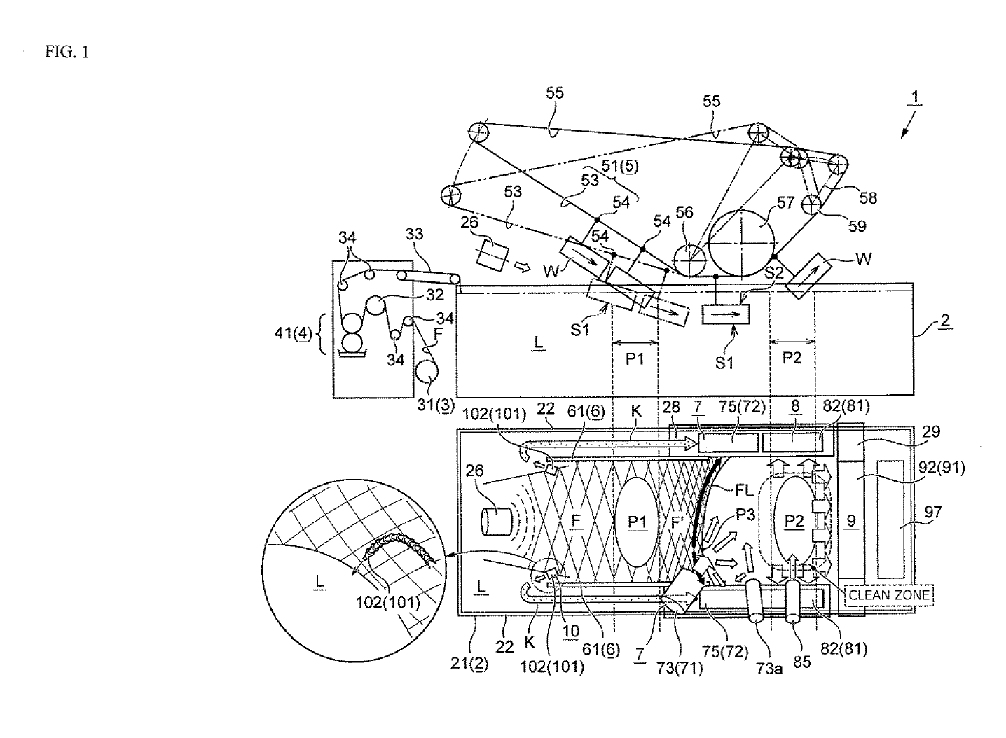

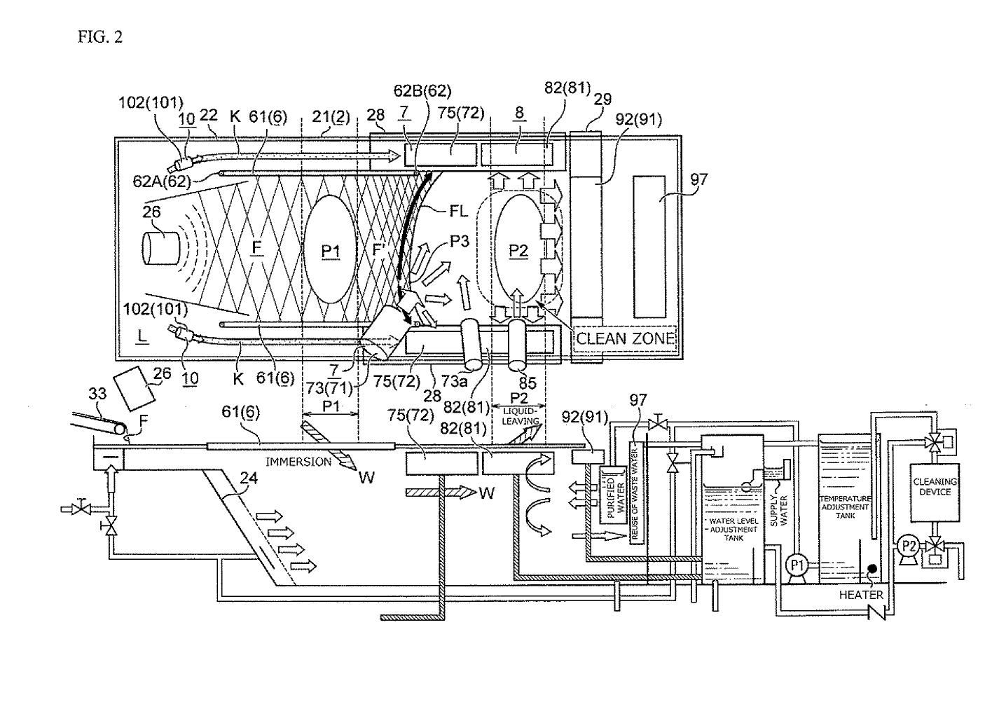

Subsequently, the liquid pressure transfer device 1 will be explained. For example, as shown in FIGS. 1 and 2, the liquid pressure transfer device 1 includes a transfer tank 2 for storing the transfer liquid L, a transfer film supply device 3 for supplying the transfer film F to this transfer tank 2, an activating agent applying device 4 for activating the transfer film F thereby rendering the transfer film F in a transferrable state, and an object conveying device 5 for placing (immersing) the object W in an appropriate posture from the upper side of the transfer film F supported in a floating manner in the transfer tank 2 and removing (pulling out) the object W from the liquid.

In addition, the transfer tank 2 includes a film holding mechanism 6 for holding both sides of the transfer film F supplied onto the surface of the transfer liquid, a liquid surface residual film collecting mechanism 7 for collecting (discharging) the liquid surface residual film F′, which is unnecessary after the object W is immersed, from the transfer tank 2, a liquid-leaving area cleaning mechanism 8 for mainly cleaning a liquid-leaving area (mainly the decoration-unnecessary surface S2 of the object W that comes out of the liquid (side opposite to the design surface S1)), a design surface cleaning mechanism 9 for cleaning the design surface S1 of the object W that ascends in the liquid-leaving area, and an elongation and extension reduction prevention mechanism 10 for preventing reduction of elongation and extension of the transfer film F that is supplied onto the surface of the transfer liquid L, by removing an activating agent component K leaving the transfer film F coming into contact with the liquid and flowing onto the surface of the transfer liquid, and particularly, in this invention, the design surface cleaning mechanism 9 is essential. Hereinafter, each constituent unit will be explained.

First, the transfer tank 2 will be explained. The transfer tank 2 is a portion where the transfer film F is supported in a floating manner when the liquid pressure transfer is performed. The transfer tank 2 includes, as a main constituent unit member, processing tank 21 that can store the transfer liquid L at a substantially constant liquid level (water level). For this reason, the upper side of the processing tank 21 is open. The processing tank 21 has a shape having a bottom enclosed by side walls in the front, the rear, the right, and the left of the processing tank 21. In particular, reference numeral 22 is given to both side walls constituting both right and left sides of the processing tank 21.

In this case, a position of the processing tank 21 where the processed object W is put into the transfer liquid L (inlet position) is referred to as an immersion area P1, and a position of the processing tank 21 where the processed object W is pulled out of the transfer liquid L (outlet position) is referred to as a liquid-leaving area P2. It should be noted that, in the liquid pressure transfer, the transfer is executed and completed as soon as the object W is immersed, and therefore, the immersion area P1 may also be called a transfer position (transfer area). The reason why the term “area” is mainly used in the above naming is that, depending on the type and the condition of the transfer pattern of the transfer film F, the transfer position is usually moved to the front or the rear and the transfer film F (transfer pattern) is transferred onto the design surface S1 having a certain size of area, and this means that, in many cases, the object W is immersed into the liquid and removed from the liquid with a certain angle with respect to the surface of the liquid (with a certain range or size of area). In addition, the angle of entering the liquid cannot be regarded as being necessarily maintained to be constant until the object W is totally immersed after starting to be immersed, and this applies the same to the angle of existing from the liquid, and the angle of exiting from the liquid cannot be regarded as being necessarily maintained to be constant until the object W completely gets out of the liquid after starting to get out of the liquid.

Here, the transfer tank 2 (processing tank 21) is configured in such a manner that when performing a liquid pressure transfer, the liquid-leaving direction from the immersion for moving the object W is the longitudinal direction; in other words, the longitudinal direction is from an immersion area P1 toward a liquid-leaving area P2. It is to be understood that, in this embodiment, the “longitudinal direction (of the transfer tank 2)” also corresponds to the liquid flow direction formed on the liquid surface of the transfer tank 2.

In this embodiment, while the object W is immersed into the transfer liquid L, a film (an unnecessary liquid surface residual film F′ that has not been used for the transfer) remaining on the surface of the liquid is divided in the longitudinal direction (the direction of the flow of the liquid/the direction from the immersion area P1 to the liquid-leaving area P2) of the transfer tank 2, and therefore, an interval between the immersion area P1 and the liquid-leaving area P2 is preferably spaced apart by a certain distance. It should be noted that the liquid surface residual film F′ that is divided in the longitudinal direction of the transfer tank 2 is thereafter moved (conveyed) to the both side walls 22 of the transfer tank 2, and the liquid surface residual film F′ is discharged (collected) from the both side walls 22 to the outside of the transfer tank 2.

Inside the processing tank 21, a flow of the liquid, in which the transfer liquid L is conveyed from the film supply side (upstream side) to the liquid-leaving area P2 (downstream side), is formed, for example, in a portion near the surface of the liquid (surface layer portion). More specifically, overflow tanks (overflow tanks 82, 92, 97 and the like to be described below) are provided in proximity to a downstream end of the transfer tank 2, and the transfer liquid L collected here is cleaned and then, a part thereof is circulated and supplied from the upstream portion of the transfer tank 2, so that the flow of the liquid is formed in proximity to the surface of the transfer liquid L. In order to clean the collected transfer liquid L, there is a technique in which foreign substances such as the redundant film, the film residue, and the like dispersed and accumulated in the transfer liquid L are removed from the collected liquid (suspension), for example, using a sedimentation tank, filtering, or the like.

Inside the both side walls 22 of the processing tank 21, conveyers 61 serving as the film holding mechanism 6 are provided, and the conveyers 61 hold both sides of the transfer film F supplied to the surface of the liquid, so that the transfer film F is conveyed from the upstream side to the downstream side at a speed synchronized with the flow of the transfer liquid L. It is to be understood that the transfer film F supplied onto the surface of the transfer liquid (in particular, water-soluble film) gradually proceeds (extends) in four directions after the transfer film F comes into contact with the liquid, and therefore, the film holding mechanism 6 (the conveyers 61) also performs an action of restricting the extension of this film from both sides. In other words, the film holding mechanism 6 (the conveyers 61) performs an action of conveying the transfer film F to at least the immersion area P1 (transfer position) while the extension of the transfer film F is maintained at a substantially constant level. Therefore, at the transfer position, the extension of the transfer film F is maintained at the same level on every occasion, and precise transfer can be performed continuously.

As described above, the film holding mechanism 6 (the conveyers 61) not only performs an action of simply conveying the transfer film F but also performs an action of maintaining the extension of the film at the transfer position to a constant level (performs an action of limiting the extension). In this specification, they are collectively referred to as “the action of holding the film”. By the way, in this embodiment, this action of holding the film is released at a portion where the liquid surface residual film F′ is collected, the details of which will be described below.

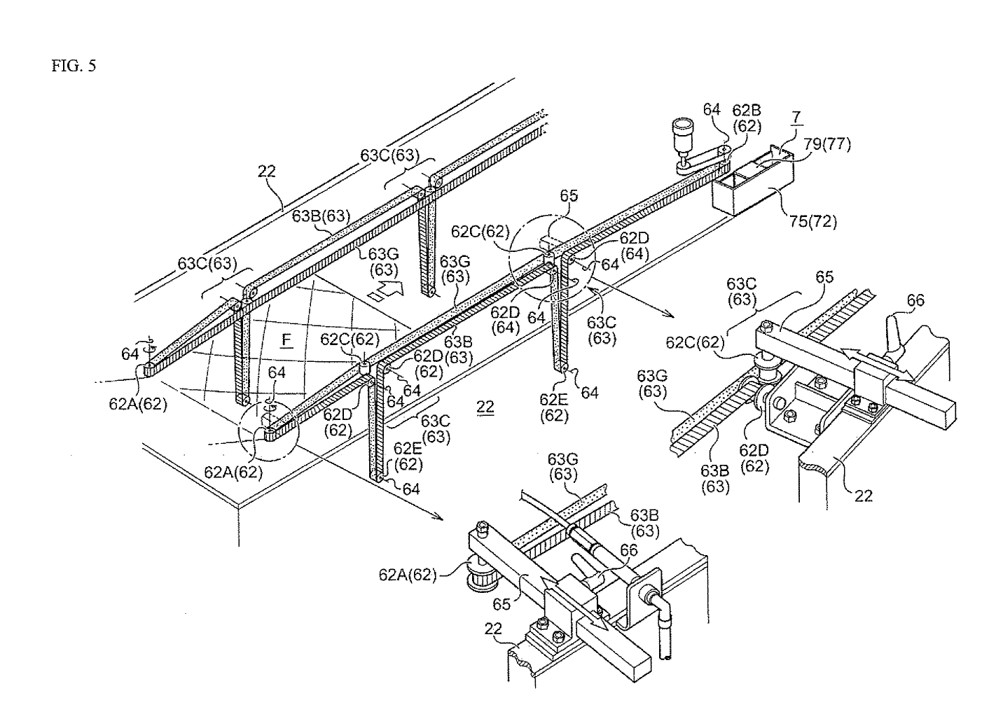

The conveyer 61 as the film holding mechanism 6, as illustrated in FIG. 5 as an example, is configured by winding an endless belt 63 around a plurality of pulleys 62. The belt 63 is brought into contact with both sides of the transfer film F and is divided into an orbit portion (this portion sends the film to the downstream side at a speed that is almost the same as that of the flow of the liquid while holding the film and thus is referred to as a “forward belt 63G”) and a backward portion (this is referred to as a “backward belt 63B”) arranged at a position on a side wall 22 side on the outer side thereof.

In addition, out of a plurality of pulleys, a pulley provided on the film supply side (upstream side) is configured as a leading end pulley 62A, and a pulley provided in a terminal end portion (the side of the overflow tank for collecting liquid surface residual films) is configured as a terminal end pulley 62B. Furthermore, in a portion arranged in the middle of the leading end pulley 62A and the terminal end pulley 62B, pulleys that support the forward belt 63G from the lateral side are configured as relay pulleys 62C (here, there are two relay pulleys).

In this embodiment, driving according to a motor or the like is input to the terminal end pulley 62B.

All the leading end pulley 62A, the terminal end pulley 62B, and the relay pulleys 62C have the rotary shafts 64 set in the approximately vertical direction and are set such that the widthwise direction of the forward belt 63G responsible for the action of holding the film is the depth (height) direction of the transfer liquid L. These settings are made in consideration that the dimension of the width of the belt 63 can respond to any change of the level of the liquid inside the transfer tank 2, and accordingly, the whole conveyer 61 need not be vertically moved (a structure that can easily respond to a change in the level of the liquid of the transfer tank 2).

Meanwhile, the backward belt 63B is operated such that a part of the orbit hangs downward in a portion in which the relay pulley 62C is provided (in other words, a folded state), and, by appropriately changing the length dimension of the hanging portion, the tension applied to the whole belt 63 is adjusted (thus, this hanging portion is configured as a tension adjustment unit 63C).

The tension adjustment unit 63C is configured by including a total of three pulleys of position fixed pulleys 62D provided on both sides of the relay pulley 62C and a vertical movement pulley 62E provided on the lower side thereof and, in actual tension adjustment, for example, in a case where the plan-view dimension of the conveyer 61, that is, the whole apparent length from the leading end pulley 62A to the terminal end pulley 62B is desired to be shortened, by increasing the downward folded length in the tension adjustment unit 63C by lowering the vertical movement pulley 62E, the apparent plan-view dimension of the conveyer 61 is shortened without changing the whole length of the belt 63.

In addition, the rotary shafts 64 of the position fixed pulley 62D and the vertical movement pulley 62E configuring the tension adjustment unit 63C are set to be in a horizontal state of being approximately perpendicular to the side wall 22 of the transfer tank 2. Accordingly, in the tension adjustment unit 63C (hanging portion), the widthwise direction of the belt 63 is set to be approximately horizontal, and the posture of the belt 63 is changed (twisted) by 90 degrees in the backward portion. In other words, the belt 63 is twisted by 90 degrees between the orbit portion formed by the terminal end pulley 62B to the position fixed pulley 62D in the backward belt 63B and the orbit portion formed by the position fixed pulley 62D to the leading end pulley 62A.

In FIG. 5, although two tension adjustment units 63C are provided, one tension adjustment unit or three or more tension adjustment units may be provided.

In addition, in consideration of various width dimensions of the transfer film F, it is preferable that the film holding mechanism 6 (conveyer 61) has a configuration in which the interval (width dimension) between left and right forward belts 63G can be freely adjusted, which will be described below. As such a configuration (width dimension adjusting function), for example, as illustrated in the enlarged diagram of FIG. 5, there is a technique in which the arm bar 65 supporting the relay pulley 62C to be rotatable is arranged to be freely protrude (freely stretchable) with respect to the side wall 22 of the transfer tank 2 (so-called stretchable type). In addition, the arm bar 65 is configured to be fixable at an arbitrary position (at a protruded dimension) by a clamp 66 or the like.

Furthermore, in this embodiment, the leading end pulley 62A is provided to freely protrude in the widthwise direction of the transfer tank 2 using the same technique. In addition, even in a case where the interval between the left and right forward belts 63G is changed in accordance with the transfer film F, the tension of the whole belt 63 is adjusted by the adjustment made by the tension adjustment unit 63C, in other words, by vertically moving the vertical movement pulley 62E.

In addition, as another technique for arranging the relay pulley 62C and the leading end pulley 62A to freely protrude with respect to the side wall 22 (transfer tank 2), a technique may be also considered in which the arm bar 65 supporting the pulleys 62C and 62A is arranged to be rotatable with respect to the side wall 22 of the transfer tank 2, and the arm bar 65 is fixed to an arbitrary rotary movement position (angle) by using a clamp 66 or the like (a so-called swing type). Furthermore, the stretchable type and the swing type may be applied in combination with each other.

In this embodiment, while the belt 63 is employed as the film holding mechanism 6, a chain, a relatively thick rope/wire, or the like may be applied.

An air blowing device 26 is provided above the film supply side (upstream side) of the processing tank 21, and this uniformly extends the transfer film F to portions around the transfer film F and helps the transfer film F proceed to the downstream side.

In this case, blowing of the air blowing device 26 is greatly characterized in that the air blowing device 26 causes air to directly act on (directly blows air to) the transfer film F. In other words, the air blowing device 26 is a method for blowing air to the transfer film F itself, and this is a concept of pressing and forcibly extending (elongating) the transfer film F to portions therearound by the force of the air.

Since the air blowing device 26 performs the action of conveying the transfer film F to the downstream side in an auxiliary manner, the air blowing direction thereof is solely one direction from the upstream side to the downstream side. It is to be understood that the attachment position of the air blowing device 26 is also set at the central position (center in the width direction) of the transfer tank 2.

Further, since the air blowing device 26 causes the air to directly act on the transfer film F, the amount of air blow is set at a relatively strong level (a relatively high level), and accordingly, it is considered that the wave caused by the air blow affects even the transfer position (immersion area P1). Therefore, in order to prevent this, it is preferable to provide a wave cancellation plate and the like between the air blowing device 26 and the transfer position in the transfer tank 2, so as to stabilize the surface of the transfer liquid, and in particular, stabilize the surface of the liquid at the transfer position.

Subsequently, the liquid surface residual film collecting mechanism 7 will be explained. The liquid surface residual film collecting mechanism 7 is a mechanism for collecting the liquid surface residual film F′ remaining on the surface of the transfer liquid L after the object W is immersed, so that the liquid surface residual film F′ does not reach the liquid-leaving area P2. In other words, when the object W is immersed, the transfer film F is in a pierced state (in this case, a state in which an elongated hole is formed) as shown in FIG. 1, for example, and the pierced portion is mainly a portion that sinks into the liquid together with the object W and that is attached and transferred to the design surface S1 due to the pressure of the liquid thereof. However, the film remaining on the surface of the liquid (film floating with an opening formed therein) is not used for transfer, and is an unnecessary portion (this is the liquid surface residual film F′). When such liquid surface residual film F′ is left as it is, it may be a factor to contaminate the transfer liquid L, and when the liquid surface residual film F′ reaches the liquid-leaving area P2 downstream, it attaches to the object W (design surface S1) pulled up from the transfer liquid. Therefore, in this embodiment, the liquid surface residual film F′ is reliably collected as soon as possible after the transfer is completed. More specifically, first, the liquid surface residual film F′ is divided in the longitudinal direction of the transfer tank 2 (the direction of the flow of the liquid/the direction of the immersion area P1 to the liquid-leaving area P2), and they are moved (pressed) to the both side walls 22 of the transfer tank 2, so that the divided liquid surface residual films F′ are discharged from the both side walls 22 to the outside of the tank.

Therefore, the liquid surface residual film collecting mechanism 7 includes a dividing means 71 for splitting and dividing the liquid surface residual film F′ in the longitudinal direction (the direction of the flow of the liquid/the direction of the immersion area P1 to the liquid-leaving area P2) and a discharge means 72 for discharging the liquid surface residual film F′ at the portions of the side walls 22 of the transfer tank 2 to the outside of the tank. The dividing means 71 and the discharge means 72 will be hereinafter described.

First, the dividing means 71 will be explained. After the object W is immersed, i.e., after the transfer, the dividing means 71 quickly divides the liquid surface residual film F′ (causes the liquid surface residual film F′ to branch off), and in this case, a method of blowing air is employed so as to reliably divide the liquid surface residual film F′ without coming into contact with the film. More specifically, for example, as shown in FIG. 1, the air blowing device 73 is provided on one of the side walls 22 of the processing tank 21, and air is blown from the air blowing device 73 to the liquid surface residual film F′ on the surface of the liquid. In this case, it is simply described as the “air blowing device (73)” in the above explanation, but this term includes extension ducts, nozzles, and the like connected to the air blowing device.

Although the liquid surface residual film F′ is divided quickly in the above explanation, the transfer itself cannot be performed accurately if the action of dividing by the dividing means 71 (in this case, the amount of air blow) gives adverse effects such as deformation (distortion of pattern caused by returning wave and the like) and stress to the transfer film F at the transfer position (immersion area P1). The range acted on by the action of the dividing means 71 is set so as not to give adverse effects on the transfer position (for example, with a certain distance). In other words, the amount of air blow (the force of air blow) of the air blowing device 73 serving as the dividing means 71 is set at a relatively low level so as not to give adverse effects on the transfer position. Therefore, the position where the air blowing device 73 serving as the dividing means 71 is preferably, flexibly movable in the longitudinal direction of the transfer tank 2 in accordance with the reciprocal movement of the transfer position. As a result, the position can be set easily at an appropriate position where the action of dividing is achieved without giving adverse effects on the transfer position.

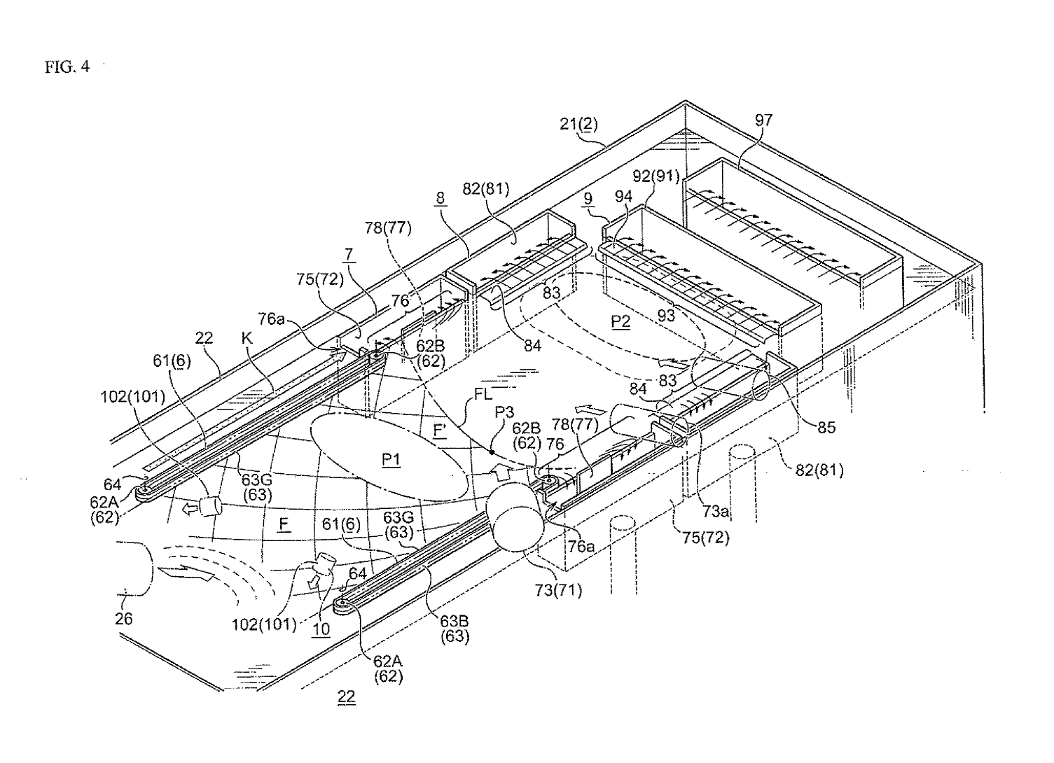

In this case, the situation of dividing of the liquid surface residual film F′ by the air blowing device 73 will be explained. The liquid surface residual film F′ is divided to the right and left by the air blow by the air blowing device 73, and in particular, a start point form from which the liquid surface residual film F′ is divided will be referred to as a dividing start point P3. The liquid surface residual film F′ is divided to a substantially arch shape or a substantially V shape by the air blown by the dividing start point P3, and it appears as if it is a line, and therefore, this film separation line is defined as a dividing line FL. It is to be understood that portions around edges of the dividing line FL are gradually dissolved little by little and separated, and move closer to the both side walls 22 by the blown air and the flow of the liquid. Therefore, in FIG. 4, the dividing line FL is drawn as a clear solid line in proximity to the dividing start point P3, but it is drawn as a broken line in portions of the side walls 22 away from there.

It should be noted that, in the present embodiment, at first glance, it appears that there is no member for performing an action of moving the divided liquid surface residual film F′ to both side walls 22, but the air blowing device 73 serving as the dividing means 71 performs an action of moving the divided liquid surface residual film F′ to the side walls 22. It is to be understood that the flow of the liquid formed in the transfer tank 2 also helps this action.

In the present embodiment, the air blowing device 73 serving as the dividing means 71 is provided on one of the side walls 22, and the liquid surface residual film F′ is divided into two parts. Therefore, for example, the ratio of division into both side walls 22 is about 8:2 to 7:3. It is to be understood that the right and left side walls 22 can be divided substantially equally when the liquid surface residual film F′ is divided, but in this case, it is considered to be common to provide the dividing means 71 (air blowing device 73) in the center in the width direction of the transfer tank 2, and it is necessary to consider the aspect of installation with regard to the object conveying device 5 located in the center of the width direction of the transfer tank 2.

It should be noted that only one air blowing device 73 serving as the dividing means 71 may not be provided. Alternatively, two air blowing devices 73 serving as the dividing means 71 can be provided in combination. As described above, this can be said countermeasure for inability to forcibly increase the amount of air blow (make the air blow stronger) of the air blowing device 73. More specifically, for example, as also shown in FIG. 1, a still smaller auxiliary air blowing device 73a is installed at the side wall 22 arranged with the air blowing device 73, so that the liquid surface residual film F′ is reliably pushed to a side at which more film can be collected.

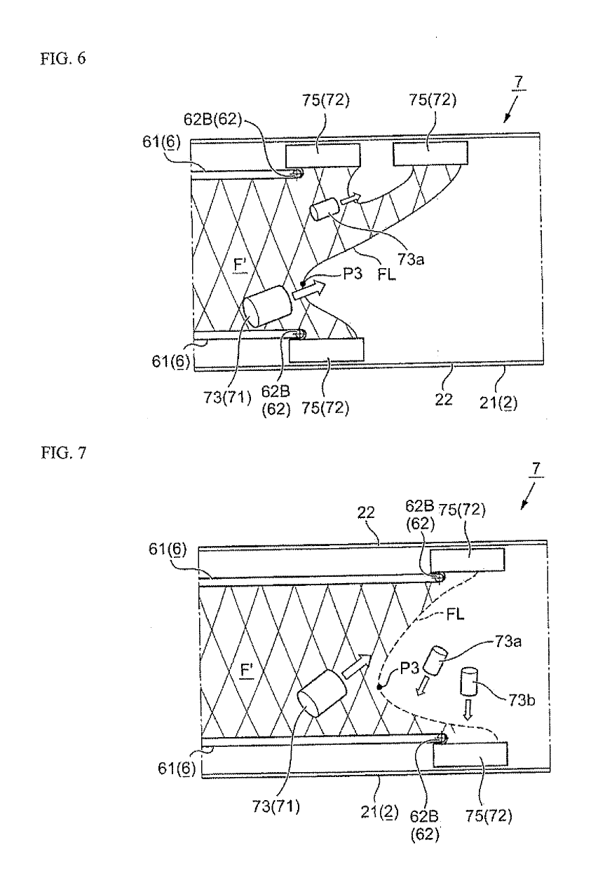

It is to be understood that the direction in which the air is blown by the auxiliary air blowing device 73a is not necessarily limited to the aspect of FIG. 1. For example, as illustrated in FIG. 6, the direction in which the air is blown by the auxiliary air blowing device 73a may be set substantially in the same direction as the direction in which the air is blown by the main air blowing device 73. It should be noted that in this embodiment of FIG. 6, the liquid surface residual film F′ is divided into three parts as a result, and are collected at three places. Therefore, it can be said that this indicates that, in this embodiment, the aspect of dividing of the liquid surface residual film F′ is not be necessarily limited to division into two parts (may not be necessarily collected at two places). In other words, various kinds of dividing forms and collecting forms can be employed depending on the situation of dividing/collecting and the aspect of the transfer film F.

Further, for example, FIG. 7 illustrates an embodiment in which three air blowing devices (the main air blowing device is denoted with 73, and the auxiliary air blowing devices are denoted with 73a and 73b) are provided as the dividing means 71, and has such a concept that since the amount of air blow of the auxiliary air blowing device 73a is weak (it is difficult to increase the amount of air blow of the auxiliary air blowing device 73a), another auxiliary air blowing device 73b is used to reliably push one of the divided liquid surface residual films F′ in a lateral direction at last.

It should be noted that the above method for dividing the liquid surface residual film F′ by blowing air achieves the effect of being able to divide the liquid surface residual film F′ in a non-contact state (i.e., the liquid surface residual film F′ can be divided without bringing the air blowing device 73 itself into direct contact with the film) and the effect of not giving adverse effects such as deformation to the transfer film F at the transfer position.

Subsequently, the discharge means 72 in the liquid surface residual film collecting mechanism 7 will be explained. The discharge means 72 collects the liquid surface residual films F′ pressed to the side walls 22 of the transfer tank 2, and discharges the liquid surface residual films F′ to the outside of the transfer tank 2. In the present embodiment, overflow tanks 75 provided inside of the both right and left side walls 22 of the processing tank 21 is applied. In this case, in the overflow tank 75, collecting ports for introducing the liquid surface residual films F′ together with the transfer liquid L are referred to as discharge ports 76.

In addition, since this kind of discharge structure using overflow is employed, the action of holding the film achieved with the film holding mechanism 6 (in this case, conveyer 61 using the belt 63) is cancelled in the discharge ports 76 as described above, and this makes it easy to discharge (collect) the liquid surface residual film F′ pressed to the both side walls 22. On the contrary, when the belt 63 is present at the discharge ports 76 of the overflow tank 75, the belt 63 blocks the discharge ports 76, and operates to hinder discharge of the liquid surface residual films F′, and therefore, the action of holding the film is cancelled in the portions of the discharge ports 76 in this embodiment.

A specific method of the film holding mechanism 6 for cancellation in the discharge ports 76 will be described. In this embodiment, for example, as illustrated in FIG. 4, the terminal end pulley 62B that is a terminal end portion for the action of holding the film is provided near a dividing start point P3 when viewed from the side surface, and the conveyer 61 (belt 63) is folded there. In this kind of aspect of arrangement, in the portions of the discharge ports 76 of the overflow tank 75, the action of holding the films by using the film holding mechanism 6 (conveyer 61) is cancelled.

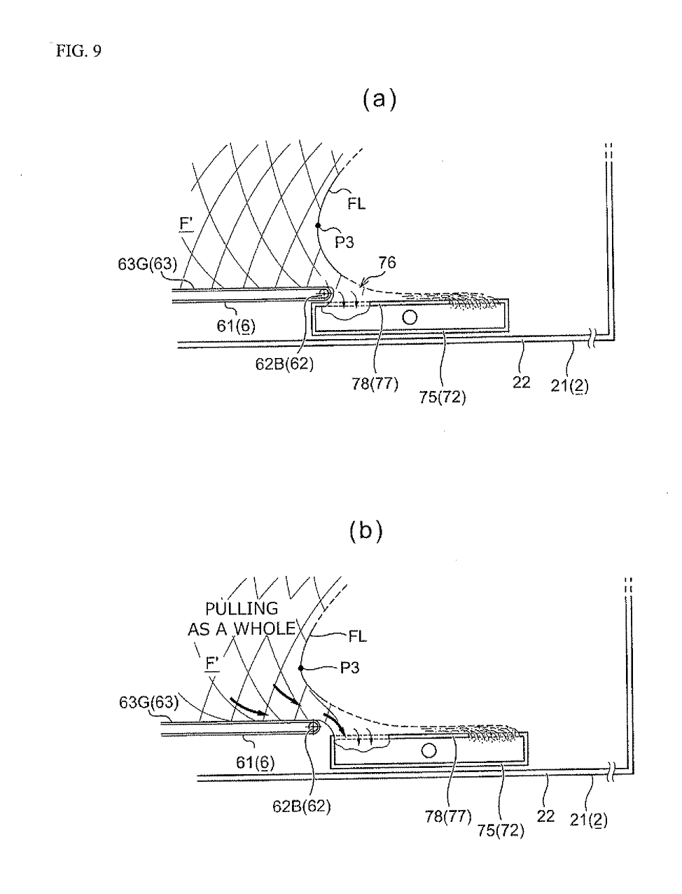

However, it is preferable that the conveyers 61 are arranged to overlap the overflow tank 75 (discharge port 76 portions) to some extent when seen from the side surface, in other words, the terminal end pulley 62B is arranged to overlap the overflow tank 75 when seen from the side surface to some extent, which will be described later (see FIG. 9(a)).

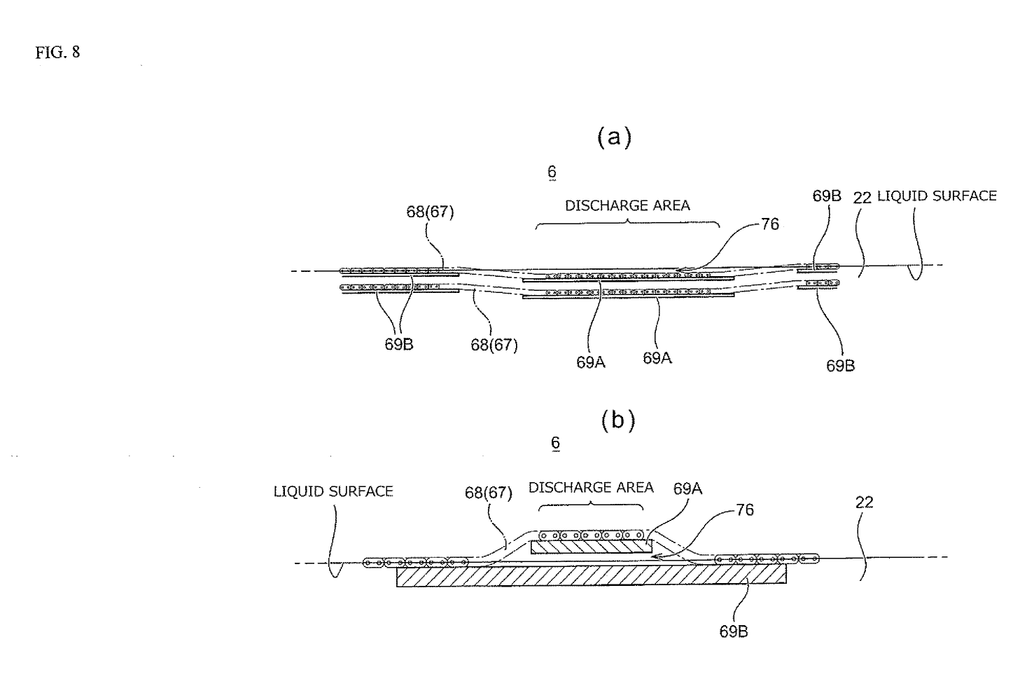

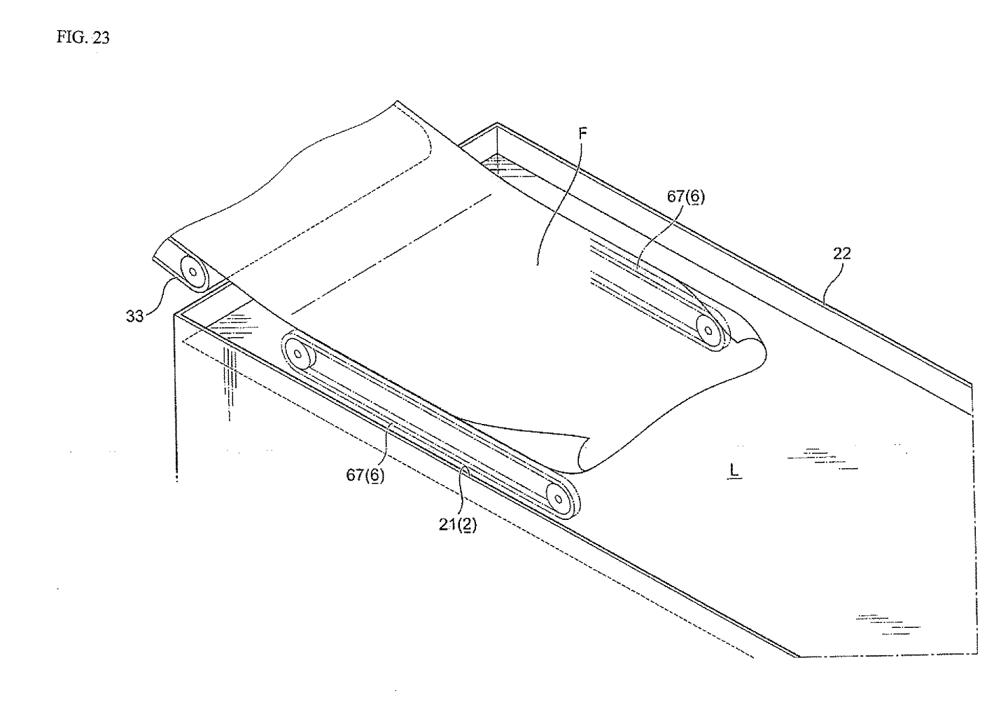

Also in a case where the chain conveyer 67 is applied as the film holding mechanism 6 (see FIG. 23), while the action of the chain conveyer 67 for holding the film in the discharge port 76 portions can be cancelled using the method described above, particularly, in a case where the chain conveyer 67 is applied, methods other than the above-described method may be employed. In other words, in this case, usually, the center of the upper chain 68 is set to match the level of the surface of the liquid in the state of view from the side surface, and accordingly, for example, as illustrated in FIG. 8(a), near the discharge port 76, the action of holding the film in the portion of the surface of the liquid can be cancelled in the discharge ports 76 by dropping the entire chain conveyer 67 (chain 68) to a level below the surface of the liquid. Alternatively, by employing a configuration opposite to this, in other words, as illustrated in FIG. 8(b), by raising the chain conveyer 67 (chain 68) to a level above the surface of the liquid in the portion of the surface of the liquid that is disposed in the discharge ports 76, the action of holding the film can be cancelled. In this case, in the figure, reference numeral 69A denotes a guide body for restricting the upper side or the lower side of the chain conveyer 67 so that the chain 68 does not block the discharge port 76 in proximity to the discharge port 76, and further, in the figure, reference numeral 69B denotes a guide body for guiding the chain conveyer 67 at an ordinary height (orbit).

For example, as illustrated in FIG. 4, the overflow tank 75 according to this embodiment has a sheathing board 78 in a middle portion of the discharge port 76, wherein the sheathing board 78 serves as a blocking means 77 to block the collection of the liquid, and this is a configuration intended to collect the liquid surface residual film F′ at two stages before and after the blocking means 77 (sheathing board 78) even in the one overflow tank 75. The blocking means 77 narrows the flow rate guiding range of the discharge port 76, and accordingly, performs control so as to reduce the flow rate after the action of holding the film is cancelled. In addition, this allows the liquid surface residual films F′ to be reliably collected without adversely affecting the transfer position (immersion area P1).

By the way, when the liquid surface residual films F′ are introduced into the overflow tank 75 from the entire discharge port 76 without providing the blocking means 77 in the discharge port 76, the liquid surface residual films F′ moving closer to the side walls 22 are pulled in the whole, and the applicant of the present application has confirmed that this extends to the transfer position and gives adverse effects such as deformation to the transfer position.

The transfer liquid L collected in the overflow tanks 75 includes much liquid surface residual films F′, i.e., transfer patterns (ink components) and half-dissolved water-soluble films, and the mix ratio of foreign substances is high. Therefore, the transfer liquid L collected in the overflow tanks 75 is preferably discarded as it is, but the transfer liquid L collected in the overflow tanks 75 may also be provided for recycled use after a cleaning device removes the foreign substances.

The overflow tanks 75 are fixed to the side walls 22 (frame) of the transfer tank 2 using bolts and the like, in the front and back direction that is the longitudinal direction (the direction of the flow of the liquid/the direction of the immersion area P1 to the liquid-leaving area P2), so that the overall height of the overflow tank 75 can be changed, and it is preferable to attach the overflow tanks 75 so that the inclination of the overflow tanks 75 in the front and back direction can be adjusted. Like the air blowing device 73, the entire overflow tank 75 is preferably, flexibly movable to the front and back in the longitudinal direction of the transfer tank 2 in view of the change of the transfer position. Further, the arrangement position of the blocking means 77 with respect to the discharge port 76 is also preferably configured to be changed as necessary, and the width (the length in the front and back direction) thereof is also preferably configured to be changed as necessary.

Now, the reason (details) why the film holding mechanism 6 (conveyer 61) preferably overlaps with the overflow tank 75 (the portions of the discharge ports 76) to some extent in the state of view from the side surface will be described with reference to FIG. 9.

First, FIG. 9(b) illustrates a case where the conveyer 61 does not overlap with the overflow tank 75. At this occasion, the terminal end pulley 62B of the conveyer 61 is located on the upstream side with respect to the overflow tank 75. In this case, in both side portions of the liquid surface residual film F′ held by the belt 63 (forward belt 63G), there is a tendency in which the holding (contacting) of the film is gradually cancelled in accordance with a force of the speedy falling liquid in the overflow tank 75 (a tendency of being separated away from the belt 63 even in the portion originally held by the belt 63). Accordingly, in this case, as illustrated in the figure, end portions of both sides of the liquid surface residual film F′ are pulled first by the overflown falling liquid, and the holding is cancelled, so that this is applied to the upstream side and may cause bending of the pattern in the entire film. It is to be understood that the effect of this kind of bending of the pattern may result in deformation of the pattern of the transfer film F in the immersion area P1.

In contrast to this, as illustrated in FIG. 9(a), when the conveyer 61 is overlapped with the overflow tank 75 to some extent, the action of holding the film according to the conveyer 61 (forward belt 63G) takes effect until the liquid surface residual film F′ reaches the overflow tank 75 (discharge port 76). Therefore, both side portions of the liquid surface residual film F′ are reliably held by the conveyers 61 until the liquid surface residual film F′ reaches the discharge ports 76. The liquid surface residual film F′ introduced to the overflow tank 75 (at a side before the blocking means 77) drops with the water as if the liquid surface residual film F′ moves around the terminal end pulley 62B, and the liquid surface residual film F′ is reliably collected without adversely affecting the transfer position.

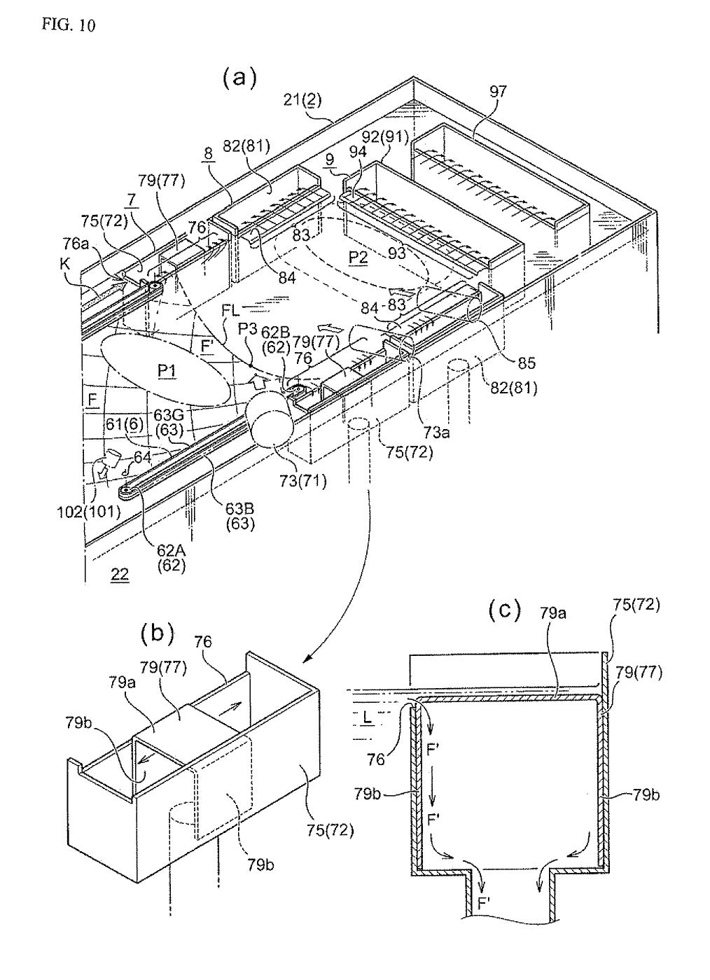

In this case, for example, in the embodiment of FIG. 4 above, the sheathing board 78 is used as the blocking means 77. However, the blocking means 77 may be in other forms. For example, as illustrated in FIG. 10, the blocking means 77 may be configured in such a form that the blocking means 77 is accommodated within the overflow tank 75, which is preferable (this will be referred to as in-tank blocking body 79).

In other words, the in-tank blocking body 79 as illustrated in FIG. 10 is, for example, a gutter form member having a C-shaped cross section. This is not used as a container (gutter) for receiving the collected liquid. As illustrated in FIG. 10(b), the in-tank blocking body 79 is accommodated (dropped) in the overflow tank 75 such that the opening portion (aperture portion) having the C shaped cross section faces downward, and the upper opening side of the overflow tank 75 is partially closed by the central flat portion of the C shaped cross section. Therefore, the in-tank blocking body 79 is installed in the overflow tank 75 in a so-called bridge manner, and in this installation state, the flat portion located at the upper portion of the in-tank blocking body 79 (portion that closes the overflow tank 75) performs the action of dam just like the sheathing board 78. Due to such fact, the flat portion will be denoted as a dam action unit 79a. On the other hand, portions provided at both sides of the dam action unit 79a to face each other will be denoted as foot units 79b. The both foot units 79b are accommodated within the overflow tank 75, so that the in-tank blocking body 79 is allowed to move only in the front and back direction.

It should be noted that when the in-tank blocking body 79 is formed in the C shape, there is an advantage in that the in-tank blocking body 79 (blocking means 77) can be fixed by just dropping this into the overflow tank 75, and the discharge positions at two stages before and after the in-tank blocking body 79 and the discharge balance can be easily adjusted and changed by moving this in the front and back direction (sliding in the longitudinal direction of the transfer tank 2).

With regard to this point, the sheathing board 78 explained above is usually installed vertically in the discharge port 76 of the overflow tank 75, and therefore, fixing means is separately required to attach the sheathing board 78 to the overflow tank 75 (discharge port 76), and it should be attached and detached when the above adjustment is made. In contrast, the in-tank blocking body 79 does not require such fixing means, and the adjustment can be done extremely easily.

In this case, as described above, the in-tank blocking body 79 blocks the collection of the liquid by the overflow tank 75, and therefore, as illustrated in FIG. 10(c), the dam action unit 79a (top surface) is set at a level higher than the discharge port 76 of the overflow tank 75 (for example, about 1 mm to 3 mm). It should be noted that this dam action unit 79a is set at a level slightly lower than the surface of the transfer liquid L as illustrated in FIG. 10(c) (for example, about 2 to 3 mm) and this means that, during normal discharge amount setting, the in-tank blocking body 79 is slightly under the liquid. However, even in such state, there occurs a difference of speed of collection of the liquid (the speed of collection of the liquid is slower in the portion of the dam action unit 79a) between the dam action unit 79a and the portions of the discharge ports 76 at which the in-tank blocking body 79 (dam action unit 79a) is not provided, and this sufficiently achieves the function of dam.

Further, when the dam action unit 79a is set at a level slightly under the liquid, the film residues are not likely to be stuck with the portion, and even if the film residues are stuck and stopped (overridden and stopped) at the portion, this can be collected, and the transfer liquid L in the transfer tank 2 is not contaminated.

In this point, the sheathing board 78 explained above has a generally-available dam structure, and the sheathing board 78 protrudes above the surface of the transfer liquid L. Therefore, the film residues may get stuck with the sheathing board 78, and in such case, the film residues will gradually crash into pieces and drop in the transfer tank 2, which may contaminate the transfer liquid L.

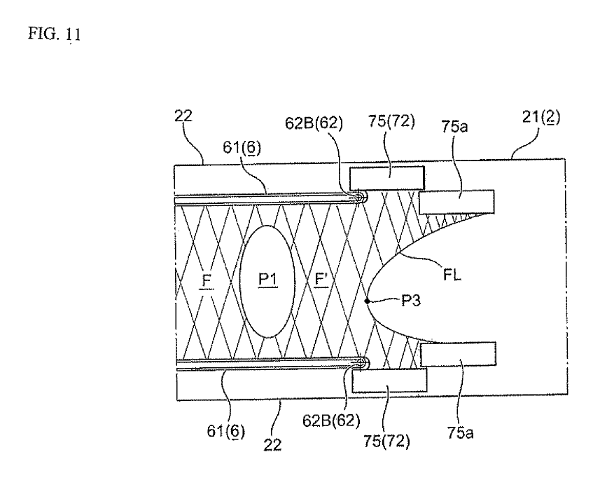

When the liquid surface residual film F′ is collected at the portion of the side wall 22 of the transfer tank 2, the liquid surface residual film F′ may not be necessarily collected at one location per one side (at one location of each of the right and left side walls 22). For example, as illustrated in FIG. 11, the liquid surface residual film F may be collected at two locations per one side. It should be noted that in the embodiment of FIG. 11, it is difficult for the air blowing device 73 serving as the dividing means 71 to set the amount of air blow at a high level, and this embodiment is configured such that, when there is no performance to push the liquid surface residual film F′ to the outsides of the conveyers 61, auxiliary overflow tanks 75a (discharge means 72) are additionally provided at the inside of the conveyer 61. However, in this case, the auxiliary overflow tank 75a is somewhat provided in a protruding manner in the center of the transfer tank 2 (on a conveying path of the object W), and therefore, it is necessary to pay attention so that the overflow tanks 75a do not block the conveying of the object W. Even when the liquid surface residual film F′ is divided into two parts in this manner, subsequent collection may be done at four locations (two locations per one side), and the number of parts into which the liquid surface residual film F′ is divided by the dividing means 71 is not necessarily the same as the number of locations where the liquid surface residual films F′ are collected.

It should be noted that the liquid surface residual film collecting mechanism 7 (discharge means 72) is not necessarily limited to the overflow structure. Other collecting methods may also be employed. For example, a vacuum method may be employed, in which the transfer liquid L in proximity to the surface of the liquid as well as the divided liquid surface residual films F′ are sucked. In other words, in this case, a sucking nozzle is employed as the discharge means 72.

In the present embodiment, a liquid-leaving area cleaning mechanism 8 is further provided in a stage subsequent to the liquid surface residual film collecting mechanism 7. This structure will be hereinafter explained. The liquid-leaving area cleaning mechanism 8 is a mechanism for mainly removing foreign substances and bubbles A on the surface of the liquid and in the transfer liquid at the side of the decoration-unnecessary surface S2 (the back side of the design surface S1) in the liquid-leaving area P2. Examples collected by the liquid-leaving area cleaning mechanism 8 include film residues generated when the object W is immersed so as to pierce the transfer film F (relatively small residues in a form of waste strings and the like made up with the water-soluble film and the ink which are mixed), redundant film which attach to a jig J and the object W during immersion and once sink under the surface of the liquid and which are thereafter discharged into the water, and many bubbles A and film residues generated on the surface of the liquid at the side of the decoration-unnecessary surface S2 of the object W when the object W (jig J) moves out of the liquid.

This structure continuously moves away these foreign substances and the bubbles A from the liquid-leaving area P2 while the object W is still in the transfer liquid L, so as to clean the liquid-leaving area P2 and at the same time prevent them from moving in to the side of the design surface S1 of the object W as much as possible.

For example, as illustrated in FIGS. 1, 2, and 4, the liquid-leaving area cleaning mechanism 8 includes the overflow tanks 82 serving as the discharge means 81 which are provided at both right and left sides of the liquid-leaving area P2, and the overflow tank 82 is provided to overlap with the liquid-leaving area P2 in the state of view from the side surface. More specifically, the discharge means 81 (the overflow tanks 82) are provided inside, of the both right and left side walls 22 in the liquid-leaving area P2 of the transfer tank 2, so that the flow of the liquid flowing from the liquid-leaving area P2 to the overflow tanks 82 (this will be referred to as side oppositely-separating flow) is generated mainly in proximity to the surface of the liquid. The bubbles A and foreign substances such as film residues are carried by this side oppositely-separating flow, and are collected by the overflow tanks 82, so that they are discharged to the outside of the tank. Therefore, in the top view, as shown in FIGS. 1 and 2, the overflow tanks 75 for collecting the liquid surface residual films and the overflow tanks 82 for cleaning the liquid-leaving area are provided adjacently in series. In this case, in the overflow tanks 82, the collecting ports through which foreign substances such as film residues are introduced together with the transfer liquid L will be referred to as discharge ports 83.

For example, as illustrated in FIG. 4, the overflow tanks 82 for cleaning the liquid-leaving area may be formed with brims for guiding the collected liquid in the discharge ports 83. In particular, in the present embodiment, the protruding length from the discharge port 83 to the processing tank 21 is formed to be relatively long. This is to make a structure for increasing the flow rate of the transfer liquid L introduced to the overflow tanks 82 (for this reason, this brim will be referred to as a flow rate increase brim 84).

It should be noted that the transfer liquid L collected by the overflow tanks 82 has a relatively low mixing ratio of foreign substances. Therefore, it is preferable that the collected liquid be provided for recycled use after the foreign substances are removed from the collected liquid by using a sedimentation tank, filtering, or the like (see FIG. 2).

As described above, the liquid-leaving area cleaning mechanism 8 is to collect the foreign substances and the bubbles A on the surface of the liquid in the liquid-leaving area P2 (at the side of the decoration-unnecessary surface S2), and therefore, in order to reliably collect the foreign substances and the bubbles A, it is preferable to blow air onto the surface of the liquid in the liquid-leaving area P2, thereby actively pushing the foreign substances and the bubbles A to the overflow tanks 82 (flow rate increase brim 84). More specifically, in the present embodiment, for example, as illustrated in FIGS. 1, 2, and 4, the air blowing device 85 is provided on one of the side walls 22 of the transfer tank 2 (above the overflow tank 82), and many foreign substances such as the bubbles A, and the film residues generated on the surface of the liquid in the liquid-leaving area P2 (at the side of the decoration-unnecessary surface S2) by this air blow from the air blowing device 85 are moved and collected to the overflow tank 82 arranged at the side opposite to the position where the air blowing device 85 is installed.

As described above, in the liquid-leaving area P2, the bubbles A and the foreign substances on the surface of the liquid are continuously removed by the air blowing device 85, and the foreign substances in the liquid are also collected by the overflow tank 82, and therefore, with the synergetic effect thereof, high degree of cleanness can be achieved, and at the same time, the foreign substances can also be prevented from moving around to the side of the design surface S1 of the object W.

Further, as described above, the air blowing device 85 is provided to act on the surface of the liquid in the liquid-leaving area P2, and when the air blowing device 85 and the air blowing device 73 for dividing the liquid surface residual film F′ are considered, multiple air blowing devices are provided in total in this apparatus. However, it may be considered that depending on various kinds of transfer conditions, for example, the shape of the object W, and the aspect of the object conveying device 5, the air blown to divide the liquid surface residual film F′ is sufficient to continuously move the bubbles A and the foreign substances on the surface of the liquid in the liquid-leaving area P2 to the overflow tanks 82. In such case, the air blowing device 73 for dividing the film can also be used as the air blowing device 85 for cleaning the liquid-leaving area, and further, they may be combined into one air blowing device capable of dividing the film as well as cleaning the liquid-leaving area.

Not only the above overflow structure but also other discharge methods can be employed as the discharge means 81 of the liquid-leaving area cleaning mechanism 8. For example, a vacuum method may be employed, in which the transfer liquid L having foreign substances mixed therein is sucked mainly in proximity to the surface of the liquid. In other words, in this case, a sucking nozzle is employed as the discharge means 81.

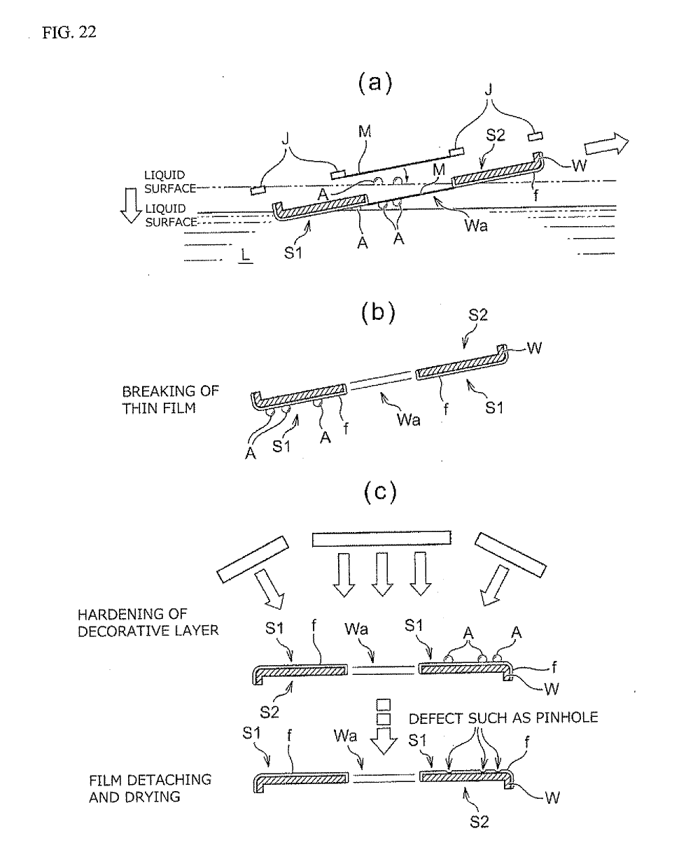

Subsequently, the design surface cleaning mechanism 9 will be explained, but before explaining the design surface cleaning mechanism 9, the bubbles A generated at the side of the design surface S1 in the liquid-leaving area P2 will be explained. In the liquid-leaving area P2, the objects W (jigs J) are successively raised obliquely upward from the surface of the liquid. Above the object W moving out of the liquid, the object W and the jig J that have already been raised above the surface of the liquid are located (which will be referred to as the object W and the jig J that have been raised previously). At this occasion, for example, the transfer liquid L may drop as drips from the object W and the jig J that have been raised previously to the surface of the liquid of the transfer tank 2, and the dropped drips bounce on, for example, the surface of the liquid to become the bubbles A, which may attach to the design surface S1 of the object W moving out of the liquid. Thereafter, when ultraviolet ray or the like is emitted on the object W in this state, as illustrated in FIG. 22(c) described above, a defect of deformation of the transfer pattern (decorative layer) and a defect (so called pinhole) of loss of the pattern may occur in the portions to which the bubbles A attach, because of the reasons such as stress caused by the bubbles A and refraction of the ultraviolet ray. Therefore, in the present invention, the design surface cleaning mechanism 9 is provided for the purpose of, i.e., cleaning the design surface S1 of the object W ascending from the transfer liquid L (action mainly caused by new water described below), removing the bubbles A generated on the surface of the liquid at the side of the design surface S1, and eliminating foreign substances in the transfer liquid and on the surface of the liquid in the liquid-leaving area P2.

Hereinafter, the design surface cleaning mechanism 9 will be further explained. The design surface cleaning mechanism 9 is provided to form the flow of the liquid flowing downstream from the design surface S1 of the object W moving out of the liquid (this flow will be hereinafter referred to as design surface oppositely-separating flow because this is a flow moving away from the design surface S1). The purpose of the design surface oppositely-separating flow is, for example, to prevent the foreign substances dispersed and accumulated in the transfer liquid L from moving closer (attaching to) to the design surface S1 as much as possible, and to move the bubbles A and the foreign substances, which are on the surface of the liquid generated by the drips dropped from the object W raised previously, away from the design surface S1 so as to discharge the bubbles A and the foreign substances to the outside of the tank as described above. Therefore, the design surface oppositely-separating flow is preferably formed by applying clean water not including any foreign substance or purified water made by removing the foreign substances from the collected liquid (which will be collectively referred to as new water).

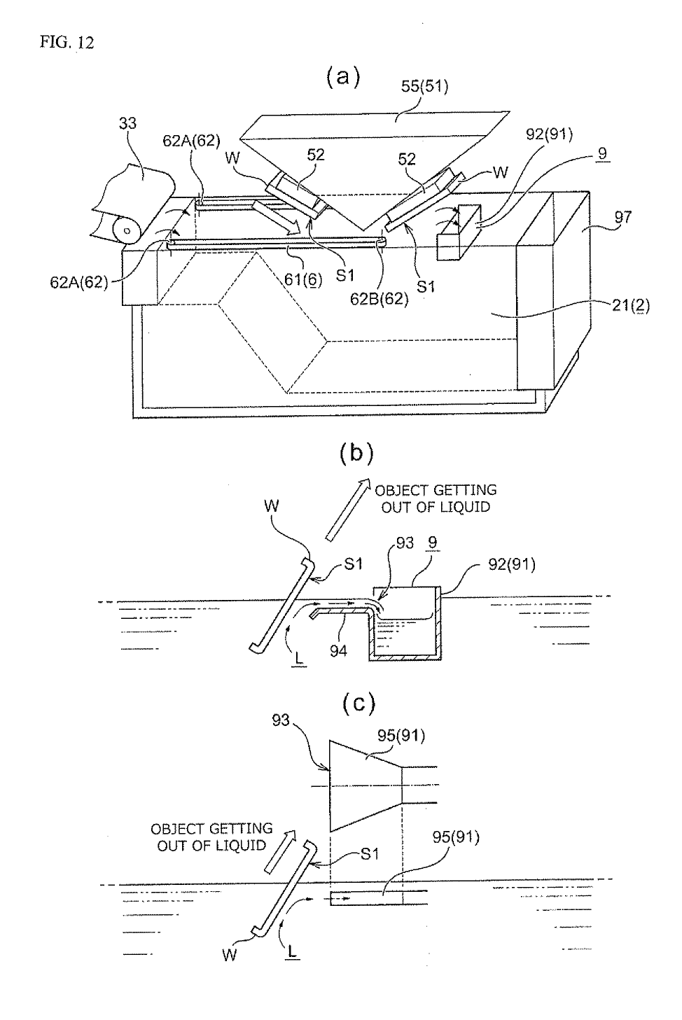

Because of such facts, for example, as illustrated in FIG. 12(a), the design surface cleaning mechanism 9 has the overflow tank 92 serving as an oppositely-separating flow forming means 91 at the side of the design surface S1 of the object W moving out of the liquid in the liquid-leaving area P2. More specifically, in the present embodiment, the object W ascends in the liquid-leaving area P2 in an inclined state in which the design surface S1 faces the lower side, and therefore, the overflow tank 92 facing (opposing) the design surface S1 of the object W is provided, whereby the design surface oppositely-separating flow, which flows from the lower side to the upper side of the ascending object W (design surface S1), is formed. In this case, in the overflow tank 92, a collecting port for mainly introducing new water together with the transfer liquid L will be referred to as a discharge port 93.

It should be noted that the design surface oppositely-separating flow is preferably formed by supplying new water as described above, and therefore, for example, in FIG. 2, some of the new water (purified water) is upward supplied to the liquid-leaving area P2 from the lower side of the overflow tank 92 used for forming the flow oppositely separating from the design surface. In addition, some of the new water upward supplied to the liquid-leaving area P2 from the lower side of the overflow tank 92 is used also as the side oppositely-separating flow of the above-described liquid-leaving area cleaning mechanism 8.

Now, easiness of attachment of the foreign substances to the design surface S1 without the design surface cleaning mechanism 9 will be explained. Usually, the object W pulled out of the transfer liquid L ascends in such a state as to somewhat block the flow of the transfer liquid L flowing from the upstream to the downstream. At this occasion, the blocked transfer liquid L flows so as to move around the object W below the object W or at the sides of the object W, and this makes the flow flowing to the design surface S1 facing the downstream side (curling flow).

When the object W is pulled up from the liquid, force flowing from a position close to the surface of the liquid of the object W to the object W is exerted due to a speed difference between the pull-up speed of the object W and surface of the liquid at rest.

Therefore, the curling flow (flow toward the design surface S1) is automatically formed at the design surface of the object W moving out of the liquid. Accordingly, if no countermeasure is taken, the foreign substances dispersed and accumulated in the transfer liquid L may be attracted to the design surface S1 and may attach to the design surface S1. For this reason, in the present invention, the design surface oppositely-separating flow made by the design surface cleaning mechanism 9 is provided to cancel the flow of the transfer liquid L flowing to the design surface S1, or suppress the flow as much as possible.

In the overflow tank 92 for forming the design surface oppositely-separating flow, for example, as illustrated in FIGS. 4 and 12(b), a flow rate increase brim 94 is formed in the discharge port 93, and this is to increase the flow rate of the transfer liquid L introduced to the overflow tank 92.

It should be noted that the oppositely-separating flow forming means 91 in the design surface cleaning mechanism 9 is not necessarily limited to the overflow structure explained above. Alternatively, other discharge methods may be employed. For example, as illustrated in FIG. 12(c), a vacuum method may be employed, in which the transfer liquid L having foreign substances and the new water are sucked mainly in proximity to the surface of the liquid. In other words, in this case, a sucking nozzle 95 is employed as the oppositely-separating flow forming means 91.

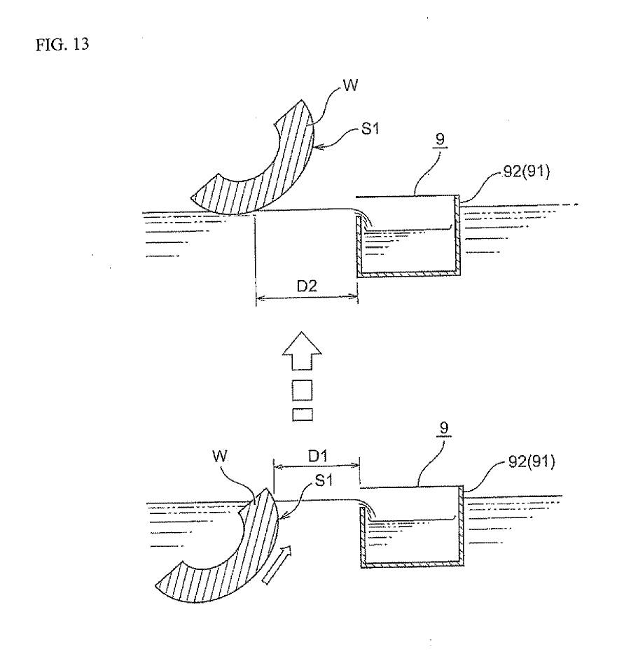

In order to reliably and uniformly cause the design surface oppositely-separating flow to act on the design surface S1 of the object W from the start of the liquid leaving to the end of the liquid leaving, it is preferable to maintain a distance between the overflow tank 92 (discharge port 93) as a oppositely-separating flow forming means 91 and the object W (design surface S1) to be almost constant (for example, about 10 to 200 mm). However, for example, as illustrated in FIG. 13, depending on, e.g., the state of the curve and the degree of projections and depressions of the object W (design surface S1), the design surface S1 may gradually move away from the overflow tank 92 (discharge port 93) even if the object W is pulled up at a constant inclined posture and liquid-leaving angle (in the figure, D1 denotes the distance between them both as soon as the object W begins to move out of the liquid, and D2 denotes the distance between them both when the object W has been moved out of the Liquid). Therefore, the overflow tank 92 is preferably configured to be able to move in the longitudinal direction of the transfer tank 2 (the direction of the flow of the liquid/the direction of the immersion area P1 to the liquid-leaving area P2). In other words, the overflow tank 92 is preferably configured to be able to flexibly move closer to and move away from the object W that is moving out of liquid. It is to be understood that as long as the discharge force (collecting force) of the transfer liquid L in the overflow tank 92 can be changed as necessary or in short, as long as the strength of the design surface oppositely-separating flow can be changed as necessary, the same effects can be achieved by increasing the collecting force of the transfer liquid L even if the object W relatively moves away while it gets out of the liquid. By the way, an example of other methods for increasing the collecting force includes decreasing the overflow tank 92.

In addition, in this embodiment, an overflow tank is additionally provided at the rear end (downstream side) of the overflow tank 92 for forming the design surface oppositely-separating flow, and, for the convenience of description, it will be referred to as a terminal end overflow tank 97 (see FIGS. 1 to 4). This terminal end overflow tank 97 maintains the level of the surface of the liquid to be almost constant by collecting the transfer liquid L containing film residues and contributes to the recycled use of the transfer liquid L, and is frequently provided in a conventional transfer tank. The structure in which overflow tanks are provided in two stages in a parallel pattern is referred to as a “two-stage OF structure” (here, the “OF” represents overflow), and, in a case where the overflow tanks 92 and 97 are represented in a simple manner (discriminated), the overflow tank 92 for forming the design surface oppositely-separating flow will be referred to as a “first-stage OF tank”, and the terminal end overflow tank 97 will be referred to as a “second-stage OF tank”.

Hereinafter, the operation and the advantages of the two-stage OF structure (the flow of the liquid in the transfer liquid) will be described.

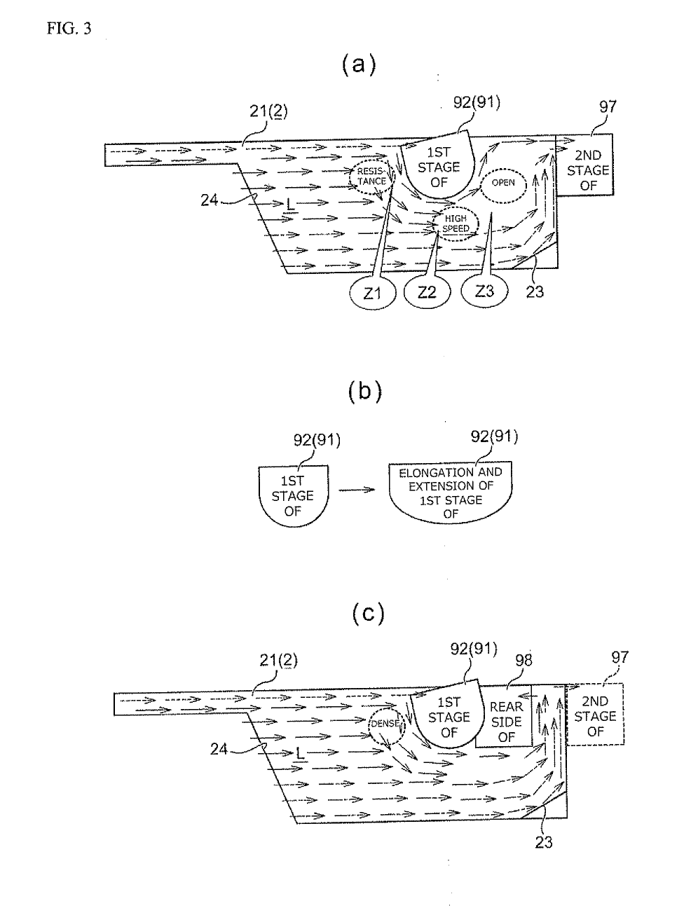

According to the two-stage OF structure, the flow of the liquid inside the transfer tank 2 is controlled as below on the whole. First, the flow of the liquid inside the transfer tank 2, for example, as illustrated in FIG. 3, is classified into the following three types depending on the depth (height) in the liquid.

near upper layer (upper layer stream): broken line in the figure

near middle layer (middle layer stream): solid line in the figure

near lower layer (lower layer stream): dashed-dotted line in the figure

Here, the middle layer stream flows at an almost same height in the first-stage OF tank 92, the OF tank 92 acts as a baffle plate (standing wall) for the flow of the liquid to be resistance for the liquid flow, and the flow is mainly considered as a flow that flows through the lower side of the OF tank 92. On the other hand, it is considered that there is no resistance for the liquid flow on the upper side and the lower side of the middle layer stream (or the influence of the resistance of the first-stage OF tank 92 is extremely small), and the upper layer stream and the lower layer stream are considered to flow almost horizontally along the flow of the liquid.

It is to be understood that a “layer” described here is a term conveniently used for the discrimination of a depth (height) in the transfer liquid, and, as is represented by the middle layer (middle layer stream), the actual flow does not form a layer as a whole (the stream does not flow in parallel in a layered state).

From such a viewpoint, the flows in the transfer liquid are understood as being summarized as below (see FIG. 3).

First, before the first-stage OF tank 92 (until the first-stage OF tank 92 becomes resistance for the liquid flow), the upper layer stream, the middle layer stream, and the lower layer stream flow at an almost same speed in the same horizontal direction.

Then, near (immediately before) the first-stage OF tank 92, as described above, only the upper layer stream near the liquid surface is collected by the first-stage OF tank 92 for forming a design surface oppositely-separating flow. At this time, since a flow rate increase brim 94 is included in the OF tank 92, the upper layer stream collected by the OF tank 92 is accelerated in the horizontal direction.

In addition, since the first-stage OF tank 92 becomes resistance for the liquid flow, the middle layer stream mainly becomes a liquid flow (this is referred to as a downward flow) that gets into the lower side of the first-stage OF tank 92 so as to slip through the first-stage OF tank 92. Since the first-stage OF tank 92 becomes resistance for the liquid flow, the speed of this downward flow is understood to be lowered. After slipping through the OF tank 92, the middle layer stream that gets into the lower side of the first-stage OF tank 92 becomes an upward flow this time (this is referred to as an upward flow). Since this upward flow comes after opening the resistance for the liquid flow, the speed thereof is understood to be lowered. In addition, the upward flow of the middle layer stream is understood to operate to pull up the lower layer stream. Thereafter, although the upward flows of the middle layer stream and the lower layer stream are collected in the second-stage OF tank 97, this collection may be performed by the whole wall surface of the terminal end of the transfer tank 2.

Here, the operation and the advantages of the flow (reference numeral Z1 in the figure) of the middle layer stream getting into the lower side of the first-stage OF tank 92 will be described.

In order to pull up the object W from the transfer liquid L, as described above, while the transfer liquid L containing foreign substances flows to go round the design surface S1 facing the downstream side just as it is, such an impinging stream (roundabout flow) is understood to be generated near the middle layer stream in which the object W operates to block the liquid flow as well as near the upper layer. However, in this embodiment, since the middle layer stream flows downward so as to get into the lower side of the first-stage OF tank 92, this operates to offset the impinging stream formed near the middle layer, and the approaching of the middle layer stream to the design surface S1 is prevented, and furthermore, the attachment of foreign substances contained in the middle layer stream to the design surface S1 is prevented.

In addition, in this embodiment, a boundary is formed (assumed) between the middle layer stream and the lower layer stream (particularly, reference numeral Z2 in the figure that is disposed on the lower side of the first-stage OF tank 92), and the operation and the advantages thereof will be described.

While the speed of the middle layer stream is lowered by the resistance of the first-stage OF tank 92 so as to form a downward flow, the lower layer stream is understood to directly flow to the downstream in the state in which the speed and the direction are maintained (a stable liquid flow state is maintained). Accordingly, the foreign substances in the middle layer stream are suppressed from falling and depositing on the upper surface of the lower layer stream (this is referred to as a curtain effect according to a liquid flow in which the lower layer stream is stable). In addition, on the lower side of the first-stage OF tank 92, an interval (the depth of the transfer tank 2) between the OF tank 92 and the bottom of the transfer tank 2 is the narrowest, whereby the speed of the middle layer stream increases. From these, the foreign substances contained in the middle layer stream are suppressed from being fallen and deposited to the bottom of the transfer tank in the boundary portion between the middle layer stream and the lower layer stream (this serves for the prevention of the sedimentation of foreign substances near the transfer tank).

Next, the operation and the advantages of a portion (reference numeral Z3 in the figure) at which the middle layer stream becomes an upward flow will be described.

When the middle layer stream slips through the lower side of the first-stage OF tank 92, the resistance for the liquid flow disappears so as to open the upper side, the speed of the middle layer stream is lowered, and the upward flow is promoted. In addition, the speed of the lower layer stream is lowered in accordance with this, and, from this, an agitation phenomenon that may easily occur due to a grinding effect of foreign substances is suppressed, thereby operating such that the foreign substances disposed near the boundary between the middle layer stream and the lower layer stream are prevented from being broken and scattered. Accordingly, near the middle layer and the lower layer of the transfer tank 2, the collection of foreign substances is promoted, and the foreign substances are further prevented from being deposited on the bottom of the transfer tank 2.

In addition, in this embodiment, an inclined plate 23 is provided on the lower side (the corner portions of the transfer tank 2) of the second-stage OF tank 97, and hereinafter, the operation and the advantages thereof will be described.

While the inclined plate 23 is responsible for an operation of allowing the lower layer stream to flow upward in the terminal end portion, it has a main role for performing support such that the rear stage (downstream side) of the middle layer stream that becomes an upward flow has no defect by additionally allowing the lower layer stream to be formed upward when the middle layer stream becomes the upward flow and conveys the foreign substances to the upper side after slipping through the lower side of the first-stage OF tank 92. From this, the foreign substances contained in the middle layer stream and the lower layer stream can be collected more efficiently.

Conventionally, while such an inclined plate may be present, the main purpose thereof is a taper process of the terminal end of the transfer tank for reducing the amount of liquid housing. It is to be understood that, even when a phenomenon of inducing (guiding) the transfer liquid L (lower layer stream) to the upper side by using the inclined plate provided at the terminal end of the transfer tank also occurs more or less in the conventional transfer tank, conventionally, there is no first-stage OF tank 92, and accordingly, there is no going-round (an upward flow from submerged inclusion) of the middle layer stream according to the OF tank 92, whereby, naturally, pulling-up of the lower layer stream according to this flow does not occur. In addition, since there is no first-stage OF tank 92, the flow of the middle layer stream is in the horizontal direction, and even the pulling-up of the transfer liquid according to the inclined plate can be expected, the horizontal flow of the middle layer stream acts to disturb the pulling-up of the lower layer stream, and consequently, only the middle layer stream is pulled up, and accordingly, pulling-up of foreign substances in the lower layer stream to the same degree as that of this embodiment cannot be expected.

In addition, there is an increased need for decreasing the amount of the transfer liquid L housed inside the transfer tank 2 as much as possible in the aspects of the cost, the processing efficiency, and the environment (in both aspects of a burden for separating foreign substances to be wasted and a burden for filtering the liquid to be circulated).

Furthermore, since the liquid pressure transfer is a transfer technique using liquid pressure, the depth (depth MAX) of the transfer tank 2 is necessary for which the object W is completely immersed (buried) in the transfer liquid L, and this depth is not essential for over the entirety (entire length) of the transfer tank 2, and, for example, the depth may be secured from a transfer requiring section formed from the immersion area P1 to the liquid-leaving area P2. Conversely, in a transfer not-requiring section such as a film supply end, such a depth does not necessarily need to be secured, and, from the viewpoint of decreasing the capacity inside the transfer tank 2 as described above, in this embodiment, the depth of the transfer tank 2 is formed to be shallow in the transfer not-requiring section. More specifically, for example, as illustrated in FIGS. 2 and 3, the film supply side (upstream side) of the transfer tank 2 is formed to be shallow over a suitable length, and, in the portion of a middle stream area following this, the bottom of the tank is formed in an inclined shape and is formed to have the depth that gradually increases, and the entire transfer tank 2 is formed in an approximate trapezoidal shape that is narrowed downward when seen from the side face. Here, reference numeral 24 represented in the figure is an inclined part formed in an inclined state in the portion of the middle stream area of the transfer tank 2. In the case of this embodiment, by collecting the liquid surface residual film F′, an interval between the immersion area P1 and the liquid-leaving area P2 is formed to have a suitable length, this section is the transfer requiring section but is not limited to being a section (a section having a suitable distance) that is clearly discriminated from the transfer requiring section, and, for example, in a liquid pressure transfer in which the immersion area P1 and the liquid-leaving area P2 almost match each other, only the immersion area P1 is the transfer requiring section.

As described above, the first-stage OF tank 92 forms an upward flow by allowing the middle layer stream to slip therethrough, and this upward flow contributes to the pulling-up of the lower layer stream and the prevention of sedimentation and the collection of foreign substances (conveyance to the second-stage OF tank 97), and the like. Accordingly, for example, as illustrated in FIG. 3(b), in a case where the first-stage OF, tank 92 is configured to be stretchable in the direction of the flow of the liquid (the longitudinal direction of the transfer tank 2), the upward flow of the middle layer stream, the pulling up of the lower layer stream, and the like can be appropriately controlled.

In addition, for example, as illustrated in FIG. 3(c), the middle layer stream can be collected from the rear side of the first-stage OF tank 92. Here, in FIG. 3(c), another overflow tank (this will be referred to as a rear-side OF tank 98 for the convenience of description) is provided in the continuous state on a stage right after the first-stage OF tank 92, and the second-stage OF tank 97 is also provided.

By employing such a structure, for example, as additionally illustrated in the figure, it may be configured such that the upper layer stream is collected by the first-stage OF tank 92, the middle layer stream is collected by the rear-side OF tank 98, and the lower layer stream is collected by the second-stage OF tank 97. In other words, in FIG. 3(c), the layer streams are collected by mutually-different OF tanks, for example, by collecting foreign substances considered to stay long in the middle layer stream (lower surface) according to the curtain effect of the lower layer stream by using the rear-side OF tank 98, the transfer liquid L (lower layer stream) collected by the second-stage OF tank 97 can be collected in a relatively clean state, and, in a case where the collected lower layer stream is circularly used, there is an advantage of reducing the cleaning load (filtering load) (in other words, the filtering load can be set in accordance with the mix ratio of foreign substances of the collected transfer liquid L).

In addition, although the second-stage OF tank 97 is provided in FIG. 3(c), in a case where the collection of the middle layer stream from the rear side of the first-stage OF tank 92 is considered to be important, the second-stage OF tank 97 does not necessarily need to be provided.

Next, a method of cleaning the transfer liquid L collected by the overflow tank 82 for forming a side oppositely-separating flow, the overflow tank 92 for forming a design surface oppositely-separating flow, and the terminal end overflow tank 97 will be described. The transfer liquid L collected by the overflow tanks 82, 92, and 97, for example, as illustrated in FIG. 2, is sent to the cleaning device through a water level adjustment tank, has foreign substances removed therefrom, and then, is reused as new water (purified water) after passing through a temperature adjustment tank. It is to be understood that the foreign substances acquired by the cleaning device are wasted.

In addition, to a portion in the middle of a pipeline that sends the transfer liquid L (containing the foreign substances) collected by the overflow tank 82 to the water level adjustment tank or the bottom of the water level adjustment tank, a disposal pipe discharging foreign substances (sludge) collected therein is connected. In addition, generally, since the mix ratio of foreign substances is high as described above, the overflow tank 75 as the liquid surface residual film collecting mechanism 7 is disposed as it is.

Furthermore, in order to remove the foreign substances from the transfer liquid by using the water level adjustment tank, the cleaning device (sedimentation tank), or the like, the cleaning is achieved by storing liquid disposed inside the adjustment tank or the sedimentation tank so as to dam the liquid up once using a board (sheathing board) or the like and sending the relatively clear top of the stored water to the rear stage.

In addition, the new water cleaned as described above, for example, as illustrated in FIG. 2, is supplied from the lower side of the guide conveyer 33 provided on the film supply side (upstream side) or the inclined part 24 of the portion of the middle stream area of the transfer tank 2 or, for example, is supplied from the lower side of the overflow tank 92 for forming the design surface oppositely-separating flow upward and downward toward the liquid-leaving area P2. Here, “upward toward the liquid-leaving area P2” is the supply of new water for forming the design surface oppositely-separating flow or the side oppositely-separating flow, and “downward toward the liquid-leaving area P2” is responsible for an operation supporting the upward flow (lower layer stream) for sending foreign substances to the second-stage OF tank 97 in FIG. 3.

In addition, in a discharge port at the time of supplying new water to the transfer tank 2, more specifically, in the inclined part 24 of the portion of the middle stream area of the transfer tank or on the lower side of the overflow tank 92, it is preferable that new water supplied by arranging a punching metal or the like be uniformly discharged from a relatively broad range (prevention of partial straight advancement of the new water).

As described above, in the liquid pressure transfer, various kinds of transfer films F (transfer patterns) and activating agents in various kinds of states are applied, and because variously different sizes of objects W are processed, the immersion area P1 may be moved in the front or the back by, for example, about 800 mm, and accordingly, the liquid-leaving area P2 may also be moved in the front or the back by, for example, about 800 mm to 1200 mm. For this reason, the immersion area P1, the terminal end pulley 62B of the film holding mechanism 6, the dividing means 71 of the liquid surface residual film collecting mechanism 7 (the air blowing devices 73 and 73a), the overflow tanks 75, the overflow tanks 82 of the liquid-leaving area cleaning mechanism 8, the air blowing device 85, the overflow tank 92 of the design surface cleaning mechanism 9 (oppositely-separating flow forming means 91), and the like are in closely related positional relationship. Therefore, as the immersion area P1 is moved, each of the above constituent unit members are preferably moved at the same time or independently, and for this reason, in the present embodiment, for example, as illustrated in FIG. 2, the terminal end pulley 62B of the film holding mechanism 6, the air blowing devices 73, 73a and 85, the overflow tanks 75 and 82 are mounted on a movable frame 28 in the longitudinal direction of the transfer tank 2 (in the front and back direction), the overflow tank 92 is configured to be mounted on a movable frame 29 that can move in the front and back direction independently, and they are configured to be able to move as necessary according to the move of the immersion area P1 and the liquid-leaving area P2.

By the way, the method for moving each of the frames 28 and 29 may be manual, or the movement of each of the frames 28 and 29 may be automatically controlled using a linear motor and the like (actually, it is practical to use a program for automatically moving the positions of the frames 28 and 29 according to, e.g., a program for pulling up the object W.).

When the transfer film F is supplied to the transfer tank 2 in the present embodiment, the elongation and extension reduction prevention mechanism 10 is provided to reduce extension of the transfer film F, and this mechanism will be hereinafter explained. The elongation and extension reduction prevention mechanism 10 is provided to prevent the activating agent component K from separating and oozing from the surface of the film to the surface of the transfer liquid L as the transfer film F comes into contact with the liquid, and prevent the activating agent component K from staying on the surface of the liquid, making a film, and blocking the elongation and extension of the transfer film F. Therefore, both sides of the transfer film F supplied to the surface of the transfer liquid L are reliably attached to the conveyer 61 (belt 63) provided in proximity to the side walls 22 of the transfer tank 2. In the explanation below, first, the reason (details) why the extension of the transfer film F is blocked by the activating agent component K flowing out of the transfer film F coming into contact with the liquid will be explained.

During the transfer, the activating agent is applied to the transfer film F in order to activate the transfer pattern, and some of the activating agent applied to the film moves away from (is separated from) the surface of the transfer film F as the transfer film comes into contact with the liquid (contact with the transfer liquid L), whereby the activating agent flows (oozes) onto the surface of the transfer liquid L (this is mainly referred to as the activating agent component K in this specification). The outflow of the activating agent component K to the surface of the liquid is not necessarily limited to the direction in which the transfer film F is supplied (the direction of the flow of the liquid), and the activating agent component K may flow in various directions, but since, e.g., the flow of the liquid is generated and the film is supplied, it is considered that the (preceding) outflow to the direction in which the film is supplied is relatively large. Because of such facts, when the liquid pressure transfer is repeatedly performed, the activating agent component K increases on the surface of the transfer liquid L little by little, and for example, the activating agent component K is accumulated in proximity to the side walls 22 of the transfer tank 2 where the flow of the liquid is weak. Then, the activating agent component K accumulated in proximity to the side walls 22 is condensed at the surface of the liquid, and attains a state as if a film (oil film) is formed by oil component on a water surface (for the sake of convenience, this will be referred to as liquid film), and this performs an action of rejecting elongation (extension) of the transfer film F. In other words, when the liquid pressure transfer is continued, the elongation (extension) of the film is blocked by the liquid film formed by the activating agent component K.

There are other factors for blocking the extension of the transfer film F supplied to the surface of the transfer liquid L. For example, almost all the transfer liquid L in the transfer tank 2 is circulated and used in view of, e.g., the environmental protection and efficient use of resources (recycling). Therefore, the activating agent component K (liquid film) discharged to the surface of the transfer liquid L is not only simply accumulated (the activating agent component K not only drifts) on the surface of the liquid but also some of the activating agent component K is also dissolved into the transfer liquid L. For this reason, when the liquid pressure transfer is repeatedly performed, the concentration of the activating agent gradually increases in the transfer liquid L, and which increases the viscosity of the transfer liquid L, and this is also one of the factors for blocking the elongation of the transfer film F.

Further, when the activating agent of ultraviolet curing resin is used, the activating agent component K is cured with a low amount of light even in the indoors, and therefore, the viscosity of the transfer liquid L tends to be further increased. In addition, because of social environment in which almost all of the transfer liquid L is reused to suppress the amount of waste liquid as described above, this is one of the factors why the viscosity of the transfer liquid L is further increased. However, since the liquid pressure transfer requires transfer process with a high degree of stability, the surface of the transfer liquid L is stabilized, e.g., wave is suppressed, as a matter of course, and it is true that this performs an action of preventing the activating agent (resin component) from mixing into the transfer liquid L.

It should be noted that the phenomenon that the elongation of the transfer film F is blocked by the activating agent component K on the surface of the transfer liquid L is more conspicuous with an activating agent that is used for the liquid pressure transfer in which a transfer pattern also having the surface protection function is formed (liquid pressure transfer that does not require the top coating). This is considered that the activating agent used therefor has a high level of viscosity than ordinary solvent type, and therefore, this tends to greatly suppress the extension of the transfer film F.

Moreover, in general, as illustrated in FIG. 23, the transfer film F supplied to the surface of the transfer liquid L gradually curls upward due to the difference of extension between the transfer pattern located at the upper side of the surface of the transfer liquid L and the water-soluble film located at the lower side thereof (the elongation rate of the water-soluble film is higher), and this makes it harder for the transfer film F supplied to the transfer tank 2 to come into contact with the film holding mechanism 6 provided in proximity to the side walls 22.

Therefore, when the liquid pressure transfer is repeatedly performed without the elongation and extension reduction prevention mechanism 10, the transfer film F that initially extended to the conveyer 61 after the transfer film F comes into contact with the liquid does not attach, and for this reason, the elongation and extension reduction prevention mechanism 10, is provided in the present embodiment to prevent this kind of reduction of the elongation and extension.

In this case, in the present embodiment, the blow method is employed as the elongation and extension reduction prevention mechanism 10, which blows air to remove the activating agent component K that extends as the liquid film on the surface of the transfer liquid L between the film holding mechanism 6 (conveyer 61) and the transfer film F and blocks the elongation of the transfer film F. More specifically, for example, as shown in FIG. 1, this mechanism blows air to portions in proximity to the side walls 22 where the flow of the transfer liquid L (the flow of the liquid) is considered to weaken and the activating agent component K is considered to be likely to be accumulated. In particular, the mechanism preferably pushes (moves) the activating agent component K located (floating) at the portions at both left and right sides of the air blowing device 26 to positions between the film holding mechanism 6 and the side walls 22. By the way, because, e.g., the portions between the film holding mechanism 6 and the side walls 22 are set so that the upper end edge of the belt 63 is at a position higher than the surface of the transfer liquid L, portions substantially do not affect the transfer position or gives extremely small effects on the transfer position. Therefore, in the present embodiment, the activating agent component K is pushed to the portions. In the present embodiment, as described above, the air blowing device 26 performs the action of extending the transfer film F to portions therearound. In this case, in order to clearly distinguish the mechanism from the action of the air blowing device 26, the mechanism is referred to as the elongation and extension reduction prevention mechanism 10.

In the present embodiment, as described above, the overflow tanks 75 are provided, outside of the conveyer 61 serving as the film holding mechanism 6, along the both side walls 22 of the transfer tank 2, and accordingly, the activating agent component K, moved to the portions between the film holding mechanism 6 and the side walls 22, is collected by the overflow tanks 75. It is to be understood that, in this case, for example, as also illustrated in FIG. 4, the discharge ports 76a for introducing and collecting the activating agent component K are also formed at the front edge sides (upstream side) of the overflow tanks 75.

Further, in the embodiment as illustrated in FIG. 1, two compressed air blow nozzles 102 are applied as the elongation and extension reduction prevention mechanism 10 (removing means 101). More specifically, originally, the transfer film F supplied to the transfer tank 2 absorbs the transfer liquid L to swell and soften, and gradually extends in four directions. Therefore, in FIG. 1, air is blown from the two compressed air blow nozzles 102 to act on (to come into contact with) the surface of the liquid that faces the extending edge of the transfer film F, whereby the activating agent component K mainly floating in proximity to the edge is removed from there, and the transfer film F is elongated in directions of both sides in proximity to the edge (reduction of elongation is prevented). In this case, the compressed air blow nozzle 102 preferably includes a multi-joint flexible hose as shown in the figure. This is because fine adjustment of, e.g., the position of the nozzle and the direction of air blow, can be easily made.

By the way, the air blow for removing the activating agent component K is preferably not done in such a manner that air acts on (coming into contact with) the transfer film F, and is preferably done in such a manner that air acts on only the surface of the transfer liquid having no film. This is to stably hold the surface of the transfer liquid and to convey the transfer film F to the transfer position (immersion area P1) in a state in which waves are kept at the lowest level. With regard to this point, for example, as illustrated in the enlarged view of FIG. 1, it is preferable to use a nozzle formed in a tapered shape toward the discharge port, so that air acts on the target surface of the liquid (such as the surface of the liquid facing the extending edge of the film) with pinpoint accuracy. Meanwhile, it is preferable to apply nozzles that have discharge ports having relatively large widths to the air blowing devices 73 and 85 and the like.

In FIG. 1, when air is blown, air is blown to act on the surface of the liquid of the upstream side (front side) elongating when the transfer film F comes into contact with the liquid. More specifically, air is blown to act on the surface of the liquid at the upstream side with respect to the action start end (leading end pulley 62A) of the film holding mechanism 6. This is to more effectively elongate the transfer film F by removing the activating agent component K, which becomes a factor of blocking the elongation of the transfer film F, before the transfer film F elongates. With such air blow, the activating agent component K floating on the surface of the transfer liquid is conveyed to the portions between the side walls 22 and the film holding mechanism 6 while avoiding the action start ends (leading end pulley 62A) of the film holding mechanism 6.

In the embodiment of FIG. 1, the air blow from the two compressed air blow nozzles 102 is in a form of air blow somewhat opposite to the flow of the transfer liquid, but the two compressed air blow nozzles 102 may have a low performance (force of air blow) such that the activating agent component K (liquid film) on the surface of the liquid is moved to the side walls 22, and therefore, there is no chance that the air blow by the compressed air blow nozzles 102 blocks the flow of the transfer liquid L itself. By the way, the air blow opposite to the flow of the transfer liquid is preferably at an angle of about 90 degrees to about 120 degrees with respect to the direction of the flow of the liquid (downstream direction).

It is to be understood that, as also shown in FIG. 2, the air blow by the compressed air blow nozzle 102 may be blown to the downstream along the flow of the transfer liquid L. Even in this case, however, it is preferably to blow air so as to move the activating agent component K on the surface of the transfer liquid to both side walls 22. More specifically, it is preferable to blow air so as to push the activating agent component K on the surface of the liquid floating in proximity to the side walls 22 disposed on the film supply side from the position before the leading end pulley 62A of the film holding mechanism 6 (conveyer 61) to the portions between the film holding mechanism 6 (conveyer 61) and the side walls 22. By the way, in this form of air blow in the downstream direction, the air blow is preferably blown at an angle of about 50 degrees to about 90 degrees with respect to the direction of the flow of the liquid (downstream direction).

As described above, the air blow of the elongation and extension reduction prevention mechanism 10 (removing means 101) is greatly different from the air blowing device 26 in that it is preferable not to cause the air to directly act on the transfer film F and in that a certain range of air blow direction is tolerated. In contrast, the air blowing device 26 causes the air to directly act on the surface of the transfer film F, and in addition, the air blow direction is set in one direction from the upstream to the downstream in view of the movement of the film.

Subsequently, standard of adjustment of the amount of air blow that is made when the air is blown by the compressed air blow nozzle 102 to prevent reduction of the elongation will be explained.

The applicant of the present application has conducted the following test to check the effects of air blow by the elongation and extension reduction prevention mechanism 10. In this test, 4000 liters of transfer liquid L (water) was put into the transfer tank 2 and is circulated, and continuous operation was performed while a conventional activating agent was applied to a conventional liquid pressure transfer film. When the transfer film no longer attached to the film holding mechanism 6 (was separated from the film holding mechanism 6), the operation was terminated, and the amount of used activating agent was checked. In this case, in the first time (the first attempt), the air blow for prevention of reduction of the elongation was not performed, and only in the second time (second attempt), the air blow for prevention of reduction of the elongation was performed. As a result, in the first attempt, when about 4 kg of activating agent was used in about five hours, the transfer film no longer attached to the film holding mechanism 6. The second attempt was carried out under the same condition except that water of the transfer tank 2 was replaced and the elongation and extension reduction prevention mechanism 10 was used to blow air as described above. In the second attempt, no change could be seen, and the transfer film continued to reach the film holding mechanism 6 always stably. Therefore, when continuous operation was performed for ten hours (about 8 kg of activating agent was used), the check (test) is terminated.

When judgment is made from this test, in the first attempt, the air blow for prevention of reduction of the elongation is not performed. Accordingly, the force of elongation of the transfer film F is gradually lost, and the elongation decreases, so that it is considered that the transfer film no longer attached to the film holding mechanism 6. In the second attempt, the air blow for prevention of reduction of the elongation is always performed, so that the activating agent component Kon the surface of the liquid is removed (the concentration of the surface of the liquid decreases), and the relationship is maintained such that the force of elongation of the film is stronger. Therefore, it is considered that the elongation of the transfer film F (arrival at the film holding mechanism 6) was always maintained.

Therefore, when the air blow for prevention of reduction of the elongation is performed, the following conclusion is obtained as the standard of adjustment of the amount of air blow. The air is to be blown so as to satisfy the following relationship: (the resisting force for blocking the elongation of the film due to the viscosity of the liquid and the liquid film due to the concentrations of both activating agents)<the force of the elongation of the film.

In this case, the reason why not only the concentration (ratio) of the activating agent on the surface of the liquid but also the concentration of the transfer liquid are taken into consideration as the factors (conditions) for blocking the elongation of the transfer film F is because the concentration of the activating agent dissolved in the transfer liquid gradually increases as the transfer is repeatedly performed as described above. In this regard, the concentration of the activating agent in the transfer liquid can also be decreased or maintained at a low level by supplying the new water, and therefore, it is considered that it is also possible to prevent reduction of the elongation of the transfer film F by supplying the new water. By the way, in the present embodiment, this point is also taken into consideration, and therefore, the new water is additionally supplied.

It should be noted that the removing means 101 in the elongation and extension reduction prevention mechanism 10 may not necessarily move the activating agent component K to the side walls 22 by blowing air, and other removing methods may also be employed. For example, a vacuum method may be employed, in which the activating agent component K on the surface of the liquid as well as the transfer liquid L are sucked. In other words, in this case, a sucking nozzle is employed as the removing means 101.

In the present embodiment, the compressed air blow nozzle 102 of the elongation and extension reduction prevention mechanism 10 is provided together with the air blowing device 26, but the elongation and extension reduction prevention mechanism 10 may not be necessarily provided with the air blowing device 26, and when the transfer film F can be elongated to portions therearound by causing the elongation and extension reduction prevention mechanism 10 to blow air (remove the activating agent component K) or by performing the action of conveying (action of holding) with the flow of the liquid or the film holding mechanism 6, the air blowing device 26 may be omitted from the entire configuration of the liquid pressure transfer device 1.

Subsequently, the transfer film supply device 3 will be explained. For example, as shown in FIG. 1, the transfer film supply device 3 includes a film roll 31 made of the transfer film F wrapped as a roll, a heat roller 32 for heating the transfer film F pulled from the film roll 31, and a guide conveyer 33 for supplying the transfer film F to the transfer tank 2, and the transfer film F is supplied to the transfer tank 2 by guide rollers 34 by way of these members.

In this case, in the above explanation, the transfer film F is successively fed to the transfer tank 2 from the film roll 31 wrapped as the roll. For example, a so-called batch-type liquid pressure transfer may be employed in which the transfer film F is cut into a rectangular shape in the first place, and the transfer films F thus cut is fed to the transfer tank 2 one by one, and the object W is pressed thereupon from above, and hereinafter, this will be described.

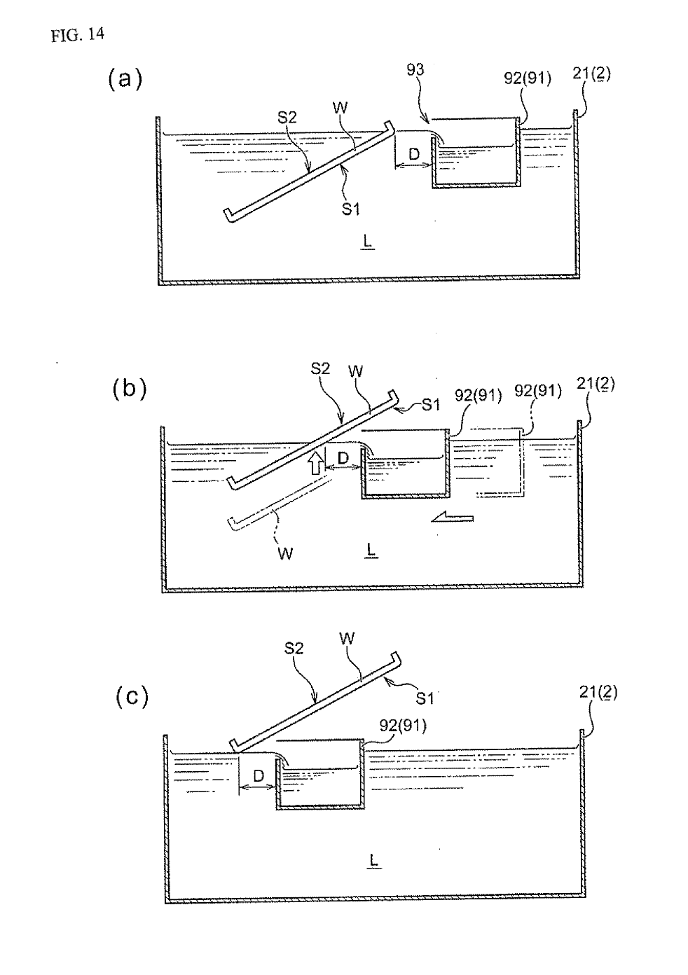

In the batch-type liquid pressure transfer, for example, as illustrated in FIG. 14, the object W is appropriately inclined, and, generally, the immersion direction and the liquid leaving direction are set to the vertical direction (perpendicular direction). In other words, generally, the object W is immersed into the transfer tank 2 from right above, and gets out of the transfer tank 2 on the upper side straight above. Here, FIG. 14 is a diagram illustrating a status in which the object W immersed at an appropriate inclined posture is slowly pulled up from the transfer tank 2 in a stepped manner. In this figure, since an interval between the object W (design surface S1) and the overflow tank 92 for forming the design surface oppositely-separating flow tends to gradually increase as the object W gets out of the liquid, the overflow tank 92 is caused to slowly approach the object W as the object W gets out of the liquid, whereby a distance (D in the figure) between the object W and the overflow tank 92 is maintained to be approximately constant (for example, about 100 mm). As above, particularly in the batch-type liquid pressure transfer, it is preferable to maintain the position (in other words, the distance between the object W and the overflow tank 92) of the object W getting out of the liquid with respect to the overflow tank 92 to be constant by moving the overflow tank 92.

Subsequently, the activating agent applying device 4 will be explained. For example, the activating agent applying device 4 is provided at a stage subsequent to the heat roller 32 of the transfer film supply device 3, and includes a roll coater 41 for applying the predetermined activating agent to the transfer film F. In this case, in the embodiment as illustrated in FIG. 1, the activating agent is applied to the transfer film F, and thereafter, this is supplied to the transfer tank 2. Alternatively, the structure and the like of the apparatus may be changed, and it is also possible to apply the activating agent to the transfer film F, which has been supplied to the transfer tank 2 and come into contact with the liquid, from above.

Subsequently, the object conveying device 5 will be explained. The object conveying device 5 places the object W into the transfer liquid L in an appropriate posture, and pulls out the object W from the transfer liquid L. Usually, in order to attach the object W with the transfer jig (which will be simply referred to as a jig J), the object conveying device 5 of the present embodiment also includes a conveyer 51 for performing an action of conveying and a jig holder 52. In other words, the object W is attached to the jig J in advance to perform the liquid pressure transfer, and the jig J is attached to and detached from the jig holder 52 to set the object W to the conveyer 51. Hereinafter, the conveyer 51 will be further explained.

For example, as illustrated in FIG. 1, the conveyer 51 has link bars 54 each passed horizontally between a pair of link chains 53 provided horizontally and has jig holders 52 arranged on the link bars 54 with a predetermined interval (see FIG. 12(a)), and the object W is immersed into the liquid L or gotten out of the liquid L continuously together with the jig J. It should be noted that attachment of the object W (jig J) to the conveyer 51 at the liquid-entering side and detachment of the object W (jig J) from the conveyer 51 at the liquid-exiting side after the transfer may be done automatically by a robot or may be done manually by an operator. In general, the conveying speed of the object W by the conveyer 51 (in particular, the speed in the immersion area P1) is set so as to be substantially in synchronization with the moving speed of the transfer film F on the surface of the liquid (i.e., the speed of the flow of the transfer liquid L).

The specific configuration of the conveyer 51 will be explained. For example, as shown in FIG. 1, this has such a structure that a liquid-exiting side wheel 57 is added to an ordinary triangular conveyer unit 55 of which conveying orbit is in an inverted triangle when it is seen from the side (the apex located at the lower side of the inverted triangle is a liquid-entering side wheel 56), and is configured such that the object W is put into the liquid generally in a section between the liquid-entering side wheel 56 and the liquid-exiting side wheel 57, and the liquid-leaving area P2 is set at a position different from the immersion area P1. More specifically, the liquid-leaving area P2 is set to be located clearly at the downstream side with respect to the immersion area P1 when it is seen in the top view.

By the way, in the aspect of conveying with only the conventional triangular conveyer unit 55, the object W is put into the liquid only at the apex at the lower side (the liquid-entering side wheel 56), and the object W is put into the liquid for a very short time or momentarily, as it were. In contrast, in the present embodiment, a long time is ensured when the object W is put into the liquid although the object W is put into the liquid in a straight manner.

Therefore, in the present embodiment, a relatively long distance can be ensured from the immersion area P1 to the liquid-leaving area P2, and this is a preferable aspect of conveying for dividing the liquid surface residual film F′ while the object W is put into the liquid and collecting the liquid surface residual films F′ at the portions of both side walls 22.

Further, in the present embodiment, in the section from the liquid-entering side wheel 56 to the liquid-exiting side wheel 57, the orbit of movement of the object W in the liquid is set substantially horizontally. The conveyer 51 has this kind of structure, and is further configured such that the conventional triangular conveyer unit 55 and the conventional straight conveyer unit 58 are connected by the liquid-exiting side wheel 57. These constituent unit members will be hereinafter explained.

Like the conventional configuration, the entire triangular conveyer unit 55 is configured to be inclinable about the liquid-entering side wheel 56, serving as the center of rotation, which corresponds to the lower side apex, and this enables the angle of the object W when the object W enters the liquid can be changed as necessary. By the way, in this case, the angle of entering the liquid is an angle at which the object W moves toward the surface of the transfer liquid L. For example, a setting range of about 15 degrees to about 35 degrees is assumed as this angle.

The straight conveyer unit 58 is also configured to be pivotable about the chain wheel 59 at the lower side, and has a so-called pantograph-shaped structure. This (the reason why the straight conveyer unit 58 is also configured to be pivotable) is because, even if the angle of the object W when the object W enters the liquid is changed by pivoting the triangular conveyer unit 55, the conveying length of the entire conveyer 51 (the entire length of the link chain 53) cannot be changed, and it is necessary to maintain the tension applied to the conveyer 51. In other words, the free pivoting end side of this is caused to function as a so-called tension pulley by pivoting the straight conveyer unit 58.

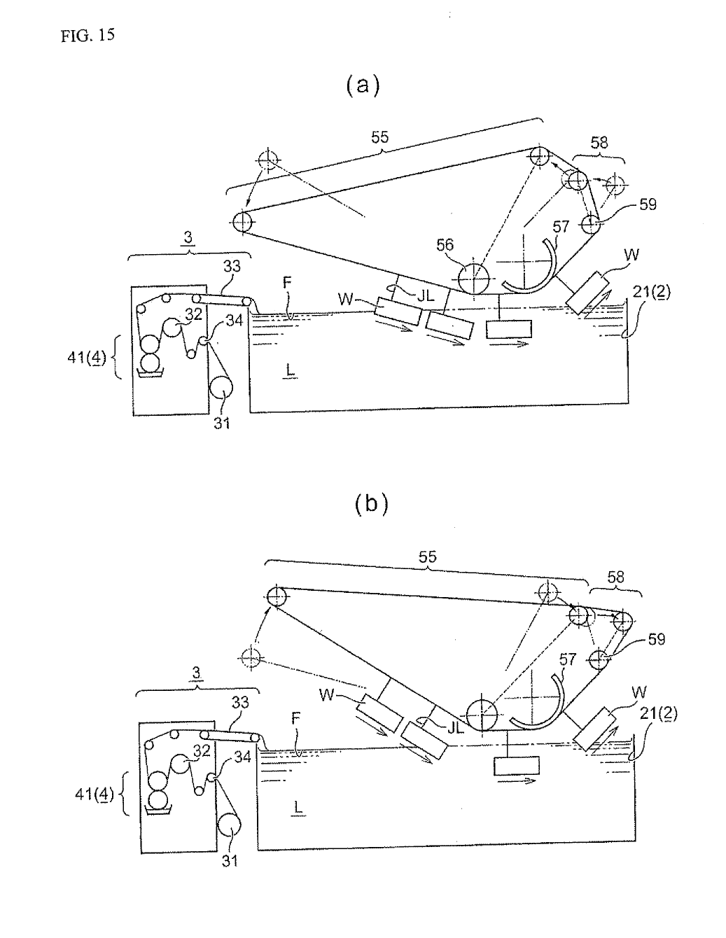

In this case, the solid line portion in FIG. 15(a) is a conveying orbit when the angle of entering the liquid is relatively small (for example, an angle of about 15 degrees when the object W enters the liquid), and the solid line portion in FIG. 15(b) is a conveying orbit when the angle of entering the liquid is relatively large (for example, an angle of about 30 degrees when the object W enters the liquid). By the way, in the present embodiment, a section from the liquid-exiting side wheel 57 to the pivoting center side of the straight conveyer unit 58 (the chain wheel 59) is set in a fixed state (only pivoting at the fixed position is allowed), and therefore, the angle of exiting from the liquid cannot be changed (set as fixed).

Although the liquid-exiting side wheel 57 is denoted as “wheel”, the liquid-exiting side wheel 57 may not be necessarily a rotating member according to the link chain 53 running. For example, as illustrated in FIG. 15 above, the liquid-exiting side wheel 57 may be a guide member that comes into contact with the chain and smoothly guides the chain (so-called sliding contact).

The diameter of the liquid-exiting side wheel 57 is preferably the same as that of the liquid-entering side wheel 56 or larger than that of the liquid-entering side wheel 56. This is because when the liquid-exiting side wheel 57 is smaller, this results in a higher peripheral speed (rotation speed) at which the object W turns along the outside of the liquid-exiting side wheel 57 when the object W moves out of the liquid and, results in a greater change of the angle (the speed difference with respect to the transfer liquid L becomes excessive). More specifically, in this conveyer 51, the moving speed (chain running speed) at the link chain 53 portion to which the link bar 54 is attached is maintained at a constant level, and therefore, when the diameter (rotation radius) of the liquid-exiting side wheel 57 decreases, this results in a higher peripheral speed (rotation speed) at which the object W turns along the outside of the wheel and, results in a greater change of the angle.

In the embodiment as illustrated in FIGS. 1 and 15 explained above, the angle of exiting from the liquid is fixed and unchangeable as described above. Alternatively, the angle of exiting from the liquid may be changeable. More specifically, for example, as illustrated in FIG. 16, this is a case where the entire conveying orbit is formed in a rectangular shape (in particular, trapezoid) when the conveyer 51 (link chain 53) is seen from the side. In this case, the liquid-entering side wheel 56 and the liquid-exiting side wheel 57 are set in a fixed state (only pivoting at the fixed position is allowed), and the remaining two chain wheels 59A, 59B are formed to be pivotable with respect to the liquid-entering side wheel 56 and the liquid-exiting side wheel 57, respectively. More specifically, straight conveyer units 58A, 58B at the liquid-entering side and the liquid-exiting side provided adjacently to the liquid-entering side wheel 56 and the liquid-exiting side wheel 57 are formed to be flexibly pivotable about the liquid-entering side wheel 56 and the liquid-exiting side wheel 57.

It is to be understood that in the present embodiment, the conveying length of the entire conveyer 51 (the entire length of the link chain 53) cannot be changed, either. Therefore, when the angle of the object W when the object W enters the liquid is changed, the straight conveyer unit 58B at the liquid-exiting side is also swung like a tension pulley, whereby the angle of exiting from the liquid is changed. Therefore, in the present embodiment, although the angle of exiting from the liquid is changeable, this is a change related to the angle of entering the liquid, and the angle of exiting from the liquid cannot be flexibly changed without any limitation. By the way, the solid line portion in FIG. 16 illustrates the aspect of conveying where the angle of entering the liquid is large and the angle of exiting from the liquid is small. On the other hand, the chain double-dashed line portion in FIG. 16 illustrates the aspect of conveying where the angle of entering the liquid is small and the angle of exiting from the liquid is large. By the way, regarding the specific angles, for example, the angle of entering the liquid can be changed from about 15 degrees to about 35 degrees, and the angle of exiting from the liquid can be changed from about 75 degrees to about 90 degrees.

In the embodiment as illustrated in FIGS. 15, 16, and the like explained above, the object W is conveyed substantially horizontally in the liquid from the liquid-entering side wheel 56 to the liquid-exiting side wheel 57, but the aspect of conveying the object W is not limited thereto, and for example, as illustrated in FIG. 17, a conveying form in which the object W gradually rises in the above-described interval may be employed. In this case, the object W is conveyed upward with an appropriate inclination angle (the angle of exiting from the liquid) while the object W is conveyed between both of the wheels. Therefore, when only the liquid-exiting side wheel 57 is gradually moved upward in the above section after the object W is put into the liquid, the angle at which the object W exits from the liquid can be gradually increased. Therefore, when the liquid-exiting side wheel 57 is configured to be able to move upward and downward flexibly in FIG. 16 explained above, the angle of exiting from the liquid can be changed with a higher degree of flexibility, and in some cases, the angle of exiting from the liquid can be changed without relying on the angle of entering the liquid at all.

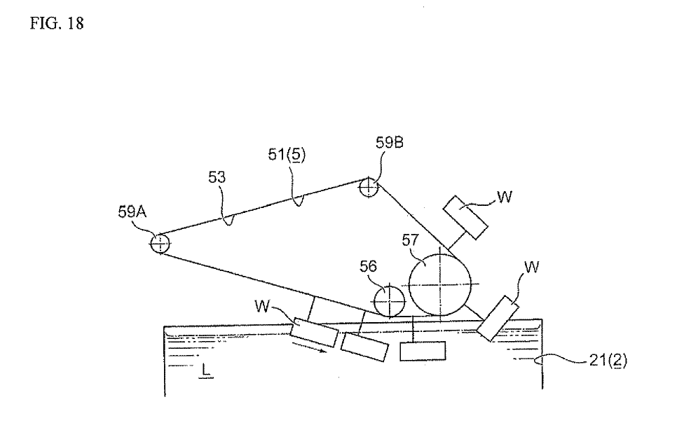

For example, as illustrated in FIG. 18, the conveying orbit of the conveyer 51 may also be formed in a folded manner to the liquid-entering side after the object W passes the liquid-exiting side wheel 57 (so-called overhang state). In this case, FIG. 18 illustrates that the object W having exited from the liquid is conveyed in the overhang manner. However, when, e.g., the arrangement of the conveyer 51 with respect to the transfer tank 2 (transfer liquid L) is changed, the object W can be pulled up in the overhang state when the object W moves out of the liquid. More specifically, the object W can be pulled out of the liquid while the design surface S1 faces the upper side; in other words, the object W is in a reversed state.

It should be noted that it is a purpose of the conveyer 51 explained above to ensure a time and a distance to some extent between the immersion area P1 and the liquid-leaving area P2, and thus the conveyer 51 may be constituted of only the conventional triangular conveyer unit 55. However, in this case, the jig leg JL as illustrated in FIG. 15 is set to have somewhat longer length, so that the object W sinks into the liquid relatively deeply, whereby a longer distance is preferably ensured from the immersion area P1 to the liquid-leaving area P2. It is to be understood that when the length of the jig leg JL is simply increased, this results in a higher peripheral speed at which the object W turns along the outside of the liquid-entering side wheel 56 (the apex at the lower side of the triangular conveyer) and, results in a greater change of the angle. Therefore, it is necessary to determine, e.g., the overall aspect of conveying in view of this.

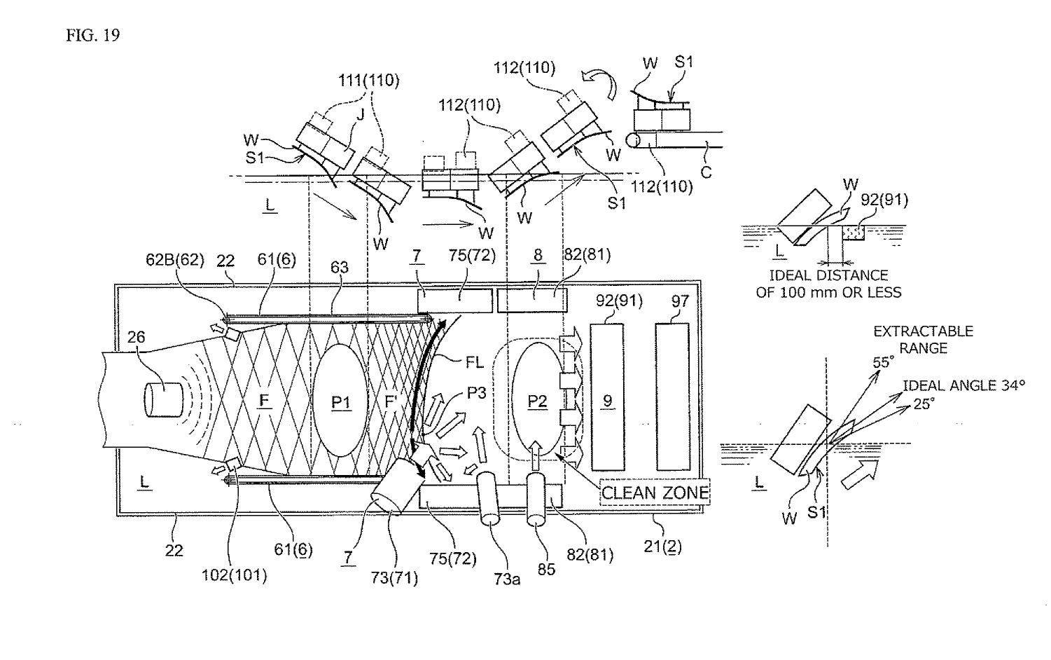

The object conveying device 5 is not limited to the conveyer 51 explained above. For example, as illustrated in FIG. 19, it is possible to apply a robot 110 (multi-joint robot, a so-called manipulator). In this case, the transfer tank 2 is also based on the form explained above, and while the object W is put into the liquid, it is preferable that the liquid surface residual film F′ be divided and discharged from the transfer tank 2. It is to be understood that the transfer liquid L and the liquid-leaving area P2 are preferably cleaned and purified at a high level by including the liquid-leaving area cleaning mechanism 8, the elongation and extension reduction prevention mechanism 10, and the like as well as the design surface cleaning mechanism 9.

In FIG. 19, reference numeral 111 indicating a broken line portion denotes a hand of a transfer robot for putting the object W into the transfer liquid L, and the hand 111 sandwiches the jig J that holds the object W in many cases. In the figure, reference numeral 112 indicating a chain double-dashed line portion denotes a hand of a handling robot for pulling the object W having been subjected to the transfer process from the liquid and placing the object W on a conveyer C for UV emission step, and in this case, the hand 112 also sandwiches the jig J that holds the object W in many cases.

In the liquid pressure transfer (robot transfer) to which the robot 110 is applied, the posture of the object W can be changed more flexibly than the conveyer 51 explained above. Therefore, the angle of entering the liquid, the angle of exiting from the liquid, or the posture and the position in the liquid can be set with a higher degree of diversity and a higher degree of flexibility. In addition, it is possible to flexibly set the immersion speed of the object W, the movement speed thereof in the liquid, and the liquid leaving speed thereof. It is also possible to provide multiple robots 110 at the right and left of the transfer tank 2 to alternately carry out the process from the transfer to the pulling up.

More specifically, in a robot transfer, when an object W gets out of the liquid, the overflow tank 92 for forming the design surface oppositely-separating flow is set to the fixed (immovable) state (it may be set to the fixed state in advance), and it is preferable to pull up the object such that the liquid leaving position has a constant distance, for example, of 100 mm or less from the overflow tank 92 all the time. This is a pulling-up technique mainly for preventing bubbles A and foreign substances from being attached to the design surface S1 of the object W (this will be referred to as a residual defect). In other words, by maintaining the distance to the overflow tank 92 from the design surface S1 to be almost constant at a position located in proximity thereto, a flow (design surface oppositely-separating flow) having a oppositely separating force, which is the same all the time, is applied to the design surface S1 that is in the middle of being gotten out of the liquid, whereby the bubbles A disposed on the liquid surface and the foreign substances disposed on the liquid surface and in the transfer liquid are excluded from the design surface S1, and the design surface S1 is cleaned as well.

In addition, in a liquid pressure transfer having a surface protection function, in addition to such a residual defect, a festering defect may easily occur (compared to a conventional liquid pressure transfer not having the surface protection function).

Here, the festering defect will be described. In the object W right after getting out of the transfer liquid, naturally, ink adhering to the design surface S1 is in an uncured and undried state and is in an easily flowing state. Accordingly, in a case where a load is applied to the design surface S1 due to the movement speed of the object W in the transfer liquid, ripples on the liquid surface, vibration of the object W right after getting out of the liquid, or the like, in accordance with the flow of ink that has just adhered to the design surface S1, a defect in which the design surface is festered may easily occur, and this is the festering defect. As a representative example of the festered defect, for example, there is a phenomenon occurring in a case where the object W is pulled up from the transfer liquid with the design surface S1 being parallel to the liquid surface.

In order to prevent such a festering defect, when the object W is pulled up from the transfer liquid, it is ideal to pull up the object in accordance with the shape of the design surface S1 without causing the liquid surface to ripple as much as possible. In addition, since the risk of the occurrence of the festering defect increases as the pulling-up speed increases, for example, the upper limit is set to 2 m/min (preferably), which is checked by applicants of this application.

Regarding the pulling-up angle (liquid-leaving angle), it is preferable to incline the design surface S1 facing the lower side with respect to the liquid surface by 25 degrees to 55 degrees, and, particularly, the applicants have confirmed that it is ideal to pull up the object from the liquid surface in accordance with the design surface S1 while the design surface S1 is constantly maintained and set to 34 degrees with respect to the liquid surface.

Based on the above-described points, in the case of the robot transfer, an ideal method is summarized as below in which the residual defect and the festering defect do not occur as possibly as can.

The upper limit of the pulling-up speed is set to 2 m/min, and the object is pulled up with a constant distance of 100 mm or less from the overflow tank 92 for forming the design surface oppositely-separating flow at a constant speed while the angle of the object W (design surface S1) is adjusted constantly to 34 degrees with respect to the liquid surface.

The liquid pressure transfer device 1 including the design surface cleaning mechanism 9 is configured as above, and, hereinafter, a method for transferring liquid pressure will be described while the aspect of the transfer performed by the liquid pressure transfer device 1 is described.

### (1) Transfer Film is Supplied

When the liquid pressure transfer is performed, first, the transfer film F is supplied to the transfer tank 2 storing the transfer liquid L. In this case, as described above, it is preferable to form a transfer pattern also having the surface protection function during the liquid pressure transfer (the top coating after the transfer is unnecessary), and therefore, as the transfer film F, a film having only a transfer pattern made of transfer ink formed on a water-soluble film is used, or a film having a curable resin layer formed between a water-soluble film and a transfer pattern is used, and in particular, when a transfer film F having only the transfer pattern formed on the water-soluble film is used, it is preferable to apply a liquid curable resin composition as the activating agent.

In the present embodiment, when the transfer film F is supplied to the transfer tank 2, the activating agent component K becoming in a liquid film form on the surface of the transfer liquid L between the film holding mechanism 6 (conveyer 61) and the transfer film F and reducing elongation of the transfer film F is removed. In order to remove the activating agent K, for example, as illustrated in FIG. 1, air is blown from the compressed air blow nozzles 102 to the surface of the liquid that faces the extending edge of the transfer film F, whereby the activating agent component K accumulated (floating) there is pushed to portions between the film holding mechanism 6 and the side walls 22 while it moves around the action start end (leading end pulley 62A) of the film holding mechanism 6. Therefore, on the surface of the liquid that faces the extending edge of the transfer film F, the activating agent component K is always removed, and therefore, the portions of both sides of the transfer film F (both side edge portions) reliably continue to reach the conveyer 61 serving as the film holding mechanism 6, and are conveyed to the immersion area P1 (transfer position) while a substantially constant elongation rate is maintained.

The activating agent component K pushed to the portions between the film holding mechanism 6 and the side walls 22 is preferably thereafter collected by introducing the activating agent component K into the overflow tanks 75 (discharge ports 76a). This is to continuously collect (discharge) the activating agent component K from the transfer tank 2, extend the transfer film F, and furthermore, continuously perform the precise liquid pressure transfer.

### (2) Object Enters the Liquid

As described above, after the transfer film F becomes transferrable on the surface of the transfer liquid L, for example, the objects W held by the conveyer 51 are successively put into the transfer liquid L in an appropriate posture (with the angle of entering the liquid). It is to be understood that this angle of entering the liquid can be changed as necessary according to the shape and projections and depressions of the object W (design surface S1).

Here, in the present embodiment, the immersion area P1 is somewhat away from the liquid-leaving area P2 where the object W is thereafter pulled up from the liquid, and the object W is placed in the transfer liquid L for a relatively long time.

As shown in FIG. 1, the transfer film F on the surface of the liquid is pierced, and a hole is formed therein, when the object W is enters the liquid. The film remaining on the surface of the liquid is the liquid surface residual film F′ that is not used for the transfer. Therefore, in the present embodiment, the liquid surface residual film F′ is reliably collected as soon as possible after the transfer so that the liquid surface residual film F′ does not reach the liquid-leaving area P2 at the downstream. Hereinafter, this aspect of collecting will be explained.

### (3) Liquid Surface Residual Film is Divided

When the liquid surface residual film F′ is collected, first, the liquid surface residual film F′ is divided in the longitudinal direction (the direction of the flow of the liquid/the direction from the immersion area P1 to the liquid-leaving area P2) of the transfer tank 2 at the downstream side with respect to the immersion area P1 and at the upstream side with respect to the liquid-leaving area P2, and as illustrated in FIG. 1, this is done by blowing air to the liquid surface residual film F′ having been used for the transfer so as to be divided. Thereafter, the liquid surface residual films F′ divided by the air are gradually conveyed to come closer to the both side walls 22 by, e.g., air blow and the flow of the liquid. As illustrated in FIG. 4, the liquid surface residual films F′ divided by the air are collected there by the overflow tanks 75 or the like provided on the both side walls 22.

### (4) Liquid Surface Residual Film is Collected

Then, in the present embodiment, in order not to block collection of the liquid surface residual films F′, the action of holding the film by the film holding mechanism 6 (conveyer 61) is cancelled in the overflow tank 75 (discharge port 76), but the action of holding the film by the film holding mechanism 6 (conveyer 61) is not to be cancelled before the overflow tank 75 (upstream side of the discharge port 76). For example, as illustrated in FIG. 9(a), the action of holding the film is preferably configured to somewhat act on the discharge port 76 (overlap state). This is to cause the conveyer 61 to reliably hold the liquid surface residual film F′ to the overflow tank 75. Therefore, the liquid surface residual films F′ do not pull the transfer film F at the transfer position, and flow at the portions of the overflow tanks 75 so as to curl around the terminal end pulley 62B of the conveyer 61. Then, the liquid surface residual films F′ are dropped into and collected in the overflow tanks 75.

In proximity to the edge of the dividing line FL, the liquid surface residual films F′ are moved closer to the both side walls 22 by the air blow and the flow of the liquid while the liquid surface residual films F′ are gradually dissolved little by little and separated as described above. Therefore, when the liquid surface residual films F′ are collected, it is preferable that the entire block portion at the dividing line FL and the foreign substances separated at the dividing line FL be collected at two stages separately. The configuration suitable for this is the blocking means 77 provided in a middle portion of the discharge port 76 of the overflow tank 75. In other words, due to the existence of the blocking means 77, the liquid surface residual film F′ is collected at two stages before and after the blocking means 77 even in the one overflow tank 75. More specifically, as illustrated in FIG. 9(a), the entire block at the dividing line FL is guided to the upstream side at the side before the blocking means 77 (the sheathing board 78 or the in-tank blocking body 79), and is collected by the first stage at the front side, whereas the separated foreign substances at the dividing line FL are collected by the second stage at the rear side with respect to the blocking means 77.

The blocking means 77 is provided to narrow the flow rate guide range of the discharge port 76, and therefore, the blocking means 77 also performs control to weaken the flow rate after the action of holding the film is cancelled.

The liquid surface residual films F′ thus divided by the air are reliably collected in the overflow tanks 75 without giving adverse effects on the transfer position (immersion area P1).

In this case, the blocking means 77 may be the sheathing board 78 and the in-tank blocking body 79 as illustrated in FIGS. 4 and 10. When the in-tank blocking body 79 is used, the in-tank blocking body 79 can be fixed by just dropping the in-tank blocking body 79 into the overflow tank 75, and the in-tank blocking body 79 is preferable in that the position setting with respect to the discharge port 76 and the adjustment of the collection ratio at the two stages before and after the blocking means 77 can be made easily by sliding the in-tank blocking body 79 to the front or the back.

It is to be understood that this kind of collection of the liquid surface residual film F′ is completed at the upstream side with respect to the liquid-leaving area P2.

### (5) Liquid-Leaving Area is Cleaned (at the Side of the Decoration-Unnecessary Surface)

In the present embodiment, along with such collection of the liquid surface residual film F′, the liquid-leaving area cleaning mechanism 8 is used to clean the liquid-leaving area P2. In particular, the side of the decoration-unnecessary surface S2 is cleaned. This will be hereinafter explained. The liquid-leaving area cleaning mechanism 8 is to move, away from the liquid-leaving area P2, the foreign substances in the transfer liquid and on the surface of the liquid and the bubbles A on the surface of the liquid in the liquid-leaving area P2, and discharge the foreign substances and the bubbles A to the outside of the tank. In order to do this, for example, as illustrated in FIG. 4, the overflow tanks 82 are provided at both of the right and left side walls 22 of the liquid-leaving area P2, and the side oppositely-separating flow flowing from the liquid-leaving area P2 to the overflow tanks 82 is formed. Therefore, mainly, the foreign substances in the liquid such as the film residues are prevented from coming closer to the liquid-leaving area P2, and the foreign substances are collected. Further, in the present embodiment, as illustrated in FIGS. 1, 2, and 4, the air blowing device 85 is provided above one of the side walls 22 of the transfer tank 2 (above the overflow tank 82), and the air is blown through the liquid-leaving area P2 to the overflow tank 82 at the opposite side. With this air blow, the bubbles A and the foreign substances generated on the surface of the liquid in the liquid-leaving area P2 (at the side of the decoration-unnecessary surface S2) are conveyed to and collected in the overflow tank 82. For this reason, it is preferable to form the flow rate increase brim 84 in the overflow tank 82 to increase the flow rate (introduction speed) near the liquid surface.

When the side oppositely-separating flow is formed, it is preferable to use some of new water.

### (6) Liquid-Leaving Area is Cleaned (at the Side of the Design Surface)

In addition, in the present invention, the design surface cleaning mechanism 9 is provided to clean the side of the design surface S1 in the liquid-leaving area P2. Therefore, when the object W is pulled up, the mechanism further cleans the design surface S1 of the object W that is coming out of the liquid, and moves, away from the design surface S1, the bubbles A on the surface of the liquid and the foreign substances in the transfer liquid and on the surface of the liquid that are generated by the drips dropped from the object W (jig J) pulled up previously, thus eliminating the bubbles A and the foreign substances from the liquid-leaving area P2. The mechanism will be hereinafter explained.

During getting out of the liquid, the object W is pulled up so as to block the transfer liquid L, and accordingly, a flow curling around into the design surface S1 facing the downstream side is naturally generated, and the design surface cleaning mechanism 9 resolves such curling flow as much as possible, and foreign substances and bubbles A do not approach the design surface S1. More specifically, as shown in FIGS. 1 and 2, the overflow tank 92 is provided in the liquid-leaving area P2, and this forms the design surface oppositely-separating flow made of new water to the object W (design surface S1) that is coming out of the liquid. Here, in the above-described overflow tank 92, it is preferable to form a flow rate increase brim 94 so as to increase a flow rate (introduction speed) near the liquid surface (see FIGS. 4 and 12).

When the object W (design surface S1) moves away from the overflow tank 92 for forming the design surface oppositely-separating flow as the object W gets out of the liquid, it is preferable to maintain the point at which the object W gets out of the liquid with respect to the overflow tank 92 to a predetermined point by gradually bringing the overflow tank 92 close to the object W.

By the way, when a manipulator is used as the object conveying device 5, in order not to generate the residual defect and the festering defect in the object W as much as possible, the pulling-up speed is set to a constant speed having an upper limit of 2 m/min, and it is preferable to pull up the object with a constant distance of 100 mm or less from the overflow tank 92 for forming the design surface oppositely-separating flow while the angle of the object W (design surface S1) is adjusted to 34 degrees with respect to the liquid surface all the time.

Here, foreign substances are removed from the transfer liquid L collected by the above-described overflow tanks 82 and 92 and the like, and the transfer liquid L is supplied for a recycled use (see FIG. 2).

In addition, in this embodiment, the two-stage OF structure in which the terminal end overflow tank (second-stage OF tank) 97 is disposed at the rear stage of the overflow tank (first-stage OF tank) 92 for forming the design surface oppositely-separating flow is employed, and, from this, the following advantages are acquired.

First, since the middle layer stream flowing near a middle position (near a height that is almost the same as that of the first-stage OF tank 92) of the transfer tank 2 becomes a flow slipping through the lower side of the first-stage OF tank 92, the middle layer stream becomes a downward flow right before the first-stage OF tank 92 and becomes an upward flow after passing through the first-stage OF tank 92. Then, in accordance with the downward flow right before the first-stage OF tank 92, the middle layer stream is prevented from being a flow curling around into the design surface S1 (the upper layer stream is prevented from being a flow curling around into the design surface S1 by the design surface oppositely-separating flow).

In addition, in accordance with the upward flow of the middle layer stream after passing through the first-stage OF tank 92, the lower layer stream is pulled up upward, and, in accordance with the upward flows of the middle layer stream and the lower layer stream, particularly, foreign substances, which are contained in the transfer liquid, staying much in the bottom portion of the middle layer stream can be efficiently collected by the second-stage OF tank 97. Accordingly, in this embodiment, the liquid-leaving area P2 and the transfer liquid L can be cleaned at a high level by the liquid surface residual film collecting mechanism 7, the liquid-leaving area cleaning mechanism 8, the design surface cleaning mechanism 9, and the like.

By the way, in the conventional liquid pressure transfer in which the top coating is applied after the liquid pressure transfer and the surface of the transfer pattern is protected, water-cleaning and the like is performed after the liquid pressure transfer, so that the water-soluble film attached to the object W (design surface S1) is removed, and thereafter, the top coating is applied. Therefore, the foreign substances such as film residues attached to the design surface S1 during the transfer do not immediately result in defectiveness. However, even in the conventional liquid pressure transfer as described above, maintaining a high level of cleaning in the liquid-leaving area P2 and a high degree of cleanness of the transfer liquid L is advantageous in that the precise liquid pressure transfer can be performed and is also preferable in the conventional liquid pressure transfer.

(7) Object is Removed from Liquid

The object W is pulled up from the liquid-leaving area P2 where a high degree of cleanness is achieved as described above, and therefore, the foreign substances and the bubbles A hardly attach to the design surface S1 (reduction of defective rate). On the other hand, the angle of exiting from the liquid when the object W is pulled out of the transfer liquid L can be changed as necessary.

### (8) Decorative Layer is Subjected to Curing Processing

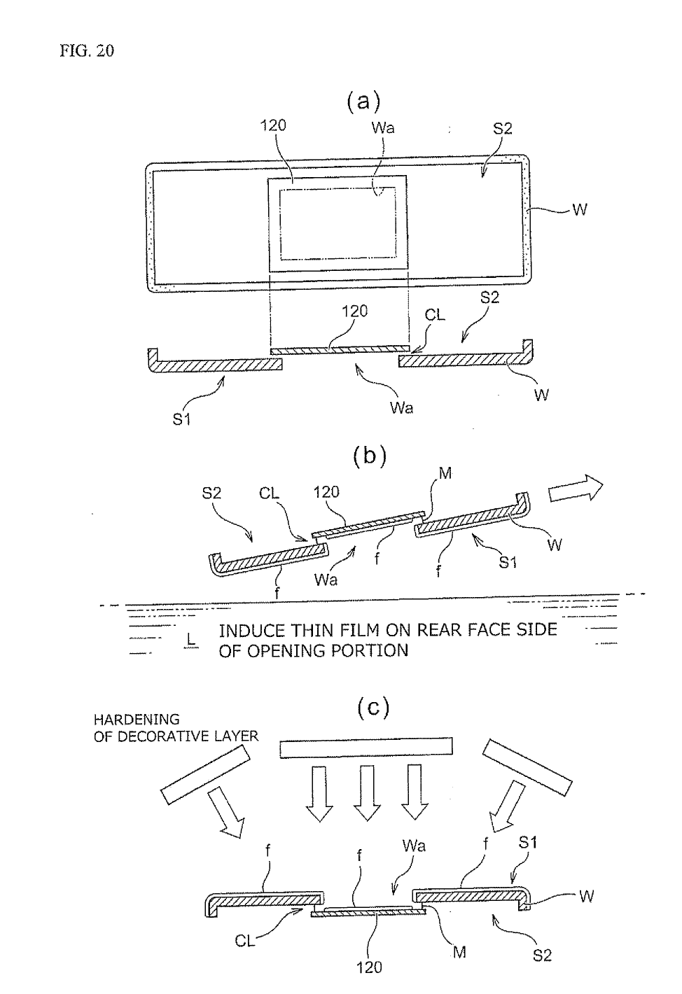

The object W pulled up from the transfer liquid L is thereafter subjected to the processing of curing the transfer pattern (decorative layer). In this case, active energy rays such as ultraviolet rays are emitted to the object W (see FIG. 20(c)), and at this occasion, half-dissolved PVA is still attached to the design surface S1 of the object W. Other than the above emission of the active energy ray, heating may be another method for curing the transfer pattern (decorative layer). Alternatively, both of the emission of the active energy ray and the heating may be performed to cure the transfer pattern (decorative layer). By the way, a recitation, “emission of an active energy ray and/or heating”, in the claims means performing one of or both of these curing processing.

Thereafter, the PVA is removed from the object W (detachment of the film) with water-cleaning and the like, and the object W is dried. At this point, the series of operation is completed. It should be noted that, in the present embodiment, the transfer pattern (decorative layer) is already cured, and therefore, it is not necessary to apply the top coating after the drying, but it may also be possible to thereafter perform the top coating in addition.

(9) Transfer when Object has Opening Portion in Design Surface

Subsequently, a preferred aspect of transfer where the object W has an opening portion Wa in the design surface S1 will be explained. For example, as illustrated in FIG. 20(a), such object W is preferably subjected to the transfer process (the object W is put into the transfer liquid L) with a thin film derivative 120 arranged with an appropriate clearance CL at the back side of the opening portion Wa (decoration-unnecessary surface S2). This is because a thin film M may be originally formed on the design surface S1 on the front side, but with the thin film derivative 120, the thin film M is formed between the opening portion Wa and the thin film derivative 120 (clearance CL) as illustrated in FIG. 20(b).

In this case, the reason (details) why the thin film M, which is originally formed at the side of the design surface S1 in an ordinary case, can be formed in the clearance CL by using the thin film derivative 120 will be explained. The thin film M is generally similar to soap bubble, and therefore, this has a property of forming a film in such a manner as to decrease the size of area (surface area) of the film (Fermat's principle). Therefore, when the thin film derivative 120 is provided such that the size of area of all periphery of the clearance CL (this will be referred to as separation all peripheral area size) is less than the size of area of the opening portion Wa (opening portion size), the thin film M can be guided to the side of the clearance CL (the side of the decoration-unnecessary surface S2).

Therefore, for example, as also illustrated in FIG. 20(a), the thin film derivative 120 is formed to be in substantially the same size as the opening portion Wa or formed to be in a size slightly larger than the opening portion Wa when the opening portion Wa is seen from the front. This is a configuration for reliably forming the clearance CL in the entire periphery of the opening portion Wa.

When the thin film derivative 120 is located at the back side of the opening portion Wa, the thin film derivative 120 may be attached to the jig J, or the thin film derivative 120 may be directly attached to the object W using the back surface of the object W (assembling structure as assembly).

By the way, for example, as illustrated in FIG. 20(c), the thin film derivative 120 is preferably located at the side of the decoration-unnecessary surface S2 until the curing processing of the decorative layer is completed. No problem would be caused even if the thin film M breaks when the object W gets out of the liquid or when the object W is subjected to the curing processing, and this is because the thin film M is formed at the side of the decoration-unnecessary surface S2 of the object W, and it is less likely to generate the bubbles A with broken residuals even at the side of the design surface S1 if the thin film M breaks.

For example, when the robot transfer is performed or when the object W is pulled up from the liquid in the overhang state even if the conveyer 51 is applied, the object W can be pulled up in the reversed state in which the design surface S1 face the upper side, and therefore, even if the object W has the opening portion Wa in the design surface S1, the liquid pressure transfer can be performed without using such thin film derivative 120 (it is considered that the bubbles A are less like to attach to the design surface S1). This is because while the object W is pulled up in the reversed state, the liquid attached to the object W (design surface S1) naturally flows to the back side corresponding to the lower side due to the gravity, and even if the bubbles A are generated with the broken residuals, it is considered that the bubbles A also move around to the side of decoration-unnecessary surface S2 according to the above flow.

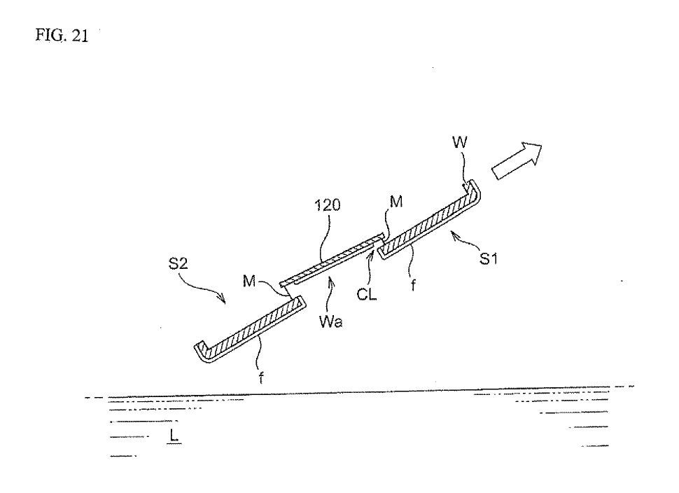

Further, the above clearance CL may not be necessarily formed constantly on the entire periphery of the opening portion Wa. For example, as illustrated in FIG. 21, the above clearance CL can be gradually decreased (in this case, the thin film derivative 120 is installed such that the clearance CL gradually widens toward the lower side of the object W getting out of the liquid). In this case, escaping air can be easily guided between the object W and the thin film derivative 120 when the object W is put into the liquid for the transfer process, and the precise liquid pressure transfer can be performed, and the liquid can be expected to be discharged and dried quickly after the object W gets out of the liquid.

### Another Embodiment 1

In the present invention, the above-described embodiment is one basic technical idea, and the following modifications may be further considered.

First, in the above-described embodiment, while the liquid-leaving area P2 is cleaned by efficiently collecting foreign substances contained in the transfer liquid L by mainly employing the two-stage OF structure, in cleaning the liquid-leaving area P2 (cleaning the transfer liquid L), not only the two-stage OF structure but also a form as below (referred to as “Another Embodiment 1”) may be employed.

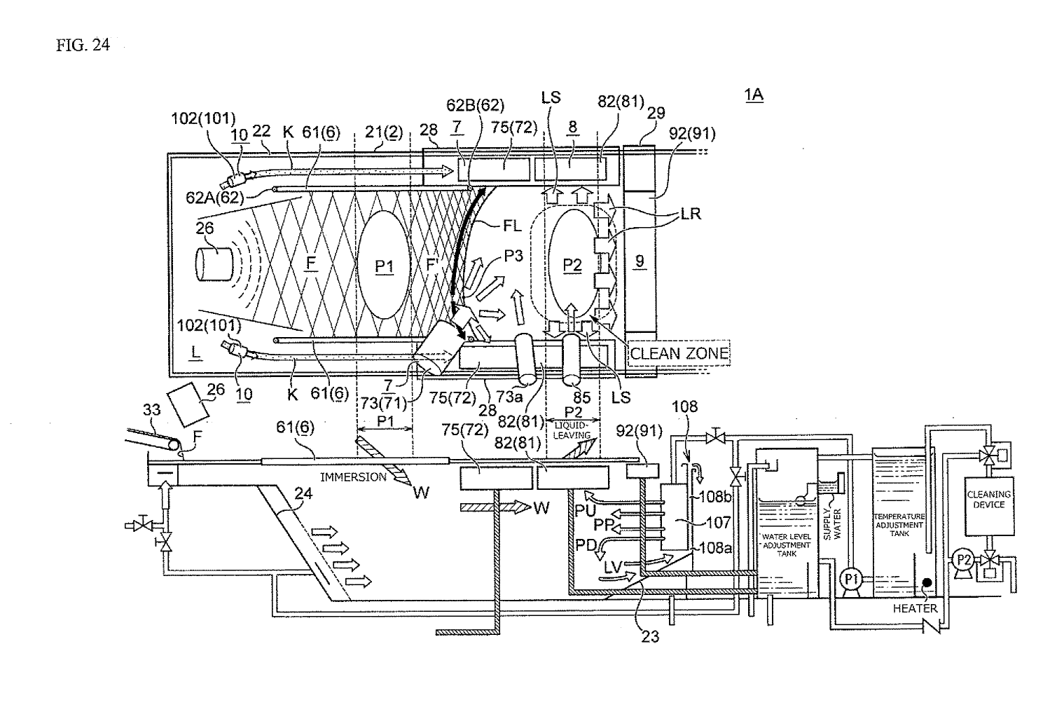

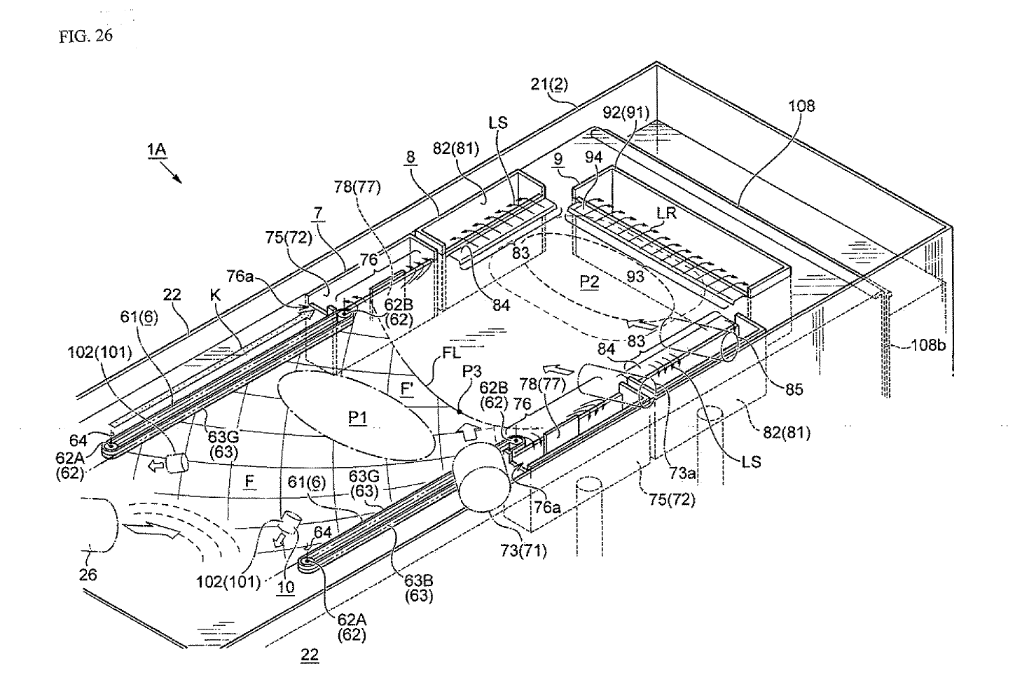

In other words, in this embodiment (Another Embodiment 1), as an example, as illustrated in FIGS. 24 to 26, a new water supply port 107 is provided on the lower side of the overflow tank 92 for forming a design surface oppositely-separating flow, and new water is supplied upward therefrom toward the liquid-leaving area P2 (reference sign “PU” is assigned to the new water in Another Embodiment 1), and, by using this, a design surface oppositely-separating flow LR is generated. It is to be understood that the new water PU supplied upward toward the liquid-leaving area P2 is not only used for generating and forming the design surface oppositely-separating flow LR but also used for generating and forming a side oppositely-separating flow LS of the above-described liquid-leaving area cleaning mechanism 8. In Another Embodiment 1 described here, reference signs “LR” and “LS” are assigned to the design surface oppositely-separating flow and the side oppositely-separating flow respectively. In addition, reference sign “1A” represented in the figure is a reference sign assigned particularly to a liquid pressure transfer device according to Another Embodiment 1.

In addition, there is also new water PD supplied downward from the new water supply port 107 toward the liquid-leaving area P2, and this is used for easily forming a sucking flow LV using a siphon-type discharge unit 108 to be described later.

Furthermore, there is also new water PP supplied from the new water supply port 107 in approximately parallel (horizontal) with the liquid-leaving area P2 (a flow toward the upstream side of the transfer tank 2 in FIG. 24). This is discharged (supplied) at a speed lower than those of the new water PU and the new water PD from a position that is located near the middle layer between the new water PU and the new water PD. Here, the “(near) middle layer” is a middle layer when the transfer liquid L inside the transfer tank 2 is classified into three kinds of upper layer (near the liquid surface)/middle layer/lower layer (near the bottom) depending on the depth (height) in the liquid and may easily contain film residues.

The siphon-type discharge unit 108 is provided on the rear-face side of this new water supply port 107, pumps up (collects) the transfer liquid L (mainly, middle layer water) containing foreign substances such as film residuals from the lower side of the transfer tank 2 (processing tank 21), and discharges the transfer liquid to the outside of the tank. In other words, in the siphon-type discharge unit 108 according to this embodiment (Another Embodiment 1), a sucking port 108a at the lower side is provided at a position lower than that of the new water supply port 107, and the conveying path formed in the middle thereof is formed to be extremely narrow (for example, an interval corresponding to a flow path cross-section of about 10 mm) such that the transfer liquid L taken in from the sucking port is pumped up to the liquid surface, and this path is configured as a siphon path 108b. In addition, the flow in the transfer liquid L sucked by the siphon-type discharge unit 108 is formed as the sucking flow LV, and this sucking flow LV is formed by using the new water PD supplied downward from the new water supply port 107 toward the liquid-leaving area P2 (it is effectively formed by using the new water PD).

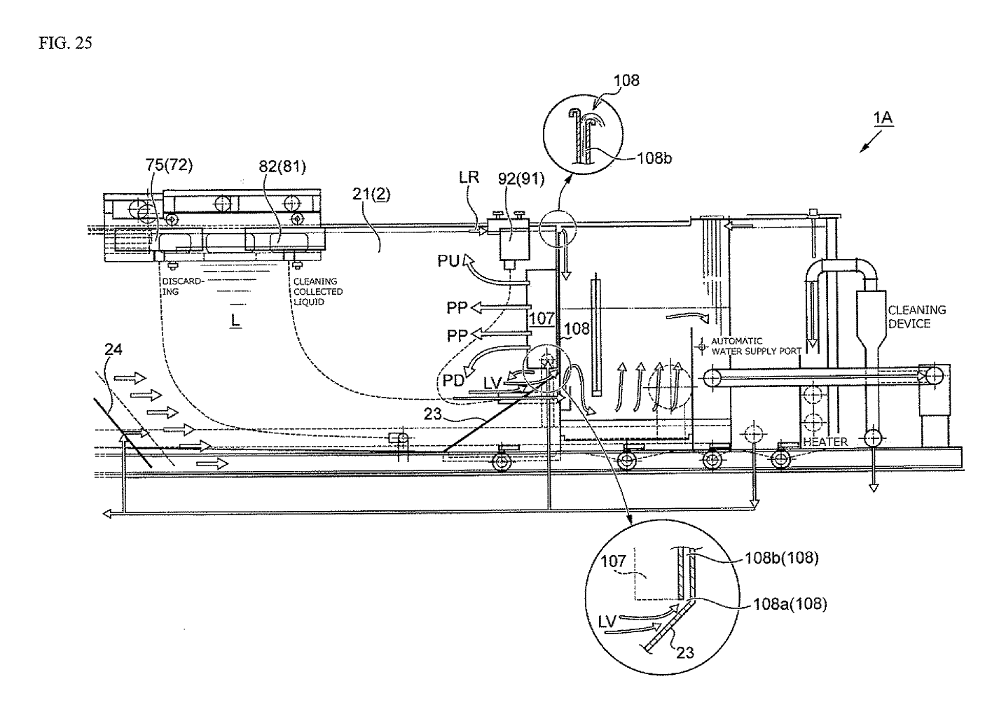

In addition, in order to form the sucking flow LV from the new water PD more easily (in order to form the sucking flow LV from the new water PD more efficiently), as illustrated in FIGS. 24 and 25, it is preferable to provide a taper-shaped inclined plate 23 at the bottom (the lower side of the new water supply port 107) of the end portion of the processing tank 21 and form the sucking port 108a of the siphon-type discharge unit 108 to face the uppermost end portion of the inclined plate 23. In other words, it is preferable to form the transfer tank 2 (processing tank 21) such that the depth of the tank gradually decreases toward the terminal end portion of the tank (the bottom of the tank is formed to gradually rise) by using the inclined plate 23 and to provide the sucking port 108a of the siphon-type discharge unit 108 so as to face the uppermost end portion of this inclined plate 23. From this, the flow of the transfer liquid L rising in accordance with the inclination of the inclined plate 23 is efficiently taken into the sucking port 108a with the power thereof being maintained.

In addition, the purpose of the formation of the sucking flow LV using the siphon-type discharge unit 108 (or the inclined plate 23 in addition thereto) is for not allowing foreign substances to rise to the liquid-leaving area P2 disposed on the upper side by conveying (allowing to flow) the foreign substances such as film residuals staying in the transfer liquid L (particularly, middle layer water) toward the lower side (bottom) and then pumping up (collecting) the foreign substances therefrom. Accordingly, even when the transfer liquid L is not completely pumped up by the siphon-type discharge unit 108, the new water Pb becomes the sucking flow LV so as to form a flow (downward flow) toward the sucking port 108a, and accordingly, the flow promoting sedimentation and separation toward the lower side in the bottom of the transfer tank 2 can be formed.

In addition, the new water PP supplied from the new water supply port 107 in approximately parallel to the liquid-leaving area P2 prevents the actions of the new water PU and PD from inhibiting each other and promotes the actions of the new water PU and PD. More specifically, the new water PP gets into the sucking flow LV formed from the new water PD and promotes the action of discharging middle layer water containing foreign substances and promotes the new water PU to become the design surface oppositely-separating flow LR and the side oppositely-separating flow LS so as to be guided to the overflow tanks 82 and 92, thereby contributing to an increase in the clean zone.

Next, a technique for cleaning the transfer liquid L collected by the overflow tank 82 for forming the side oppositely-separating flow, the overflow tank 92 for forming the design surface oppositely-separating flow, and the siphon-type discharge unit 108 will be described. The transfer liquid L collected by these, for example, as illustrated in FIG. 24, is sent to the cleaning device through the water level adjustment tank, and, after foreign substances are removed therefrom, the transfer liquid is reused as new water (purified water) through the temperature adjustment tank. It is to be understood that the foreign substances acquired by the cleaning device are wasted.

In addition, to a portion in the middle of a pipeline that sends the transfer liquid L (containing the foreign substances) collected by the overflow tank 82 to the water level adjustment tank or the bottom of the water level adjustment tank, a disposal pipe discharging foreign substances (sludge) collected therein is connected. In addition, generally, since the mix ratio of foreign substances is high as described above, the overflow tank 75 as the liquid surface residual film collecting mechanism 7 is disposed as it is.

Furthermore, in order to remove the foreign substances from the transfer liquid by using the water level adjustment tank, the cleaning device (sedimentation tank), or the like, the cleaning is achieved by storing liquid disposed inside the adjustment tank or the sedimentation tank so as to dam the liquid up once using a board (sheathing board) or the like and sending the relatively clear top of the stored water to the rear stage.

In addition, the new water cleaned as described above, for example, as illustrated in FIG. 24, is supplied from lower side of the guide conveyer 33 provided on the film supply side (upstream side) or the inclined part 24 of the portion of the middle stream area of the transfer tank 2 or, for example, is supplied upward and downward from the new water supply port 107 (the lower side of the overflow tank 92 for forming the design surface oppositely-separating flow) toward the liquid-leaving area P2 and is supplied to be parallel (horizontal). Here, “the new water PU supplied upward toward the liquid-leaving area P2”, as described above, is new water for forming the design surface oppositely-separating flow LR or the side oppositely-separating flow LS, and the “new water PD supplied downward toward the liquid-leaving area P2” is new water for forming the sucking flow LV according to the siphon-type discharge unit 108.

In addition, it is preferable to uniformly discharge supplied new water from a relatively large range to the discharge port at the time of supplying the new water to the transfer tank 2, more specifically, to the inclined part 24 of the portion of the middle stream area of the transfer tank or the new water supply port 107 by providing a punching metal or the like (prevention of partial straight advancement of the new water).

### Another Embodiment 2

In the basic embodiment described above, although the form has been mainly illustrated in which, after the transfer film F is coated with the activating agent, and this is supplied to the transfer tank 2 (see FIG. 1), as described above, the transfer film F may be activated in the state of being supplied to the transfer tank 2 and coming into contact with the liquid, and, in such a case, there is a preferred activation form that is appropriate therewith, and, hereinafter, it will be described (this will be referred to as “Another Embodiment 2”). In other words, Another Embodiment 2 has a form in which an activating agent applying device (the device to which reference numeral “4” is assigned in the basic embodiment) activates the transfer film F supplied to the surface of the transfer liquid L in the transfer tank, and particularly, reference numeral of “activating agent applying device 40” is assigned to the device so as to be discriminated from that of the basic embodiment. In addition, in relation with this, reference sign “1B” is assigned to a liquid pressure transfer device according to Another Embodiment 2.

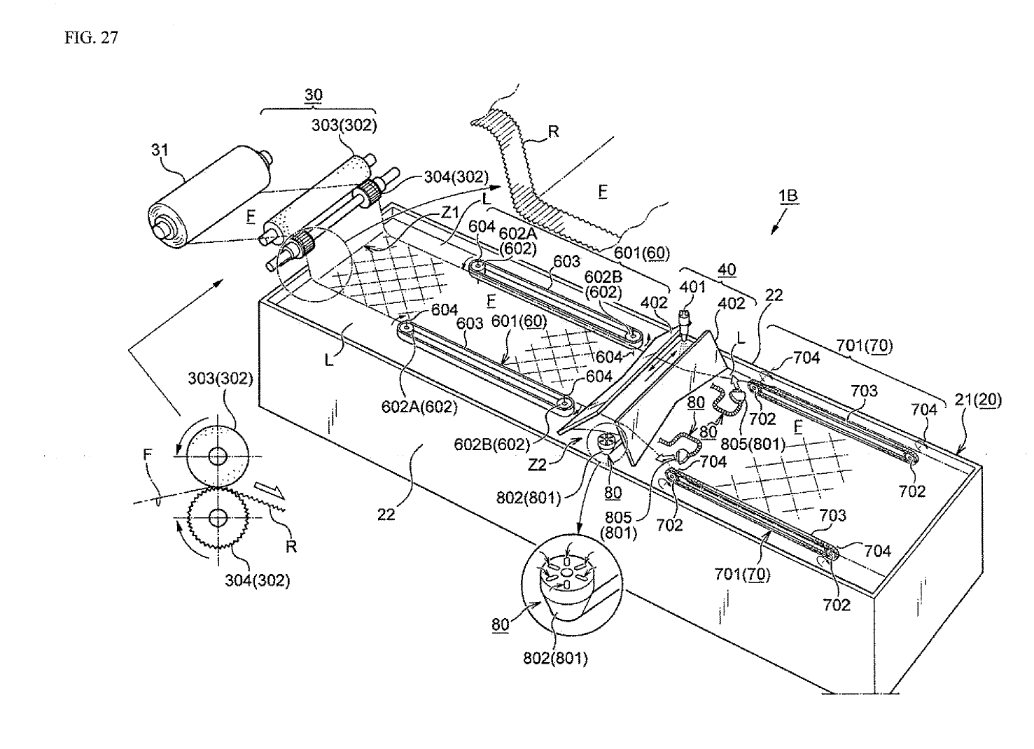

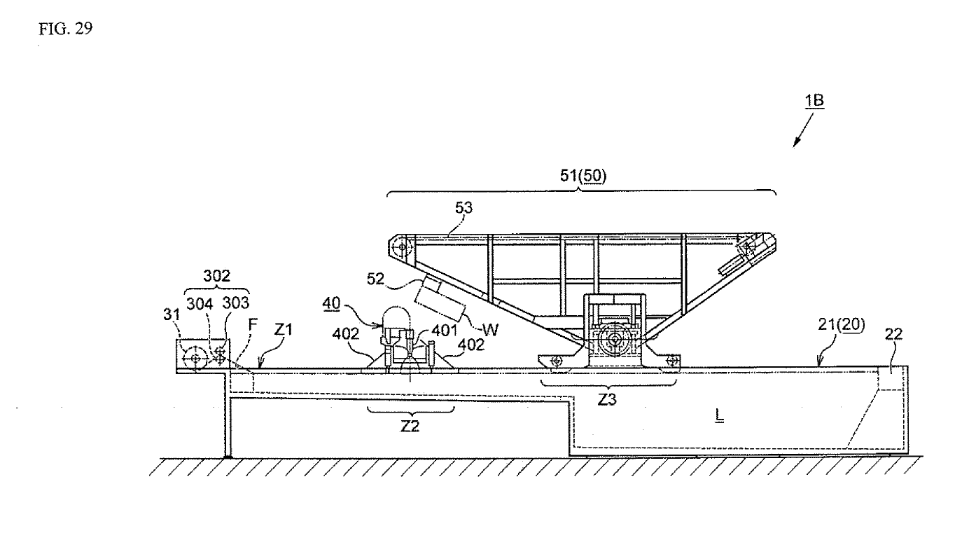

The liquid pressure transfer device 1B, for example, as illustrated in FIGS. 27 to 29, is formed by including a transfer tank 20 storing the transfer liquid L, a transfer film supply device 30 supplying the transfer film F to the transfer tank 20, the activating agent applying device 40 activating the transfer film F supplied to the transfer tank 20 on the liquid surface to be in a transferable state, and an object conveying device 50 that inputs (immerses) an object W with an appropriate posture from the upper side of the transfer film F supported to float in the transfer tank 20 and gets (pulls up) the object out of the liquid.

In addition, the transfer tank 20 is formed by including an pre-activation guide mechanism 60 that holds both sides of the transfer film F coming into contact with the liquid and conveys the transfer film to an activation area Z2, a post-activation guide mechanism 70 that holds both sides of the transfer film F after being coated with the activating agent and conveys the transfer film to a transfer area z3, and an elongation and extension reduction prevention mechanism 80 for preventing reduction of elongation and extension of the transfer film F by removing an activating agent component disposed on the surface of the transfer liquid.

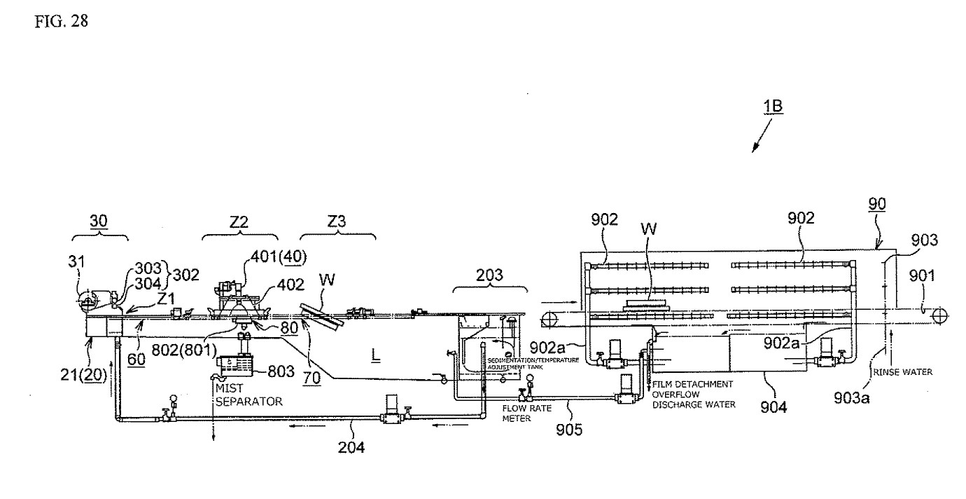

In addition, in the embodiment illustrated in FIG. 28, a film detaching and cleaning device 90 is further included in the rear stage of the transfer tank 20. This is responsible for a process of dissolving and cleaning a half-dissolved water-soluble film adhering to the surface of the object W at the time of performing a transfer.

In addition, in Another Embodiment 2, a point (area) at which the transfer film F comes into contact with the transfer liquid L disposed inside the transfer tank 20 is referred to as a liquid contact point Z1, an area that is applied with the activating agent is referred to as an activation area Z2, and an area in which a transfer is performed is referred to as a transfer area Z3. In addition, since a transfer is almost completed simultaneously with the immersion of the object W, the transfer area Z3 may be also referred to as an immersion area and corresponds to the “immersion area P1” according to the basic embodiment. Here, while terms referred to as an “activating agent” and an “activating agent component” are used, mainly, the “activating agent component” refers to the name of an activating agent, with which the transfer film F or the surface of the transfer liquid has been coated, floating and staying on the surface of the transfer liquid so as to reduce the elongation and extension of the transfer film F. Hereinafter, each constituent unit will be explained.

First, before description of the transfer tank 20, a transfer film supply device 30 will be described. The transfer film supply device 30, for example, as illustrated in FIG. 27, is formed by including a film roll 31 that is formed by a roll-wound transfer film F (the same reference sign is assigned to the same member as that of the basic embodiment) and a projection and depression molding roller 302 that forms projections and depressions having a stripe pattern in both side portions of the film in the widthwise direction of the film when guiding the transfer film F pulled therefrom to the transfer tank 20. Here, the formation of the projections and depressions having a stripe pattern in both side portions of the transfer film F is for preventing curls that may be generated on both sides of the film due to absorption of water in the water-soluble film after the transfer film F comes into contact with the liquid, and these projections and depressions are referred to as curl-prevention projections and depressions R (see FIG. 23 for the curls). In other words, when being supplied to the transfer tank 20, the transfer film F is supplied (guided) to the surface of the transfer liquid in a state in which the curl-prevention projections and depressions R are formed with an approximately constant width dimension in both side portions.

In addition, for example, as illustrated together in FIG. 27, the projection and depression molding roller 302 is configured by a combination of a rubber smoothing roller 303 and a serration roller 304, which are installed in a circumscribed state, and thus, the curl-prevention projections and depressions R are formed as creases or stripes (strings) folded in the widthwise direction of the film.

Furthermore, in order to easily form the curl-prevention projections and depressions R on the transfer film F, the transfer film F may be heated in advance, and, for example, as one method therefor, there is a technique of building a heater in the serration roller 304.

Hereinafter, how (reason) the curl-prevention projections and depressions R prevent the curl phenomenon will be described. The curl-prevention projections and depressions R are bent lines (stripes) formed along the widthwise direction of the film, a film in which such stripes are simply formed are difficult to turn in the widthwise direction (the stripes has resilience or strength opposing bending). The reason is not only that the bent lines (stripes) formed along the widthwise direction have strength resisting a curl, but it is also considered to be significant that the curl-prevention projections and depressions R have certain degree of height differences in the vertical direction. In other words, for the curl-prevention projections and depressions R (stripes) having height differences, until all the projections and depressions come into contact with the liquid after they start to come into contact with the liquid from a portion disposed on the lower side, a time of some degree is required. In other words, there is a time difference between when the lowermost portion of the projections and the depressions starts to be immersed into the transfer liquid L and when the uppermost portion of the projections and the depressions is immersed, and an upper portion of the projections and depressions that has not come into contact with the liquid has strength resisting a curl in accordance with the time difference, and this is considered to serve for the prevention of a curl after the contact of the transfer film F with the liquid.

In addition, accordingly, in order to maintain the resilience, the curl-prevention projections and depressions R may be creases, and a slit shape in which the individual projections and depressions are completely cut out is not considered as being preferable. Furthermore, the combination of the rubber smoothing roller 303 and the serration roller 304 is a preferable configuration in this point (the point that individual projections and depressions are not completely cut out).

Furthermore, in a case where it is difficult to form curl-prevention projections and depressions R as described above on the film while the supply of the transfer film F is performed, in other words, while the transfer film F runs out or the like, as described above, first, after both side portions of the film are heated at the time of causing the transfer film to run out (after the film is formed to be easily deformed), the curl-prevention projections and depressions R can be formed by the projection and depression molding roller 302.

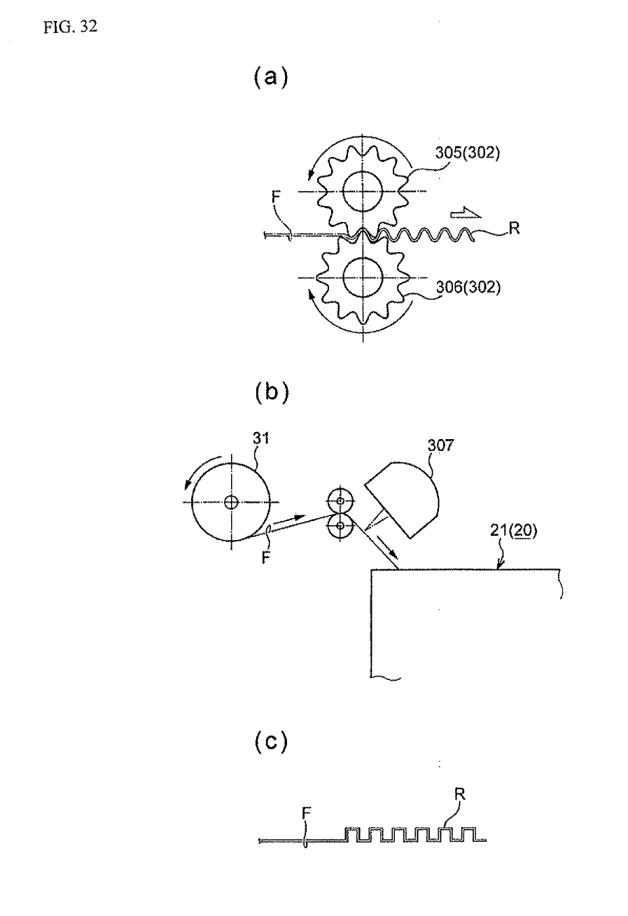

In addition, since resilience capable of resisting a curl may be included, the curl-prevention projections and depressions R do not need to be completely-bent lines (zigzag lines) when the film is seen from the side face and, for example, may have a wave shape (waveform) as illustrated in FIG. 32(a). In such a case, generally, the projection and depression molding roller 302, as illustrated together in FIG. 32(a), are configured by one pair of gears 305 and 306 having waveforms engaged with each other.

In addition, a means for forming the curl-prevention projections and depressions R is not necessarily limited to a contact-type projection and depression molding roller 302, and, for example, a non-contact type laser marker 307 as illustrated in FIG. 32(b) may be applied. In such a case, curl-prevention projections and depressions R that are more microscopic than those of the projection and depression molding roller 302 can be formed. It is to be understood that one laser marker 307 is provided on each one of both left and right sides of the transfer film F.

Furthermore, the curl-prevention projections and depressions R, for example, may be formed as projections and depressions having an angled zigzag shape (keyboard shape) as illustrated in FIG. 32(c) other than the bent line shape (zigzag shape) and the wave shape (waveform) when seen from the side face.

In addition, since the curl-prevention projections and depressions R may have resilience (strength) for a curl winding in the widthwise direction, the curl-prevention projections and depressions R do not necessarily need to be formed along the widthwise direction of the film but may be formed to be inclined with respect to the widthwise direction of the film.

In addition, in supplying the transfer film F to the transfer tank 20, in order to cause the transfer film F to reliably come into contact with the liquid and to maintain and stabilize the liquid contact point Z1 at a predetermined position, it is preferable to blow air (air over the widthwise direction) pressing the transfer film F to the side of the liquid surface at the liquid contact point Z1. In addition, in order to guide the transfer film F from the projection and depression molding roller 302 to the transfer tank 20 in a stable manner, it is preferable to provide an inclined guide such as a sliding board, and this does not necessarily need to be continuous in the widthwise direction of the film (the inclined guide may be partially provided in a non-continuous strip shape in the widthwise direction).

Next, the activating agent applying device 40 will be described. The activating agent applying device 40 activates the transfer film F in a transferable state, and, in this embodiment (Another Embodiment 2), as described above, there is a distinctive feature in which the activating agent is applied in a state where the transfer film F is guided (supplied) to the surface of the transfer liquid, in other words, a state where the transfer film F floats on the liquid surface.

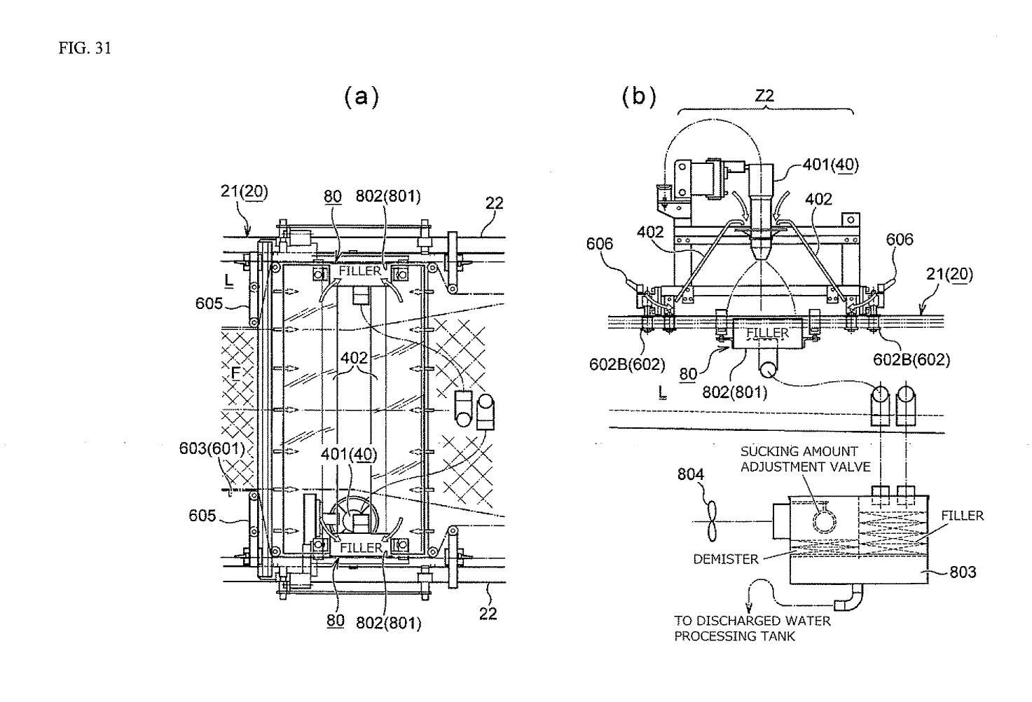

As a technique for applying the activating agent, for example, a technique utilizing electrostatic spray disclosed in U.S. Pat. No. 3,845,078 that has been issued to the applicants of this application may be applied. This technique, for example, as illustrated in FIG. 27, is a coating technique spraying an activating agent from a spray gun (spray nozzle) 401 for a transfer film F (transfer pattern) formed on the surface of the transfer liquid, and the spray gun 401 sprays the activating agent for the transfer film F conveyed on the surface of the transfer liquid while reciprocating so as to traverse this transfer film F (so called traverse). At that time, the activating agent is electrically charged at an exhaust nozzle of the spray gun 401, and the transfer film F floating on the surface of the transfer liquid is grounded through the transfer liquid L and a transfer tank 20, whereby the transfer film F is uniformly coated with the activating agent. In addition, since the spray gun 401 radially spays the activating agent for a predetermined range, the traversing orbit in which the spray gun 401 reciprocates corresponds to almost the center of the activation area Z2 (see FIG. 31(b)).

In addition, the spray gun 401 reciprocates with a stroke larger than the dimension of the width of the transfer film F and is configured to spray the activating agent over the dimension of the width of the transfer film F. The reason for this is that the transfer film F is uniformly elongated and extended such that a portion for which the activating agent is not sprayed is not present in the transfer film F. Accordingly, on the outer side of the transfer film F, a redundant or unnecessary activating agent (an activating agent that is not used for the original purpose of activating the ink of the transfer film F) is necessarily sprayed (floats) on the surface of the transfer liquid.

Thus, according to this technique, the front and rear sides and both side portions of the spray gun (exhaust nozzle) 401 reciprocating are covered with a hood 402, and particularly, a redundant/unnecessary activating agent is prevented from being sprayed to the outside of the activation area Z2, whereby the operation environment is not degraded. Since the hood 402 is disposed with a clearance from the transfer film F disposed on the liquid surface more or less, it is preferable that the activating agent does not leak from the clearance as possibly as can. In addition, a redundant/unnecessary activating agent component disposed on the surface of the liquid is drained (collected) by an elongation and extension reduction prevention mechanism 80 (a catch basin 802 to be described later, a small submersible pump or the like) together with the transfer liquid L, and a redundant/unnecessary activating agent that floats and is scattering inside the hood 402 is simultaneously sucked in accordance with an air flow generated inside the hood 402 by the drain and is mixed with the transfer liquid L to be discharged. In addition, the collected transfer liquid L is processed to be mixed with air containing the unnecessary activating agent component and then is wasted.

In addition, the activation area Z2, usually, is set to a position located farther than the liquid contact point Z1 at which the transfer film F comes into contact with water (liquid) more or less. The reason for this is for softening the water-soluble film of the lower side of the film by containing water therein between them (between the liquid contact and the activation), so that the whole film can be uniformly elongated and extended without any distortion at the time of activation performed thereafter (this may be referred to as a stage for preparing elongation and extension). In other words, ink, which is in a dried state, disposed on the upper side of the film has the elongation and extension suppression state being cancelled at once in accordance with the application of the activating agent and is elongated and extended uniformly to the left and right sides without any distortion in the widthwise direction that is secured as an escape route of stress, and the interval from the liquid contact to the activation may be regarded as a swelling interval (softening interval) for causing the water-soluble film on the lower side of the film to follow the elongation and extension.

As the activating agent, any may be used which can return the dried state of ink on the transfer film F (transfer pattern) to a wet state that is equal to the state right after printing so as to form a transferable state, for example, a material composed by mixing a pigment, a solvent, a plasticizer, or the like into a pitch at an appropriate ratio may be applied, and only a solvent such as a thinner that can give plasticity to the ink may be used.

Next, the transfer tank 20 will be described, the basic structure having the processing tank 21 and the side walls 22 is the same as that of the basic embodiment described above, and thus, description thereof will not presented here. Here (in Another Embodiment 2), the same reference numerals are assigned to the same members as those of the basic embodiment such as the processing tank 21 and the side walls 22.

When a liquid pressure transfer is continuously performed (so-called continuous processing), generally, a liquid flow for sending the transfer liquid L from the liquid contact point Z1 (upstream side) to the transfer area Z3 (downstream side) is formed in a liquid surface portion of the processing tank 21. More specifically, for example, as illustrated in FIG. 28, an overflow unit 203 is formed in a downstream end portion of the transfer tank 20, and, by mainly supplying the transfer liquid L collected therein from the upstream portion of the transfer tank 20 through a circulating pipe path 204 in a cyclic manner, the above-described liquid flow is formed near the liquid surface of the transfer liquid L. It is to be understood that cleaning facilities such as a sedimentation tank, filtering, and the like are disposed in the overflow unit 203 or the circulating pipe path 204, and foreign substances such as redundant films and film residuals dispersing and staying in the transfer liquid L can be removed from the collected liquid (suspension), and the collected liquid can be reused. In addition, in the reuse, as illustrated together in FIG. 28 described above, it is preferable that, after a solid content such as ink is precipitated from the suspension collected by the overflow unit 203, the water temperature thereof is adjusted by temperature adjustment devices such as a temperature sensor and a heater, and then, a resultant liquid is provided for the reuse (sent to the upstream side of the transfer tank 20).

In addition, the transfer tank 20 is formed such that, after the activation area Z2, particularly, the transfer area Z3 is deepened.

In the transfer tank 20, as described above, the pre-activation guide mechanism 60 guiding the transfer film F supplied to the transfer tank 20 up to the activation area Z2, the post-activation guide mechanism 70 guiding the transfer film F after the application of the activating agent up to the transfer area Z3, and the elongation and extension reduction prevention mechanism 80 for promoting of elongation and extension of the transfer film F by removing an activating agent component disposed on the surface of the transfer liquid are disposed, and hereinafter, these will be described.

First, the pre-activation guide mechanism 60 will be described. The pre-activation guide mechanism 60 is disposed on the inner side of the both side walls 22 of the transfer tank 20 in the front stage of the activation area Z2 and guides a transfer film F supplied to the center of the liquid surface of the transfer tank 20 up to the activation area Z2 while holding both sides of the film at horizontally equivalent positions (positions equivalent from the both side walls 22).

The pre-activation guide mechanism 60, as illustrated in FIG. 27 as an example, is configured by a conveyer 601 formed by winding an endless belt 603 around pulleys 602. Here, as the pulleys 602, there are pulleys that are directly driven by a motor or the like and pulleys to which rotation is delivered through the belt 603. When these are desired to be discriminated from each other, the former is referred to as a driving pulley 602A, and the latter is referred to as a driven pulley 602B. In the embodiment illustrated in FIG. 27, the rotation shaft 604 of the pulley 602 is set to an almost vertical direction, and the widthwise direction of the belt 603 is formed to be the depth (height) direction of the surface of the transfer liquid. The reason for this is that, even when the level of the liquid inside the transfer tank 20 changes, it can be responded by the dimension of the width of the belt 603, and accordingly, the height of the whole conveyer 601 does not need to be changed.

By the pre-activation guide mechanism 60 (conveyer 601), the transfer film F supplied to liquid surface at the center of transfer tank 20 is conveyed to the activation area Z2 in the state in which both sides disposed at the horizontally equivalent positions are regulated, and accordingly, a deviation, position mismatch, meandering, or the like does not occur in the transfer film F that is in the process of conveyance. In other words, the pre-activation guide mechanism 60 may be regarded as prevention of positional mismatch of the transfer film F before activation in the width direction or center alignment.

In addition, the holding of both sides of the transfer film F using the pre-activation guide mechanism 60 may be regarded also as the regulation of the widthwise direction, and in such a case, it may be considered that the pre-activation guide mechanism 60 promotes swelling and enlargement of the water-soluble film of the lower side of the film in the thickness direction and, as a result, limits (regulates) the swelling and enlargement in the widthwise direction of the film. Even when the transfer film F comes in contact with the liquid, ink disposed on the upper side of the film is maintained to be hard, and accordingly, the widthwise swelling is regulated using the ink. However, it is considered that the pre-activation guide mechanism 60 is also responsible for the action of regulating widthwise swelling or strengthens such an action. In addition, the swelling (promoting) of the transfer film F before activation in the thickness direction is, as described above, for elongating and extending the transfer film F in the widthwise direction to be horizontally equivalent without any distortion in the activation stage. As above, although the pre-activation guide mechanism 60, originally, is responsible for the action of position matching, it may be regarded to supply the transfer film F to the activation area Z2 while promoting swelling in the thickness direction and suppressing elongation and extension in the widthwise direction for the transfer film F until a time point right before activation.

The holding of both sides of the transfer film F using the pre-activation guide mechanism 60 is cancelled (released) right before the activation area Z2. In other words, both sides of the transfer film F coated with the activating agent are in a free state, and the reason for this is that the elongation and extension according to the application of the activating agent is not inhibited by the pre-activation guide mechanism 60. The transfer film F is sent from the liquid contact point Z1 to the activation area Z2 (and further up to the transfer area Z3) in a connected state, and, even when the holding of both sides is cancelled from right before the activation area Z2, the guide action according to the pre-activation guide mechanism 60 is applied to a portion disposed on the upstream side, and, in the film as a whole, a position matching function acts also in the activation area Z2.

In addition, since the transfer film F arrives at the activation area Z2 right after being released from the pre-activation guide mechanism 60, the transfer film is released from the pre-activation guide mechanism 60 even in a state in which the activating agent is not applied and start to elongate and extend more or less (the degree of elongation and extension is naturally lower than that according to the application of the activating agent).

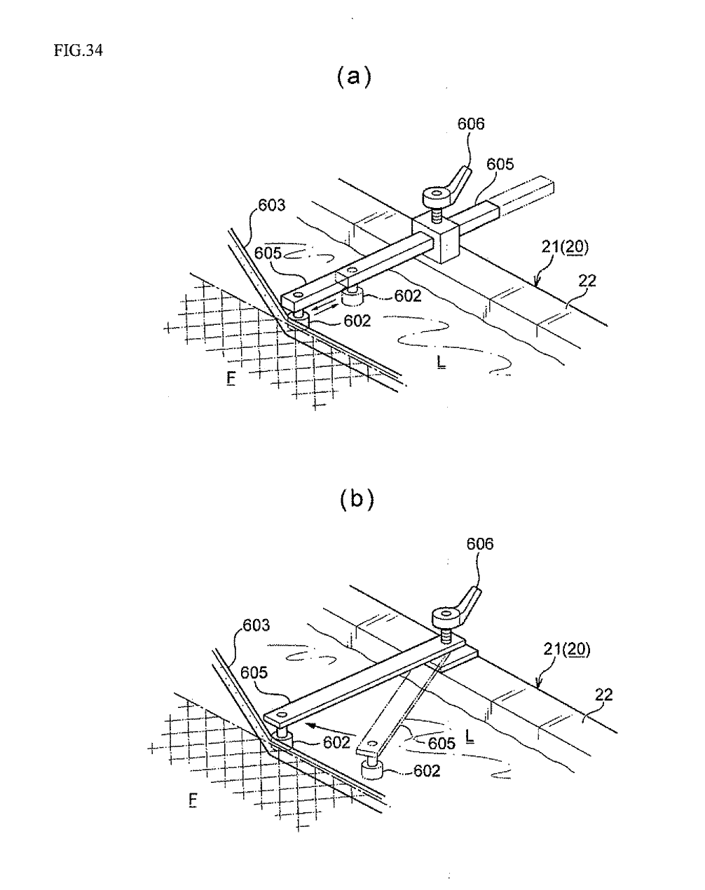

In addition, in order to respond to transfer films F having various mutually-different widths, it is preferable that such a pre-activation guide mechanism 60 (conveyer 601) has a configuration in which a gap between the left and right belts 603 is freely adjustable, and, hereinafter, such an embodiment will be described. As such a configuration (width dimension adjustment function), for example, as illustrated in FIG. 34(a), there is a technique in which an arm bar 605 supporting the pulley 602 (driven pulley 602B) to be rotatable in the leading end portion is arranged to be freely stretchable (able to protrude) from the side wall 22 of the transfer tank 20 (so-called stretchable type). In addition, the arm bar 605 may be fixed to an arbitrary position (with protrusion dimension) by using a clamp 606 or the like.

In addition, as illustrated in FIG. 34(b), a technique may be considered in which the arm bar 605 supporting the pulley 602 is arranged to be freely rotatable with respect to the side wall 22 of the transfer tank 20, and this arm bar 605 is fixed to an arbitrary rotation position by using a clamp 606 or the like (so-called swing type). It is to be understood that the stretchable type and the swing type may be used in a combinational manner in places without any problem.

Furthermore, while the pre-activation guide mechanism 60 is configured by the belt 603, a chain, a relatively thick rope, wire, or the like may be used.

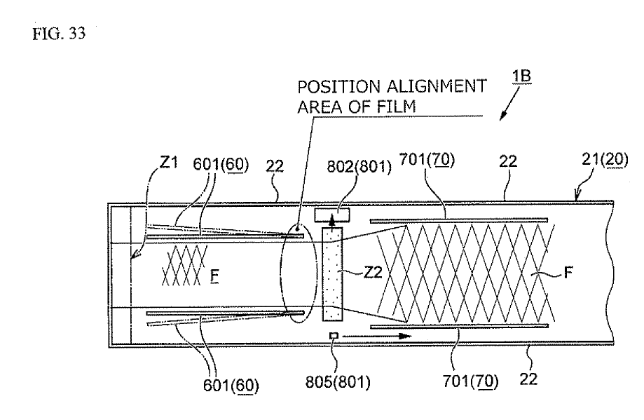

In addition, in FIG. 27 described above, while the pre-activation guide mechanism 60 is arranged such that the left and right belts 603 are almost parallel to each other, the position matching of the transfer film F according to the pre-activation guide mechanism 60 may be performed until the transfer film F is sent to the activation area Z2. Thus, for example, as illustrated in FIG. 33, the pre-activation guide mechanism 60 (conveyer 601) may be arranged such that the gap between the left and right belts gradually decreases from the liquid contact point Z1 to the activation area Z2, in other words, in the shape of “Λ” in the plan view.

Next, the post-activation guide mechanism 70 will be described. The post-activation guide mechanism 70 is provided on the inner side of both side walls 22 of the transfer tank 20 in the rear stage of the activation area Z2 and guides the transfer film F up to the transfer area Z3 while holding both sides of the transfer film F after activation. The transfer film F coated with the activating agent extends (spreads) in the widthwise direction only for which there is no restriction in a horizontally equivalent manner without any distortion, and the extension ends when the transfer film arrives at the post-activation guide mechanism 70 (chain conveyer 701), whereby this mechanism is also responsible for the action of regulating the extension of the film from both sides. In other words, the post-activation guide mechanism 70 (chain conveyer 701) conveys the transfer film F up to the transfer area Z3 in the state in which the extension of the transfer film F is maintained to be almost constant, and, from this, the extension of the transfer film F is always maintained to the same level in the transfer area Z3, whereby a continuous accurate transfer can be performed.

As the post-activation guide mechanism 70, as illustrated in FIG. 27 as an example, a chain conveyer 701 is applied, this is formed by winding a chain 703 around a sprocket 702, and the rotation shaft 704 of the sprocket 702 is set to be horizontal. In other words, the chain 703 is vertically arranged so as to travel on the liquid surface and the middle of the liquid in a cyclic manner and is set such that the center of the chain 703 matches the level of the liquid surface near the liquid surface. Accordingly, the uppermost face of the chain 703 appears (protrudes) on the upper side of the level of the liquid surface more or less, and, from this, the chain 703 is configured to be in contact with both sides of the transfer film F on the liquid surface and be relatively firmly maintained.

Here, since the post-activation guide mechanism 70 is disposed at the rear stage of the activation area Z2, the width dimension (the gap between the chain conveyers 701) that holds and regulates both sides of the transfer film F according to this mechanism is naturally set to be larger than the width dimension (the gap between the conveyers 601) holding both sides of the transfer film F according to the pre-activation guide mechanism 60. Here, the post-activation guide mechanism 70 does not necessarily need to be configured by the chain conveyer 701 but may be configured by a belt, a relatively thick rope, wire, or the like.

Also in the post-activation guide mechanism 70 (chain conveyer 701), the width dimension does not necessarily need to be maintained as being constant, the chain conveyer 701 may be arranged such that the horizontal width dimension gradually decreases from the activation area Z2 toward the transfer area Z3 (in other words, toward the downstream). From this, by tightening the transfer pattern of the transfer film F after activation (suppressing the extension of the pattern), the transfer pattern (pattern) can be transferred more sharply.

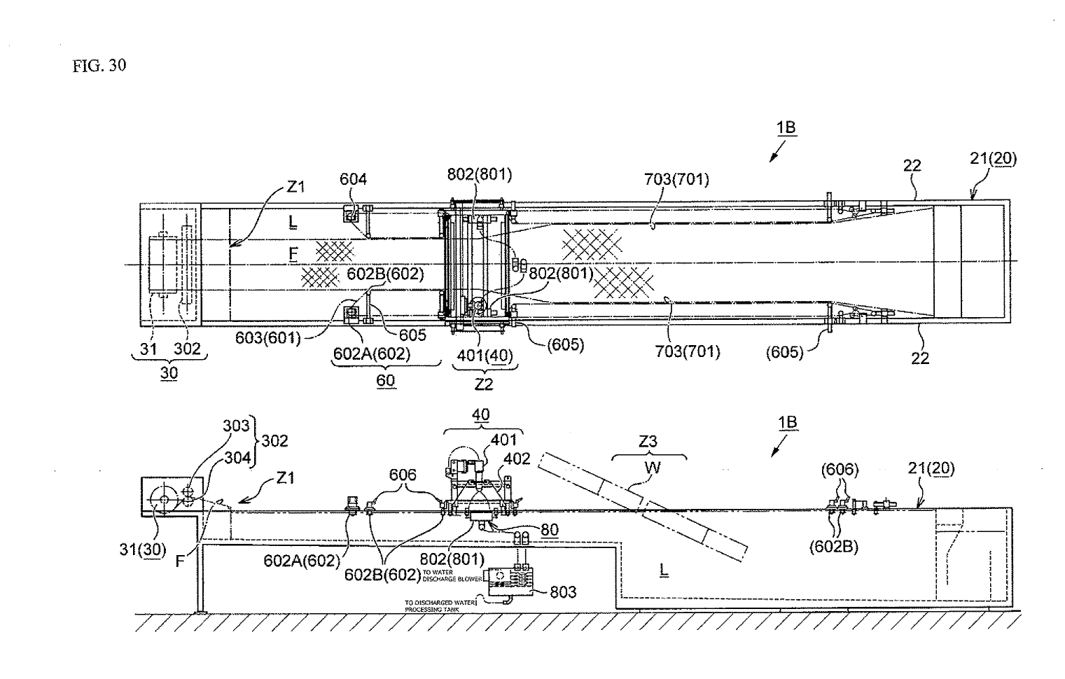

In FIG. 27 described above, although the pre-activation guide mechanism 60 and the post-activation guide mechanism 70 are configured to be completely independent from each other (for example, separate configurations of the conveyer 601 using the belt 603 and the chain conveyer 701), for example, as illustrated in FIG. 30, the guide member (here, the belt 603) holding both sides of the film using the pre-activation guide mechanism 60 may be handled (applied also as the post-activation guide mechanism 70) even after that activation area Z2, and the transfer film F extending in accordance with activation may be held by the same guide member. In such a case, in the activation area Z2, an arrangement is employed in which the guide member (belt 603) avoids the transfer film F (activation area Z2), for example, the guide member retreats near the side wall 22 (see FIG. 31(a)) or enters deeply in the liquid. In such a form (a form in which the guide member holding both sides of the film is shared by the pre-activation guide mechanism 60 and the post-activation guide mechanism 70), the transfer film F can be conveyed at the same speed before and after the activation, and, in a case where a transfer is desired to be performed with the speed of the film are the same in the activation area Z2 and the transfer area Z3, the transfer can be efficiently performed.

In contrast to this, as illustrated in FIG. 27, in a case where the pre-activation guide mechanism 60 and the post-activation guide mechanism 70 are formed to be completely independent from each other, the conveying speed of the transfer film F before and after activation can be changed, and accordingly, in a case where the speed of the film is desired to be different in the activation area Z2 and the transfer area Z3, the transfer can be efficiently performed.

In addition, the pre-activation guide mechanism 60 and the post-activation guide mechanism 70 along with the activating agent applying device 40 are preferably disposed to be freely movable to the front and rear sides (the upstream side is set as the front side) with respect to the transfer tank 20, so that the activation timing and the transfer timing can be appropriately set.

Next, the elongation and extension reduction prevention mechanism 80 will be described.

In Another Embodiment 2, since the activating agent is applied (sprayed) on the liquid surface, the activating agent is applied to an outer portion exceeding both sides of the transfer film F so as to uniformly extend the transfer film F, and the like, a situation is formed on the surface of the transfer liquid in which a redundant/unnecessary activating agent may easily float and stay on the liquid surface. In this embodiment, such an activating agent component, for acting to inhibit the extension of the transfer film F, is collected and removed by a removing means 801 in the activation area Z2 or at a position (hereinafter, simply referred to as a “prior-contact point”) right before the transfer film F extending in accordance with activation comes into contact with the post-activation guide mechanism 70, and this is the elongation and extension reduction prevention mechanism 80.

Accordingly, the elongation and extension reduction prevention mechanism 80 (removing means 801) may be regarded as a mechanism that is used for causing the transfer film F to come in contact with the guide mechanism, particularly, the post-activation guide mechanism 70 reliably and stably by collecting and removing an activating agent component floating on the liquid surface and promoting the extension of the transfer film F to be enlarged by the activation. Accordingly, even when a transfer is repeatedly performed, the transfer film F that is horizontally extended uniformly without any distortion in accordance with activation continuously comes into contact with the guide mechanism (post-activation guide mechanism 70) in a stable manner (the promotion of extension is continued), and an accurate transfer can be continuously performed.

Here, details why the activating agent component floating and staying on the surface of the transfer liquid inhibits the extension of the transfer film F will be described.

Since the holding (regulating) of both sides of the film using the pre-activation guide mechanism 60 is cancelled in the activation area Z2, between the activation area Z2 and the post-activation guide mechanism 70, the flow on the liquid surface tends to be weakened, and particularly, an activating agent applied to run off the film in the activation area Z2 may easily stay therein. Accordingly, when the liquid pressure transfer is repeatedly performed in the state, the activating agent component gradually increases on the surface of the transfer liquid in the activation area Z2, and enters between the transfer film F and the guide mechanism (post-activation guide mechanism 70) and acts so as to prevent the extension (enlargement) of the transfer film F. When such a situation is formed, the transfer film F does not arrive at the guide mechanism, and horizontally uniform extension cannot be acquired, and the conveyance of the film is non-uniform, whereby various defects such as pattern bending and pattern distortion may occur.

Here, as described above, the elongation and extension reduction prevention mechanisms 80 (removing means 801) are arranged in both the activation area Z2 and the prior-contact point. Out of these, the removing means 801 arranged in the activation area Z2 mainly removes and collects an activating agent (activating agent component) which is sprayed on the liquid surface to run off to the outside of the transfer film F, and, as this, the catch basin 802 is applied.

In the catch basin 802, for example, a sucking port (collecting port) is disposed upward under the water surface (for example, a position immersed by about 4 mm from the liquid surface). Here, in the collection using the catch basin 802, although a vacuum technique in which the activating agent component disposed on the liquid surface is aggressively sucked in together with the transfer liquid L is preferable, a collection form (so-called overflow) may be employed in which the activating agent component disposed on the liquid surface is caused to naturally fall overhead together with the transfer liquid L. In the case of the vacuum technique for aggressively sucking the activating agent component disposed on the liquid surface together with the transfer liquid L, for example, as illustrated in FIG. 31, air inside the hood 402 can be sucked and discharged together, and, from this, the flow of air flowing from a clearance between the hood 402 and the transfer film F or an opening portion formed in the upper portion of the hood 402 so as to reciprocate the spray gun 401 toward the catch basin 802 is generated inside the hood 402, and this air flow contributes also to the discharge of the activating agent (a redundant/unnecessary activating agent floating inside the hood 402), whereby there is an advantage of reducing the smell of the solvent on the periphery of the spray activation device (activating agent applying device 40). In addition, it is preferable to arrange one pair of the catch basins 802 on both outer sides (both side portions) of the film in which the spray gun 401 reciprocates.

In addition, as illustrated in FIG. 31 (particularly, in FIG. 31(b)), it is preferable to arrange fillers promoting an air-liquid contact on the inner side of the catch basin 802 (sucking port), and it is more preferable to arrange a mist separator 803 in which fillers and a demister are built at the water-discharging side rear stage of the catch basin 802, and accordingly, the air containing an unnecessary activating agent component and the transfer liquid (collection liquid) can be mixed and discharged more efficiently. In addition, from this, the air containing the unnecessary activating agent component can be completely melted into the transfer liquid (collection liquid), and the melted collection liquid is circulated by a submersible pump so as to be reused or discharged (exhausted). Furthermore, from this, an activating agent and the smell of the solvent are almost completely removed from the exhausted air (air) discharged from an exhaust fan 804, and accordingly, a high-priced solvent collection device does not need to be disposed, and the process of exhausting and water-discharging the activating agent and the solvent component can be efficiently performed.

As above, in this embodiment, since the activating agent component to stay on both sides of the activation area Z2 is effectively collected by the catch basin 802, the transfer film F after activation can be easily extended to be horizontally uniform. In addition, in accordance with the liquid flow flowing toward the catch basin 802, an advantage of extending the transfer film F after activation to be horizontally uniform can be expected.

In addition, as the removing means 801 provided in the activation area Z2, not only the catch basin 802 (including a technique of the overflow of naturally falling water) but also a small submersible pump (vacuum pump) or the like can be applied.

Meanwhile, the removing means 801 that is disposed at the prior-contact point removes the activating agent component to be a liquid film and spread on the surface of the transfer liquid between the post-activation guide mechanism 70 (chain conveyer 701) and the transfer film F, and here, a blow technique is employed. In other words, in the activation area Z2, as described above, the activating agent component is considered to easily stay, and accordingly, the air used for removing the activating agent component, as illustrated in FIG. 27 as an example, is blown such that the activating agent component that may easily stay at the prior-contact point from the activation area Z2 is pushed out (sent) to the rear side of the guide, in other words, a position between the post-activation guide mechanism 70 and the side wall 22. In addition, the rear side of the guide is a portion that does not have substantial influence on the transfer or have a little influence on the transfer by setting the upper face of the post-activation guide mechanism 70 (chain conveyer 701) to a position higher than the surface of the transfer liquid and the like.

In addition, a portion that pushes the activating agent component that may easily stay at the prior-contact point from the activation area Z2 is not limited to the rear side of the guide, and the activating agent component may be sent to the catch basins 802 (or the submersible pumps) disposed on both sides of the activation area Z2 and be collected therefrom.

Next, a specific configuration of the removing means 801 removing the activating agent component located at the prior-contact point will be further described. As the removing means 801, as illustrated in FIG. 27 as an example, two compressed air extraction nozzles 805 are applied, and this compressed air extraction nozzle 805, as illustrated in the figure, preferably includes a multi-joint type flexible hose, and which enables fine adjustment of the position of the nozzle, the air blowing direction, and the like to be performed in an easy manner.

In addition, in the air blowing for removing the activating agent component, it is preferable that the blowing is applied to the surface of the transfer liquid on which the film is not present without directly applying (putting) the blowing to the transfer film F, and, in such a case, the surface of the transfer liquid is stably maintained, and the transfer film F is conveyed to the transfer area Z3 in a state in which there is no ripple as possible as can. In addition, in that point, as the compressed air extraction nozzle 805, it is preferable that air is applied to a target liquid surface in a pin-point manner by using a nozzle formed in a tapered shape toward the discharge port.

In FIG. 27, while the air blows applied from two compressed air extraction nozzles 805 are in the blowing form reversing the flow of the transfer liquid, the two compressed air extraction nozzles 805 may have a small capacity (air blowing power) to a degree for sending the activating agent component (liquid film) disposed on the liquid surface to the catch basin 802, the small submersible pump, or the rear side of the guide, and there is no concern that the air blows according to the compressed air extraction nozzle 805 block the flow of the transfer liquid L. It is apparent that the air blows according to the compressed air extraction nozzles 805, for example, as illustrated in FIG. 33, may be performed almost along the flow of the transfer liquid L (toward the downstream side).

In FIG. 27, as described above, while a form in which the elongation and extension reduction prevention mechanisms 80 (removing means 801) are arranged both in the activation area Z2 and at the prior-contact point is basically employed, and both the catch basin 802 and the compressed air extraction nozzle 805 are arranged, but any one thereof may be arranged as long as the activating agent component can be removed to a degree for which the extension of the transfer film F can be continuously performed by any one of the removing means 801. Accordingly, for example, the catch basin 802 operated in the activation area Z2 located on the upstream side is considered as a main removing means 801, and a form may be applied in which the compressed air extraction nozzle 805 is operated (or arranged) in a case where the removal capacity of the catch basin 802 is insufficient, and the activating agent component is prevented from entering between the transfer film F and the post-activation guide mechanism 70 (chain conveyer 701). In addition, mutually-different removing means 801 may be horizontally arranged, and, for example, in FIG. 33, the catch basin 802 is arranged near the left side wall 22 of the liquid flow when seen in the plan view, and the compressed air extraction nozzle 805 is arranged near the side wall 22 located on the opposite side.

Next, regarding the object conveying device 50, it basically has the same configuration as that of the basic embodiment described above, and the description thereof will not presented here. However, reference numeral “50” is assigned to the object conveying device according to Another Embodiment 2.

Next, the film detaching and cleaning device 90 will be described. The film detaching and cleaning device 90 washes away a half-dissolved water-soluble film that adheres to and remains in a film from on the surface of the object W pulled up from the transfer liquid L (only a transfer pattern transferred to the surface of the object W is caused to remain) and, as illustrated in FIG. 28 as an example, is formed by a conveyer 901 that places and conveys an object W taken out from the transfer tank 20 (transfer area Z3), a warm water shower 902 that sprays water (warm water) to the object W conveyed on the conveyer 901, a rinse water shower 903 that sprays rinse water to the object W after water cleaning, and a storage tank 904 that stores the warm water and the rinse water (discharged cleaning water containing dissolved water-soluble film) after film detaching and cleaning. In addition, in the storage tank 904, an overflow unit 203 is formed and is connected to the transfer tank 20 through a circulating water discharge pipe path 905, and discharged cleaning water (discharged film detaching and cleaning water containing a water-soluble film) overflown by the storage tank 904 is drawn right before the overflow unit 203 of the transfer tank 20, and the water-soluble film washed off in the film detaching and cleaning process is also deposited and collected therein.

In the middle of the circulating water discharge pipe path 905, a filter is preferably arranged, and it is preferable to remove foreign substances such as water-soluble films and the like generated in the film detaching and cleaning process also therein. In addition, in a case where water is desired to be circulated and used as much as possible as above, water for the warm water shower 902 and water for the rinse water shower 903 may be also reused from the storage tank 904. In such a case, it is preferable to arrange filters removing foreign substances in supply pipe paths 902a and 903a for the warm water shower 902 and the rinse water shower 903.

Here, advantages of a case where water is circulated and used as much as possible (a case where discharged water after film detaching and cleaning is resupplied to the transfer tank 20) will be described.

### Comparative Example

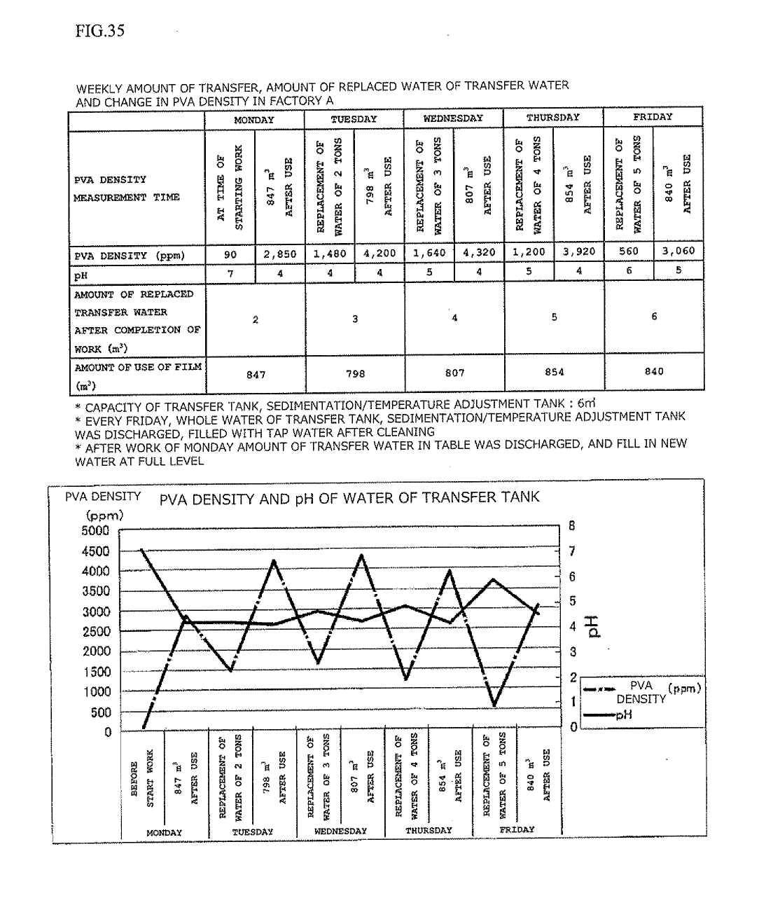

First, according to a conventional liquid pressure transferring technique, in other words, in a system in which discharged water after film detaching and cleaning is not resupplied to the transfer tank 20, a weekly amount of the transfer, the amount of replaced transfer water, and a change in the PVA density are as represented in a table and a graph illustrated in FIG. 35. When the PVA density was 500 ppm or less, the transfer film F was hard and the deposition property was inferior, thereafter, a good film state was continued, and, when the PVA density rose to 3000 ppm, the transfer film F excessively softened, and the occurrence of a transfer defect tended to increase. The amount of water of the transfer tank replaced and supplemented for one week was 23 tons.

### Example

### Another Embodiment 2: FIG. 28

On the other hand, in the present system in which discharged water after film detaching and cleaning is resupplied to the transfer tank 20, the film detaching and cleaning device 90 performed the warm water shower 902 and the rinse water shower 903 of 20 L/min using two storage tanks 904 and a circulation pump, and film detachment water of 15 L/min was introduced from the terminal end middle layer portion of the storage tank 904 to the transfer tank 20 (see FIG. 28). The PVA density of the film detachment water was 600 ppm after 3 hours and 1200 ppm after 8 hours.

The initial PVA density of the transfer tank 20 was adjusted to 500 ppm, and transfer processing was continued while the above-described film detachment water was introduced. As a result, the PVA density of the transfer water was 1350 ppm after 8 hours, 1700 ppm after 16 hours, 2000 ppm after 80 hours, and 2040 ppm after 160 hours, the characteristics of the transfer film were stabilized, and there was no defect due to the transfer film F.

As water of the transfer tank discharged therebetween, bottom water containing ink residuals collected at the bottom of the sedimentation tank was about 200 L once per two days and was about 600 L for a week. The number of processes of the operation of replacing the water of the transfer tank for two weeks decreased, the amount of replaced water decreased by 45 tons, and accordingly, not only a decrease in the transfer defect but also an advantage that is particularly useful in an area in which water resources are valuable was acquired.

The liquid pressure transfer device 1B is configured as above, and hereinafter, while the operation form (liquid pressure transfer method) of the liquid pressure transfer device 1B is described, a method of activating the transfer film will be described together.

### (1) Before Activation: Supply of Transfer Film (Before Floating on Liquid Surface)

In performing a liquid pressure transfer, first, a transfer film F is supplied to the transfer tank 20 storing the transfer liquid L. Here, as described above, since activation above water is performed, the transfer film F is supplied to the transfer tank 20 without being activated. At that time, the transfer film F is supplied to the transfer tank 20 while passing through the projection and depression molding roller 302, and, from this, the transfer film F is sent out to the surface of the transfer liquid in a state in which curl-prevention projections and depressions R are formed on both side portions.

### (2) Before Activation: Prevention of Curl

The transfer film F supplied to the surface of the transfer liquid is formed such that the curl-prevention projections and depressions R formed on both sides have sufficient resilience (strength) against bending in the widthwise direction, and the like, whereby the curl phenomenon is prevented. Accordingly, the transfer film F supplied to the surface of the transfer liquid does not have the occurrence of a curl in which both sides are oppositely separated away from the liquid surface and reliably comes into contact with the pre-activation guide mechanism 60 (the belt 603 of the conveyer 601), whereby both sides are accurately held. In addition, from this, the transfer film F is conveyed to the activation area z2 without being deviated to one side wall 22 and causing any position mismatching and meandering. Furthermore, the effective use width of the film can be broadened, and the elongation and extension rate in the widthwise direction is suppressed, whereby the feeling of pattern extension can be relieved, and a high-precision transfer design can be represented. In addition, in order to form the curl-prevention projections and depressions R, not only the projection and depression molding roller 302 but also a laser marker 307 may be applied. In such a case, curl-prevention projections and depressions R that are finer than those of the projection and depression molding roller 302 can be formed.

(3) Before Activation: Status of Transfer Film while being Held by Pre-Activation Guide

In the transfer film F having both sides held by being brought into contact with the pre-activation guide mechanism 60, the position in the widthwise direction of the film is regulated in accordance with the holding, swelling and expansion in the thickness direction are promoted. In other words, the transfer film F after a contact with the liquid, particularly, the water-soluble film of the lower side of the film is swollen and expanded in the thickness direction until reach of the activation area Z2, and, as a result, a state is formed in which swelling and expanding in the widthwise direction are regulated. In addition, the reason for causing the transfer film F (water-soluble film) before activation is swollen in the thickness direction is for elongating and extending the transfer film F in the widthwise direction to be horizontally uniform without any distortion in the activation stage performed thereafter.

### (4) Activation: Cancellation of Guide Action According to Pre-Activation Guide Mechanism

Thereafter, although the activating agent is applied when the transfer film F arrives at the activation area Z2, first, a guide action (holding action) according to the pre-activation guide mechanism 60 is cancelled right before the arrival. In other words, the transfer film F is coated with the activating agent in a free state in which both side portions are not held and regulated in the activation area Z2. Since the transfer film F is sent from the liquid contact point Z1 up to the activation area Z2 (furthermore, up to the transfer area Z3) in a continuous state, even when the holding of both sides is cancelled in the activation area Z2, a guide action according to the pre-activation guide mechanism 60 is applied to a portion disposed on the upstream side, and, as a whole of the film, the position mismatching prevention function is applied also in the activation area Z2.

### (5) Activation: Elongation and Extension of Transfer Film in Widthwise Direction

As above, the transfer film F is coated with the activating agent in the state in which the holding and regulating of both sides of the film are cancelled in the activation area Z2, and accordingly, the transfer film F is horizontally-uniformly elongated and extended in the widthwise direction without any distortion. Such elongation and extension are caused by not only the action of the activating agent but also the swelling and expanding of the water-soluble film of the lower side of the film in the thickness direction to a degree for following the elongation and extension according to the activation until reach of the activation area Z2 (in advance). In other words, the transfer film F extends in the widthwise direction only for which no regulation is present in accordance with the application of the activating agent such that the thickness dimension that has been swollen and expanded decreases.

### (6) Activation: Removal of Activating Agent Component in Activation Area

In addition, in the activation area Z2, the activating agent is applied to run off to the outer side of the side portion of the transfer film F, and accordingly, in the activation area Z2, the activating agent applied to the outside of the film is collected by the removing means 801 (catch basin 802) together with the transfer liquid L. Accordingly, the activating agent component to stay on both sides of the activation area Z2 is collected, and therefore, the transfer film F to be enlarged in accordance with the activation is horizontally-uniformly elongated and extended. In addition, the effect of horizontally-uniformly elongating and extending the transfer film F after the activation can be expected in accordance with the liquid flow flowing toward the catch basin 802.

In addition, in sucking (collecting and discharging) the activating agent component disposed on the liquid surface together with the transfer liquid L using the catch basin 802, as described above, air inside the hood 402 can be sucked and exhausted. Thus, for example, by arranging fillers in the catch basin 802 (sucking port) or passing the collected liquid sucked in from the catch basin 802 through the mist separator 803 in which fillers and a demister are built, a redundant activating agent floating inside the hood 402 is dissolved into the collection liquid (transfer liquid), whereby the smell of the solvent on the periphery of the activating agent applying device 40 can be remarkably reduced.

### (7) After Activation: Collection of Activating Agent Component at Prior-Contact Point

Although the transfer film F coated with the activating agent component in the activation area Z2 is horizontally-uniformly elongated and extended in the widthwise direction without any distortion and comes into contact with the post-activation guide mechanism 70, for example, in a case or the like in which all the activating agent component may not be collected by the catch basin 802, it is preferable that the activating agent component entering between the post-activation guide mechanism 70 and the transfer film F is sent to the rear side of the catch basin 802 (submersible pump) or the guide by using the compressed air extraction nozzle 805 applied to the prior-contact point. From this, reduction in the elongation and extension of the transfer film F is further prevented, and the transfer film F reliably comes into contact with the post-activation guide mechanism 70 even when the transfer is repeatedly performed.

Thereafter, the transfer film F is conveyed up to the transfer area Z3 while both sides thereof are held and regulated by the post-activation guide mechanism 70. In other words, the transfer film F is conveyed up to the transfer area Z3 in the state in which the position mismatching is prevented or center alignment is performed and in the state of being maintained to a predetermined degree of elongation and extension after activation.

### (8) Transfer: Immersion of Object

When the transfer film F that is held and regulated by the post-activation guide mechanism 70 arrives at the transfer area Z3, for example, the objects W held by the object conveying device 50 such as the conveyer 51 are sequentially put into the transfer liquid L at an appropriate posture (with the angle of entering the liquid) and a transfer is performed. This angle of entering the liquid may be appropriately changed in accordance with the shape or the projections and depressions of the object W.

In addition, in a case where the width dimension of the post-activation guide mechanism 70 (chain conveyer 701) gradually decreases from the activation area Z2 toward the transfer area Z3, by tightening the transfer pattern of the transfer film F after activation (suppressing the extension of the pattern), the transfer pattern (pattern) can be transferred more sharply.

### (9) After Transfer: Film Detaching and Cleaning Process

After the transfer is completed, the object W getting out of the liquid on the liquid surface is taken away from the object conveying device 50, is loaded on the conveyer 901 of the film detaching and cleaning device 90, and receives the warm water shower 902 and the rinse water shower 903, whereby the water-soluble film disposed on the surface is removed.

In addition, while the discharged film detaching and cleaning water after the film detaching and cleaning process contains foreign substances such as a dissolved water-soluble film, the discharged film detaching and cleaning water is guided right before the overflow unit 203 of the transfer tank 20 by the circulating water discharge pipe path 905, and accordingly such foreign substances are additionally deposited and collected by the overflow unit 203. It is preferable that the foreign substances such as a water-soluble film contained in the discharged film detaching and cleaning water is additionally collected by a filter that is appropriately disposed in the circulating water discharge pipe path 905.

Thereafter, the object W is appropriately dried, top-coated, and the like, thereby becoming a product.

### INDUSTRIAL APPLICABILITY

The present invention is appropriate for a liquid pressure transfer (a liquid pressure transfer not requiring top coating) forming a transfer pattern that has an additional surface protection function at the time of performing the transfer and may be also applied to a conventional liquid pressure transfer in which a transfer pattern is formed at the time of performing the transfer, and surface protection is achieved by top coating after the transfer.

1. A liquid pressure transfer method provided with a design surface cleaning device in which a transfer film configured by forming at least a transfer pattern on a water-soluble film in a dried state is supported on a liquid surface inside a transfer tank so as to float, and the transfer pattern is transferred mainly to a design surface side of an object in accordance with liquid pressure generated by pressing the object from an upper side, the liquid pressure transfer method comprising:
forming a design surface oppositely-separating flow that is separated away from a design surface of the object that is in the process of getting out of a liquid in a liquid-leaving area in which the object is pulled up from the transfer liquid in the transfer tank, separating foam on a surface of a transfer liquid and foreign substances staying in the liquid away from the design surface of the object that is in the process of getting out of the liquid, and discharging the foam and the foreign substances outside the transfer tank.

2. The liquid pressure transfer method provided with the design surface cleaning device according to claim 1, wherein, on both left and right sides of the liquid-leaving area, side oppositely-separating flows from a decoration-unnecessary surface side that is a rear side of the design surface of the object in the process of getting out of the liquid toward both side walls of the transfer tank are formed near the liquid surface, and the foreign substances staying in the transfer liquid and on the surface of the liquid are separated away from the liquid-leaving area and are discharged outside the transfer tank.

3. The liquid pressure transfer method provided with the design surface cleaning device according to claim 1, wherein a discharge means discharging liquid surface residual films, which are not used for the transfer due to immersion of the object, floating on the liquid surface from the transfer tank is disposed on a previous stage of the liquid-leaving area, and the liquid surface residual films are collected until the object gets out of the liquid so as not to arrive at the liquid-leaving area.

4. The liquid pressure transfer method provided with the design surface cleaning device according to claim 1, wherein the design surface oppositely-separating flow is formed by an overflow tank disposed so as to face the design surface of the object that is in the process of getting out of the liquid.

5. The liquid pressure transfer method provided with the design surface cleaning device according to claim 4, wherein an overflow tank collecting the transfer liquid is further disposed at a rear stage of the overflow tank disposed so as to face the design surface of the object that is in the process of getting out of the liquid.

6. The liquid pressure transfer method provided with the design surface cleaning device according to claim 4, wherein the design surface oppositely-separating flow is generated by supplying new water such as clean water not containing foreign substances or purified water acquired by removing foreign substances from the transfer liquid collected from the transfer tank from a lower side of the overflow tank for forming the design surface oppositely-separating flow toward the liquid-leaving area disposed on an upstream side.

7. The liquid pressure transfer method provided with the design surface cleaning device according to claim 4,
wherein a new water supply port that supplies new water such as clean water not containing foreign substances or purified water acquired by removing foreign substances from the transfer liquid collected from the transfer tank into the inside of the tank is disposed on the lower side of the overflow tank for forming the design surface oppositely-separating flow, and
the design surface oppositely-separating flow is formed using new water supplied upward from the new water supply port toward the liquid-leaving area.

8. The liquid pressure transfer method provided with the design surface cleaning device according to claim 7,
wherein downward new water is supplied from the new water supply port toward the liquid-leaving area,
a siphon-type discharge unit that sucks up the transfer liquid containing foreign substances such as film residuals from the lower side and discharges the transfer liquid to the outside of the tank is disposed on a rear face side of the new water supply port, and
a sucking flow according to the siphon-type discharge unit is formed by using new water supplied downward toward the liquid-leaving area.

9. The liquid pressure transfer method provided with the design surface cleaning device according to claim 8,
wherein the transfer tank has a tapered inclined plate disposed on the lower side of the new water supply port and is formed such that a tank depth gradually decreases toward a terminal end portion of the tank, and
a sucking port of the siphon-type discharge unit is disposed so as to face an uppermost end portion of the inclined plate.

10. The liquid pressure transfer method provided with the design surface cleaning device according to claim 8,
wherein new water that flows in approximately parallel with the liquid-leaving area is also supplied from the new water supply port, and
the new water is supplied from the new water supply port between both new water supplied upward toward the liquid-leaving area and new water supplied downward toward the liquid-leaving area.

11. The liquid pressure transfer method provided with the design surface cleaning device according to claim 7, wherein, in the new water supply port, a punching metal is disposed in a discharge port portion supplying new water, and new water supplied from the new water supply port to the transfer tank is uniformly discharged from a relatively broad range.

12. The liquid pressure transfer method provided with the design surface cleaning device according to claim 4, wherein, in the overflow tank forming the design surface oppositely-separating flow, a flow rate increase brim for increasing a flow rate of the transfer liquid introduced into the overflow tank is formed in a discharge port that serves as a liquid collection port.

13. The liquid pressure transfer method provided with the design surface cleaning device according to claim 1, wherein the transfer tank is formed so as to secure a depth in which the design surface of the object is immersed into the transfer liquid in a transfer-necessary section that is until the object gets out of the liquid after being immersed into the liquid and is formed so as to have a depth smaller than the depth in the other transfer-unnecessary section.

14. The liquid pressure transfer method provided with the design surface cleaning device according to claim 4, wherein the overflow tank forming the design surface oppositely-separating flow is formed to be freely movable in a longitudinal direction of the transfer tank and is moved so as to maintain a distance between the design surface of the object and the overflow tank to be almost constant even when a position of the object changes to a front or rear side in accordance with an operation of the object getting out of the liquid.

15. The liquid pressure transfer method provided with the design surface cleaning device according to claim 2,
wherein the side oppositely-separating flows are formed by overflow tanks disposed on both left and right sides of the liquid-leaving area, and
in the discharge port that serves as a liquid collection port in the overflow tank, a flow rate increase brim for increasing a flow rate of the transfer liquid introduced into the overflow tank is formed.

16. The liquid pressure transfer method provided with the design surface cleaning device according to claim 15, wherein, in the liquid-leaving area, foreign substances staying in the transfer liquid and on the surface of the liquid are discharged by performing air blowing for pushing foam or the foreign substances generated on the liquid surface of the liquid-leaving area to one side wall of the transfer tank, and the foam and the foreign substances disposed on the liquid surface of the area are also collected by the overflow tank for forming the side oppositely-separating flows and are discharged to the outside of the tank.

17. The liquid pressure transfer method provided with the design surface cleaning device according to claim 15,
wherein an overflow tank for collecting the liquid surface residual films is disposed in a previous stage of the overflow tank forming the side oppositely-separating flows, and
in the overflow tank, a blocking means blocking collection of the liquid is disposed in the middle of the discharge port collecting the liquid surface residual films, and the liquid surface residual films are collected from front and rear sides of the blocking means.

18. The liquid pressure transfer method provided with the design surface cleaning device according to claim 17, wherein, in collecting the liquid surface residual films, until the object gets out of the transfer liquid after being immersed into the transfer liquid, the liquid surface residual films are divided to be split in a longitudinal direction of the transfer tank by a dividing means, and the divided liquid surface residual films are caused to approach both side walls of the transfer tank and are collected by the overflow tank for collecting the liquid surface residual films.

19. The liquid pressure transfer method provided with the design surface cleaning device according to claim 1,
wherein the liquid pressure transfer applied to the object is performed by either applying a transfer film made by forming only a transfer pattern to a water-soluble film in a dried state and using a liquid curable resin composition as an activating agent, or applying a transfer film having a curable resin layer between a water-soluble film and a transfer pattern as a transfer film, and
using the liquid pressure transfer, a transfer pattern also having a surface protection function is formed on the object, and this is cured by emission of an active energy ray and/or heating after the transfer.

20. A liquid pressure transfer device provided with a design surface cleaning device which supports a transfer film configured by forming at least a transfer pattern on a water-soluble film in a dried state on a liquid surface inside a transfer tank so as to float and transfers the transfer pattern mainly to a design surface side of an object in accordance with liquid pressure generated by pressing the object from an upper side, the liquid pressure transfer device comprising:
the transfer tank that stores a transfer liquid;
a transfer film supply device that supplies the transfer film to the transfer tank; and
an object conveying device that presses the object from the upper side with respect to the transfer film that is in an activation state on the liquid surface of the transfer tank,
wherein an oppositely-separating flow forming means acting on the design surface of the object that is in the process of rising from the transfer liquid is disposed in a liquid-leaving area in which the object is pulled up from the transfer liquid, a design surface oppositely-separating flow that is separated away from the design surface of the object that is in the process of getting out of a liquid is formed, and foam disposed on the surface of the transfer liquid and foreign substances staying in the liquid are separated away from the design surface of the object that is in the process of getting out of the liquid and are discharged outside the transfer tank in accordance with the design surface oppositely-separating flow.

21. The liquid pressure transfer device provided with the design surface cleaning device according to claim 20, wherein a discharge means that collects the transfer liquid near the liquid surface is disposed on both left and right sides of the liquid-leaving area, side oppositely-separating flows from a decoration-unnecessary surface side that is a rear side of the design surface of the object in the process of getting out of the liquid toward both side walls of the transfer tank are formed, and the foreign substances staying in the transfer liquid and on the surface of the liquid are separated away from the liquid-leaving area and are discharged outside the transfer tank in accordance with the side oppositely-separating flows.

22. The liquid pressure transfer device provided with the design surface cleaning device according to claim 20, wherein a discharge means discharging liquid surface residual films, which are not used for the transfer due to immersion of the object, floating on the liquid surface from the transfer tank is disposed on a previous stage of the liquid-leaving area, and the liquid surface residual films are collected until the object gets out of the liquid so as not to arrive at the liquid-leaving area.

23. The liquid pressure transfer device provided with the design surface cleaning device according to claim 20, wherein the design surface oppositely-separating flow is formed by an overflow tank disposed so as to face the design surface of the object that is in the process of getting out of the liquid.

24. The liquid pressure transfer device provided with the design surface cleaning device according to claim 23, wherein an overflow tank collecting the transfer liquid is further disposed at a rear stage of the overflow tank disposed so as to face the design surface of the object that is in the process of getting out of the liquid.

25. The liquid pressure transfer device provided with the design surface cleaning device according to claim 23, wherein the design surface oppositely-separating flow is generated by supplying new water such as clean water not containing foreign substances or purified water acquired by removing foreign substances from the transfer liquid collected from the transfer tank from a lower side of the overflow tank for forming the design surface oppositely-separating flow toward the liquid-leaving area disposed on an upstream side.

26. The liquid pressure transfer device provided with the design surface cleaning device according to claim 23,
wherein a new water supply port that supplies new water such as clean water not containing foreign substances or purified water acquired by removing foreign substances from the transfer liquid collected from the transfer tank into the inside of the tank is disposed on the lower side of the overflow tank for forming the design surface oppositely-separating flow, and
the design surface oppositely-separating flow is formed using new water supplied upward from the new water supply port toward the liquid-leaving area.

27. The liquid pressure transfer device provided with the design surface cleaning device according to claim 26,
wherein downward new water is supplied from the new water supply port toward the liquid-leaving area,
a siphon-type discharge unit that sucks up the transfer liquid containing foreign substances such as film residuals from the lower side and discharges the transfer liquid to the outside of the tank is disposed on a rear face side of the new water supply port, and
a sucking flow according to the siphon-type discharge unit is formed using new water supplied downward toward the liquid-leaving area.

28. The liquid pressure transfer device provided with the design surface cleaning device according to claim 27,
wherein the transfer tank has a tapered inclined plate disposed on the lower side of the new water supply port and is formed such that a tank depth gradually decreases toward a terminal end portion of the tank, and
a sucking port of the siphon-type discharge unit is disposed so as to face an uppermost end portion of the inclined plate.

29. The liquid pressure transfer device provided with the design surface cleaning device according to claim 27,
wherein new water that flows in approximately parallel with the liquid-leaving area is also supplied from the new water supply port, and
the new water is supplied from the new water supply port between both new water supplied upward toward the liquid-leaving area and new water supplied downward toward the liquid-leaving area.

30. The liquid pressure transfer device provided with the design surface cleaning device according to claim 26, wherein, in the new water supply port, a punching metal is disposed in a discharge port portion supplying new water, and new water supplied from the new water supply port to the transfer tank is uniformly discharged from a relatively broad range.

31. The liquid pressure transfer device provided with the design surface cleaning device according to claim 23, wherein, in the overflow tank forming the design surface oppositely-separating flow, a flow rate increase brim for increasing a flow rate of the transfer liquid introduced into the overflow tank is formed in a discharge port that serves as a liquid collection port.

32. The liquid pressure transfer device provided with the design surface cleaning device according to claim 20, wherein the transfer tank is formed so as to secure a depth in which the design surface of the object is immersed into the transfer liquid in a transfer-necessary section that is until the object gets out of the liquid after being immersed into the liquid and is formed so as to have a depth smaller than the depth in the other transfer-unnecessary section.

33. The liquid pressure transfer device provided with the design surface cleaning device according to claim 23, wherein the overflow tank forming the design surface oppositely-separating flow is formed to be freely movable in a longitudinal direction of the transfer tank and is moved so as to maintain a distance between the design surface of the object and the overflow tank to be almost constant even when a position of the object changes to a front or rear side in accordance with an operation of the object getting out of the liquid.

34. The liquid pressure transfer device provided with the design surface cleaning device according to claim 21,
wherein, as the discharge means forming the side oppositely-separating flows, overflow tanks disposed on both left and right sides of the liquid-leaving area are applied, and
in the discharge port that serves as a liquid collection port in the overflow tank, a flow rate increase brim for increasing a flow rate of the transfer liquid introduced into the overflow tank is formed.

35. The liquid pressure transfer device provided with the design surface cleaning device according to claim 34, wherein, in the transfer tank, an air blowing device pushing foam or foreign substances generated on the liquid surface of the liquid-leaving area to one side wall of the transfer tank is disposed, and the foam and the foreign substances disposed on the liquid surface of the area are also discharged from the overflow tank for forming the side oppositely-separating flows to the outside of the tank together with discharge of foreign substrates staying in the transfer liquid and on the surface of the liquid.

36. The liquid pressure transfer device provided with the design surface cleaning device according to claim 34,
wherein an overflow tank for collecting the liquid surface residual films is disposed in a previous stage of the overflow tank forming the side oppositely-separating flows, and
in the overflow tank, a blocking means blocking collection of the liquid is disposed in the middle of the discharge port collecting the liquid surface residual films, and the liquid surface residual films are collected from front and rear sides of the blocking means.

37. The liquid pressure transfer device provided with the design surface cleaning device according to claim 36,
wherein a dividing means dividing the liquid surface residual films right after the transfer to be split in a longitudinal direction of the transfer tank is disposed in a previous stage of the overflow tank collecting the liquid surface residual films, and
when the liquid surface residual films are collected, the liquid surface residual films divided by the dividing means are collected by the overflow tank until the object gets out of the transfer liquid after being immersed into the transfer liquid.

38. The liquid pressure transfer device provided with the design surface cleaning device according to claim 20,
wherein, as the transfer film, either a film acquired by forming only a transfer pattern on a water-soluble film in a dried state or a film in which a resin layer having hardenability is included between a water-soluble film and the transfer pattern is applied, and, in a case where the film in which only the transfer pattern is formed on the water-soluble film in the dried state is applied, a liquid resin composite material having hardenability is used as an activating agent, and
when the liquid pressure transfer is performed using the resin composite material, a transfer pattern having also a surface protection function is formed on the object, and the transfer pattern is hardened by radiation of an active energy ray or/and heating after the transfer.
